SEQUENCE LISTING (7 sequences)

SEQ ID NO: 1 - protein, 347 aa, Homo sapiens
EASAFRSYKMINSTSTQPPDESCSQNLLITQQIIPVLYCMVFIAGILLNGVSGWIFFYVPSSKSFIIYLKNIVIADFVMSLTFPFKILGDSGLGPWQLNVFVCRVSAVLFYVNMYVSIVFFGLISFDRYYKIVKPLWTSFIQSVSYSKLLSVIVWMLMLLLAVPNIILTNQSVREVTQIKCIELKSELGRKWHKASNYIFVAIFWIVFLLLIVFYTAITKKIFKSHLKSSRNSTSVKKKSSRNIFSIVFVFFVCFVPYHIARIPYTKSQTEAHYSCQSKEILRYMKEFTLLLSAANVCLDPIIYFFLCQPFREILCKKLHIPLKAQNDLDISRIKRGNTTLESTDTL

SEQ ID NO: 2 - DNA, 2416 bp, Homo sapiens
gaacagtgttaccttggagcctacaatgagaggtatttcaaaatgagtgaagcatgactctcacagatgaaggcctagacgcaggatctttaatggaaaaacacttgggccacttcaagacgacaaacgctcactgggcaaaacaccttcactgaaaagagacctcatattatgcaaaaaaaatcttaagaggcctctgccttcagaagttacaagatgatcaattcaacctccacacagcctccagatgaatcctgctctcagaacctcctgatcactcagcagatcattcctgtgctgtactgtatggtcttcattgcgggaatcctactcaatggagtgtcaggatggatattcttttacgtgcccagctctaagagtttcatcatctatctcaagaacattgttattgctgactttgtgatgagcctgacttttcctttcaagatccttggtgactcaggccttggtccctggcagctgaacgtgtttgtgtgcagggtctctgccgtgctcttctacgtcaacatgtacgtcagcattgtgttctttgggctcatcagctttgacaggtattataaaattgtaaagcctctttggacttctttcatccagtcagtgagttacagcaaacttctgtcagtgatagtatggatgctcatgctcctccttgctgttccaaatattattctcaccaaccagagtgttagggaggttacacaaataaaatgtatagaactgaaaagtgaactgggacggaagtggcacaaagcatcaaactacatcttcgtggccatcttctggattgtgtttcttttgttaatcgttttctatactgctatcacaaagaaaatctttaagtcccaccttaagtcaagtcggaattccacttcggtcaaaaagaaatctagccgcaacatattcagcatcgtgtttgtgttttttgtctgttttgtaccttaccatattgccagaatcccctacacaaagagtcagaccgaagctcattacagctgccagtcaaaagaaatcttgcggtatatgaaagaattcactctgctactatctgctgcaaatgtatgcttggaccctattatttatttctttctatgccagccgtttagggaaatcttatgtaagaaattgcacattccattaaaagctcagaatgacctagacatttccagaatcaaaagaggaaatacaacacttgaaagcacagatactttgtgagttcctaccctcttccaaagaaagaccacgtgtgcatgttgtcatcttcaattacataacagaaatcaataagatatgtgccctcatcataaatatcatctctagcactgccatccaatttagttcaataaaattcaaatataagtttccatgcttttttgtaacatcaaagaaaacatacccatcagtaatttctctaatactgacctttctattctctattaataaaaaattaatacatacaattattcaattctattatattaaaataagttaaagtttataaccactagtctggtcagttaatgtagaaatttaaatagtaaataaaacacaacataatcaaagacaactcactcaggcatcttctttctctaaataccagaatctagtatgtaattgttttcaacactgtccttaaagactaacttgaaagcaggcacagtttgatgaagggctagagagctgtttgcaataaaaagtcaggtttttttcctgatttgaagaagcaggaaaagctgacacccagacaatcacttaagaaaccccttattgatgtatttcatggcactgcaaaggaagaggaatattaattgtatacttagcaagaaaattttttttttctgatagcactttgaggatattagatacatgctaaatatgttttctacaaagacttacgtcatttaatgagcctggggttctggtgttagaatatttttaagtaggctttactgagagaaactaaatattggcatacgttatcagcaacttcccctgttcaatagtatgggaaaaataagatgactgggaaaaagacacacccacaccgtagaacatatattaatctactggcgaatgggaaaggagaccattttcttagaaagcaaataaacttgatttttttaaatctaaaatttacattaatgagtgcaaaataacacataaaatgaaaattcacacatcacatttttctggaaaacagacggattttacttctggagacatggcatacggttactgacttatgagctaccaaaactaaattctttctctgctattaactggctagaagacattcatctatttttcaaatgttctttcaaaacatttttataagtaatgtttgtatctatttcatgctttactgtctatatactaataaagaaatgttttaatactg

SEQ ID NO: 3 - protein, 338 aa, Homo sapiens
MINSTSTQPPDESCSQNLLITQQIIPVLYCMVFIAGILLNGVSGWIFFYVPSSKSFIIYLKNIVIADFVMSLTFPFKILGDSGLGPWQLNVFVCRVSAVLFYVNMYVSIVFFGLISFDRYYKIVKPLWTSFIQSVSYSKLLSVIVWMLMLLLAVPNIILTNQSVREVTQIKCIELKSELGRKWHKASNYIFVAIFWIVFLLLIVFYTAITKKIFKSHLKSSRNSTSVKKKSSRNIFSIVFVFFVCFVPYHIARIPYTKSQTEAHYSCQSKEILRYMKEFTLLLSAANVCLDPIIYFFLCQPFREILCKKLHIPLKAQNDLDISRIKRGNTTLESTDTL

SEQ ID NO: 4 - protein, 338 aa, Artificial Sequence
  Synthetic construct
MVNSTSTQPPDESCSQNLLITQQIIPVLYCMVFIAGILLNGVSGWIFFYVPSSESFIIYLKNIVIADFVMSLTFPFKILGDSGLGPWQLNVFVCRVSGVLFYVNMYVSIVFFGLISFDRYYKIVKPLWTSFIQSVSYSKLLSVIVWMLMLLLAVPNIILTNQSVREVTQIKCIELKSELGRKWHKASNYIFVVIFWIVFLLLIVFYTAITKKIFKSHLKSSRNSTSVKKKSSRNIFSIVFVFIVCFVPYHIVRIPYTKSQTEAHYSCQSKEILRYMKEFTLLLSAANVCLDPIIYFFLCQPFREILCKKLHIPLKAQNDLDISRIKRGNTTLESTDTL

SEQ ID NO: 5 - protein, 338 aa, Artificial Sequence
  Synthetic construct
MVNSTSTQPPDESCSQNLLITQQIIPVLYCMVFIAGILLNGVSGWIFFYVPSSESFIIYLKNIVIADFVMSLTFPFKILGDSGLGPWQLNVFVCRVSGVLFYVNMYVSIVFFGLISFDRYYKIVKPLWTSFIQSVSYSKLLSVIVWMLMLLLAVPNIILTNQSVREVTQIKCIELKSELGRKWHKASNYIFVVIFWIVFLLLIVFYTAITKKIFKSHLKSSRNSTSVKKKSSRNIFSIVFVFIVCFVPYHTVKIPYTKSQTEAHYSCQSKEILRYMKEFTLLLSAANVCLDPIIYFFLCQPFREILCKKLHIPLKAQNDLDISRIKRGNTTLESTDTL

SEQ ID NO: 6 - protein, 338 aa, Artificial Sequence
  Synthetic construct
MVNSTSTQPPDESCSQNLLITQQIIPVLYCMVFIAGILLNGVSGWIFFYVPSSESFIIYLKNIVIADFVMSLTFPFKILGDSGLGPWQLNVFVCRVSGVLFYVNMYVSIVFFGLISFDRYYKIVKPLWTSFIQSVSYSKLLSVIVWMLMLLLAVPNIILTNQSVREVTQIKCIELKSELGRKWHKASNYIFVVIFWIVFLLLIVFYTAITKKIFKSHLKSSRNSTSVKKKSSRNIFSIVFVFIVCFVPYHIVRIPYTKSQTEAHYSCQSKEILRYMKGFTLLLSAANVCLDPIIYFFLCQPFREILCKKLHIPLKAQNDLDISRIKRGNTTLESTDTL

SEQ ID NO: 7 - protein, 338 aa, Artificial Sequence
  Synthetic construct
MVNSTSTQPPDESCSQNLLITQQIIPVLYCMVFIAGILLNGVSGWIFFYVPSSESFIIYLKNIVIADFVMSLTFPFKILGDSGLGPWQLNVFVCRVSGVLFYVNMYVSIVFFGLISFDRYYKIVKPLWTSFIQSVSYSKLLSVIVWMLMLLLAVPNIILTNQSVREVTQIKCIELKSELGRKWHKASNYIFVVIFWIVFLLLIVFYTAITKKIFKSHLKSSRNSTSVKKKSSRNIFSIVFVFIVCFVPYHIVRIPYTKSQTEAHYSCQSKEILRYMKEFTVFLSSANVCLDPIIYFFLCQPFREILCKKLHIPLKAQNDLDISRIKRGNTTLESTDTL

(19) United States
(12) Patent Application Publication
(10) Pub. No.: US 2011/0177964 A1
(43) Pub. Date: Jul. 21, 2011

(54) CHEMOSENSORY ARRAYS

(75) Inventors: James R. Broach, Skillman, NJ (US); Addison D. Ault, Pennington, NJ (US); Alexandre V. Morozov, Princeton, NJ (US); Julia Tsitron, Brooklyn, NY (US)

(73) Assignees: THE TRUSTEES OF PRINCETON UNIVERSITY, Princeton, NJ (US); Rutgers, The State University of New Jersey, New Brunswick, NJ (US)

(21) Appl. No.: 12/960,157

(22) Filed: Dec. 3, 2010

Related U.S. Application Data
(60) Provisional application No. 61/266,420, filed on Dec. 3, 2009.

(51) Int. Cl. C40B 30/04; C40B 60/12; C40B 50/00; C40B 40/10

(52) U.S. Cl. 506/9; 506/39; 506/23; 506/18

(57) ABSTRACT

A chemosensor array, a method of detecting ligands in a chemical mixture and a chemosensor system are provided. Chemosensor array designs are also provided.

This application claims the benefit of U.S. provisional application No. 61/266,420 filed Dec. 3, 2009, which is incorporated herein by reference as if fully set forth.

### FIELD

The disclosure relates to chemosensory arrays, chemosensory systems and associated methods.

### BACKGROUND

Animals evolved sophisticated olfactory systems capable of recognizing thousands of odors, which are airborn chemical compounds of mostly organic origin. The olfactory tasks faced by an animal in its natural environment are essential for its survival and reproduction, and include odor detection and strength estimate, source identification, and mixture separation. The mammalian and insect olfactory systems display amazing sensitivity and discriminatory power, distinguishing between closely related compounds and detecting vanishingly small odorant concentrations.

Olfactory signaling is mediated by a large family of G-protein-coupled receptors (or GPCRs) which interact with a vast pool of odorant molecules. In mammals, GPCRs are located on the surfaces of cilia projected from olfactory sensory neurons; typically only one type of odorant-binding GPCR is expressed in a given neuron. Odor recognition is combinatorial, with one odorant recognized by multiple receptors and one receptor recognizing multiple odorants. Thus different odorants elicit response from different combinations of receptors, enabling robust odor identification and classification.

Even a pure smell elicits a complex response pattern, which makes it possible to recognize an exponentially large number of substances using relatively few receptor types. The activation pattern depends non-linearly on the odorant concentration; with more than one ligand present simultaneously the pattern will depend on the concentration of each constituent chemical in a complex way, making prediction of relative concentrations difficult with traditional pattern-recognition approaches.

### SUMMARY

In an aspect, the invention relates to a method of analyzing a chemical mixture that may contain a plurality of ligands. The method includes providing a chemosensor array including at least one sensor, and a respective reporter operably connected to each of the at least one sensor. Binding of at least one of the plurality of ligands to one of the at least one sensor causes activation of the respective reporter to produce a respective report intensity. Each of the plurality of ligands has a respective free energy of binding with each respective one of the at least one sensor. Each of the at least one sensor has a respective efficacy of activation by each respective one of the plurality of ligands. Each of the at least one sensor has a respective background intensity. The method includes exposing the chemosensor array to the chemical mixture, measuring each of the respective report intensities, and inferring a respective concentration for each of the plurality of ligands from the respective report intensities based on the respective free energies, the respective efficacies and the respective backgrounds.

In an aspect, the invention relates to a chemosensor system. The system includes a chemosensor array including at least one sensor, and a respective reporter operably connected to each of the at least one sensor. Binding of at least one of a plurality of ligands to one of the at least one sensor causes activation of the respective reporter to produce a respective report intensity. Each of the plurality of ligands has a respective free energy of binding with each respective one of the at least one sensor. Each of the at least one sensor has a respective efficacy of activation by each respective one of the plurality of ligands. Each of the at least one sensor has a respective background intensity. The system includes a processor operably connected to the chemosensor array, and a computer-readable medium operably connected to the processor, operably connected to the chemosensor array, and including processor executable instructions for analyzing a chemical mixture that may include the plurality of ligands. The processor executable instructions include directions for receiving data including at least one of the respective report intensities, the respective free energies, the respective efficacies, or respective backgrounds, and inferring a respective concentration for each of the plurality of ligands from the respective report intensities received after exposing the chemosensor array to the chemical mixture. Inferring is based on the respective free energies, the respective efficacies and the respective backgrounds.

In an aspect, the invention relates to a computer-readable medium storing a set of processor-executable instructions for execution by a general purpose computer to perform a method of analyzing a chemical mixture that may contain a plurality of ligands. The method including obtaining data from a chemosensor array including at least one sensor, and a respective reporter operably connected to each of the at least one sensor. Binding of each of the plurality of ligands to each respective one of the at least one sensor causes activation of the respective reporter to produce a respective report intensity. Each of the plurality of ligands has a respective free energy of binding with each respective one of the at least one sensor. Each of the at least one sensor having a respective efficacy of activation by each respective one of the plurality of ligands. Each of the at least one sensor having a respective background intensity. The method also including inferring a respective concentration for each of the plurality of ligands from the respective report intensities based on the respective free energies, the respective efficacies and the respective backgrounds.

In an aspect, the invention relates to a method of making a chemosensor array. The method includes selecting a plurality of ligands to be analyzed by the chemosensor array, each ligand in the plurality of ligands having a range of relative concentrations with respect to the remaining ligands in the plurality of ligands. The method also including selecting a plurality of sensors having i) a respective free energy of binding between with each of the plurality of ligands, and ii) a respective efficacy of activation by each of the plurality of ligands. The method also including defining errors in predicting component concentrations by inferring a concentration of each of the ligands in the plurality of ligands and determining the difference between the inferred concentration and the actual concentration. The method also including minimizing errors by sampling for binding free energies and efficacies between each of the at least one sensor and each of the plurality of ligands and determining a best estimate and associated error for each of the at least one sensor. The method also including selecting sensors from the plurality of sensors for the chemosensor array based the best estimate and associated error for each of the plurality of sensors. The selected sensors for the chemosensor array are capable of detecting whether one of the ligands in the plurality of ligands is present in a chemical mixture that may contain one or more of the plurality of ligands and the concentration of the one of the ligands.

In an aspect, the invention relates to a chemosensor array comprising at least one sensor, and a respective reporter operably connected to each of the at least one sensor. Binding of at least one of a plurality of ligands to one of the at least one sensor causes activation of the respective reporter to produce a respective report intensity. One of the plurality of ligands is an agonist to one of the at least one sensor and a different one of the plurality ligands an antagonist to the one of the at least one sensor. Each of the plurality of ligands has a respective free energy of binding with each respective one of the at least one sensor. Each of the at least one sensor having a respective efficacy of activation by each respective one of the plurality of ligands. Each of the at least one sensor having a respective background intensity.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 illustrates a flow chart for implementing a method of analyzing a chemical mixture.

FIG. 2 illustrates a flow chart for experimental calibration.

FIG. 2A illustrates a Bayesian method.

FIG. 2B illustrates a method of Chemosensor array design.

FIG. 3 illustrates binding of one ligand to one sensor for each of four different ligands and four different sensors.

FIG. 4 illustrates a method of calibration.

FIG. 5A illustrates intensity versus concentration plots.

FIG. 5B illustrates the average standard deviation plotted as a function of total ligand concentrations.

FIG. 5C illustrates prediction accuracy decrease with the amount of noise in the data.

FIG. 6 illustrates a scheme for analyzing unknown chemical mixtures.

FIG. 7 illustrates a method of inference.

FIG. 8.1A illustrates tests of a chemosensor array with an increasing number of receptors and a UDP-Gal+UDP-Glc mixture.

FIG. 8.1B illustrates tests of a chemosensor array with an increasing number of receptors and a UDP-Gal+UDP-Glc mixture.

FIG. 8.1C illustrates tests of a chemosensor array with an increasing number of receptors and a UDP-Gal+UDP-Glc mixture.

FIG. 8.1D illustrates tests of a chemosensor array with an increasing number of receptors and a UDP-Gal+UDP-Glc mixture.

FIG. 8.2A illustrates tests of a chemosensor array with an increasing number of receptors and a UDP-Gal+UDP-GlcNAc mixture.

FIG. 8.2B illustrates tests of a chemosensor array with an increasing number of receptors and a UDP-Gal+UDP-GlcNAc mixture.

FIG. 8.2C illustrates tests of a chemosensor array with an increasing number of receptors and a UDP-Gal+UDP-GlcNAc mixture.

FIG. 8.2D illustrates tests of a chemosensor array with an increasing number of receptors and a UDP-Gal+UDP-GlcNAc mixture.

FIG. 8.3A illustrates tests of a chemosensor array with an increasing number of receptors and a UDP-Glc+UDP-GlcNAc mixture.

FIG. 8.3B illustrates tests of a chemosensor array with an increasing number of receptors and a UDP-Glc+UDP-GlcNAc mixture.

FIG. 8.3C illustrates tests of a chemosensor array with an increasing number of receptors and a UDP-Glc+UDP-GlcNAc mixture.

FIG. 8.3D illustrates tests of a chemosensor array with an increasing number of receptors and a UDP-Glc+UDP-GlcNAc mixture.

FIG. 8.4A illustrates tests of a chemosensor array with an increasing number of receptors and a UDP+UDP-Glc mixture.

FIG. 8.4B illustrates tests of a chemosensor array with an increasing number of receptors and a UDP+UDP-Glc mixture.

FIG. 8.4C illustrates tests of a chemosensor array with an increasing number of receptors and a UDP+UDP-Glc mixture.

FIG. 8.4D illustrates tests of a chemosensor array with an increasing number of receptors and a UDP+UDP-Glc mixture.

FIG. 8.5A illustrates tests of a chemosensor array with an increasing number of receptors and a UDP+UDP-GlcNAc mixture.

FIG. 8.5B illustrates tests of a chemosensor array with an increasing number of receptors and a UDP+UDP-GlcNAc mixture.

FIG. 8.5C illustrates tests of a chemosensor array with an increasing number of receptors and a UDP+UDP-GlcNAc mixture.

FIG. 8.5D illustrates tests of a chemosensor array with an increasing number of receptors and a UDP+UDP-GlcNAc mixture.

FIG. 8.6A illustrates tests of a chemosensor array with an increasing number of receptors and a UDP+UDP-Gal mixture.

FIG. 8.6B illustrates tests of a chemosensor array with an increasing number of receptors and a UDP+UDP-Gal mixture.

FIG. 8.6C illustrates tests of a chemosensor array with an increasing number of receptors and a UDP+UDP-Gal mixture.

FIG. 8.6D illustrates tests of a chemosensor array with an increasing number of receptors and a UDP+UDP-Gal mixture.

FIG. 9 illustrates determinant of the Hessian in the one-receptor, two-ligand case, plotted as a function of ΔG₁, ΔG₂. log₁₀ n^{l}={−3.0, −3.5, . . . , −8.5, −9.0}.

FIG. 10A illustrates matrix elements and the determinant of the Hessian in the agonist-antagonist case, plotted as a function of ΔG₁ and ΔG₂ in the one-receptor, two-ligand system. The efficacies are fixed at A₁=0, A₂=0; α=0.25 and log₁₀ n^{l}={−3.0, −3.5, . . . , −8.5, −9.0}.

FIG. 10B illustrates matrix elements and the determinant of the Hessian in the agonist-antagonist case, plotted as a function of ΔG₁. and ΔG₂ in the one-receptor, two-ligand system. The efficacies are fixed at A₁=0, A₂=0; α=0.25 and log₁₀ n^{l}={−3.0, −3.5, . . . , −8.5, −9.0}.

FIG. 10C illustrates matrix elements and the determinant of the Hessian in the agonist-antagonist case, plotted as a function of ΔG₁ and ΔG₂ in the one-receptor, two-ligand system. The efficacies are fixed at A₁=0, A₂=0; α=0.25 and log₁₀ n^{l}={−3.0, −3.5, . . . , −8.5, −9.0}.

FIG. 10D illustrates matrix elements and the determinant of the Hessian in the agonist-antagonist case, plotted as a function of ΔG₁ and ΔG₂ in the one-receptor, two-ligand system. The efficacies are fixed at A₁=0, A₂=0; α=0.25 and log₁₀ n^{l}={−3.0, −3.5, . . . , −8.5, −9.0}.

FIG. 11 illustrates optimal free energies ΔG and efficacies A obtained by maximizing the determinant of the Hessian in the four-ligand-two-receptor, four-ligand-three-receptor, and four-ligand-four-receptor cases. In each case, α₁=0.0001, α₂=0.1, and α₃=0.5. log₁₀ n^{l}={−3.0, −3.5, . . . , −8.5, −9.0}.

FIG. 12 illustrates number of ligands detected versus number of receptors. log₁₀ n^{l}={−3.0, −3.5, . . . , −8.5, −9.0}.

FIG. 13 illustrates optimal ΔG values for several cases: (i) one-receptor, two-ligand (ii) two-receptor, three-ligand (iii) two-receptor, three-ligand (at a local maximum) (iv) two-receptor, four-ligand (v) three-receptor, four-ligand (vi) four-receptor, four-ligand and (vii) four-receptor, four-ligand with an ‘auxiliary’ receptor. Underlined values correspond to an efficacy of A=0 (antagonist), while values without an underline correspond to A=1 (agonist).

FIG. 14A illustrates matrix elements of the Hessian in the agonist-antagonist case, plotted as a function of ΔG₁ and ΔG₂ in the one-receptor, two-ligand system. The efficacies are fixed at A₁=1, A₂=0; =0.25 and log₁₀ n^{l}={−3.0, −3.5, . . . , −8.5, −9.0}.

FIG. 14B illustrates matrix elements of the Hessian in the agonist-antagonist case, plotted as a function of ΔG₁ and ΔG₂ in the one-receptor, two-ligand system. The efficacies are fixed at A₁=1, A₂=0; =0.25 and log₁₀ n^{l}={−3.0, −3.5, . . . , −8.5, −9.0}.

FIG. 14C illustrates matrix elements of the Hessian in the agonist-antagonist case, plotted as a function of ΔG₁ and ΔG₂ in the one-receptor, two-ligand system. The efficacies are fixed at A₁=1, A₂=0; =0.25 and log₁₀ n^{l}={−3.0, −3.5, . . . , −8.5, −9.0}.

FIG. 14D illustrates matrix elements of the Hessian in the agonist-antagonist case, plotted as a function of ΔG_{S}. and ΔG₂ in the one-receptor, two-ligand system. The efficacies are fixed at A₁=1, A₂=0; α=0.25 and log₁₀ n^{l}={−3.0, −3.5, . . . , −8.5, −9.0}.

FIG. 14E illustrates matrix elements of the Hessian in the agonist-antagonist case, plotted as a function of ΔG₁ and ΔG₂ in the one-receptor, two-ligand system. The efficacies are fixed at A₁=1, A₂=0; α=0.25 and log₁₀ n^{l}={−3.0, −3.5, . . . , −8.5, −9.0}.

FIG. 14F illustrates matrix elements of the Hessian in the agonist-antagonist case, plotted as a function of ΔG₁ and ΔG₂ in the one-receptor, two-ligand system. The efficacies are fixed at A₁=1, A₂=0; α=0.25 and log₁₀ n^{l}={−3.0, −3.5, . . . , −8.5, −9.0}.

FIG. 15A illustrates matrix elements and the determinant of the Hessian in the agonist-agonist case, plotted as a function of ΔG₁ and ΔG₂ in the one-receptor, two-ligand system. The efficacies are fixed at A₁=1, A₂=1; α=1 and log₁₀ n^{l}={−3.0, −3.5, . . . , −8.5, −9.0}.

FIG. 15B illustrates matrix elements and the determinant of the Hessian in the agonist-agonist case, plotted as a function of ΔG₁ and ΔG₂ in the one-receptor, two-ligand system. The efficacies are fixed at A₁=1, A₂=1; α=1 and log₁₀ n^{l}={−3.0, −3.5, . . . , −8.5, −9.0}.

FIG. 15C illustrates matrix elements and the determinant of the Hessian in the agonist-agonist case, plotted as a function of ΔG₁ and ΔG₂ in the one-receptor, two-ligand system. The efficacies are fixed at A₁=1, A₂=1; α=1 and log₁₀ n^{l}={−3.0, −3.5, . . . , −8.5, −9.0}.

FIG. 15D illustrates matrix elements and the determinant of the Hessian in the agonist-agonist case, plotted as a function of ΔG₁ and ΔG₂ in the one-receptor, two-ligand system. The efficacies are fixed at A₁=1, A₂=1; α=1 and log₁₀ n^{l}={−3.0, −3.5, . . . , −8.5, −9.0}.

FIG. 16A illustrates Changes in the Hessian determinant with the concentration of the second ligand. Each determinant is plotted as a function of _{┌}G₁ and ΔG₂ for a given value of =n₂/n₁, with log₁₀ n^{l}={−3.0, −3.5, . . . , −8.5, −9.0}. The efficacies are fixed at A₁=1, A₂=0. FIGS. 16A-D show the optimal ΔG₁ and ΔG₂ corresponding to the maximum value of the determinant.

FIG. 16B illustrates Changes in the Hessian determinant with the concentration of the second ligand. Each determinant is plotted as a function of _{┌}G₁ and ΔG₂ for a given value of =n₂/n₁, with log₁₀ n^{l}={−3.0, −3.5 . . . , −8.5, −9.0}. The efficacies are fixed at A₁=1, A₂=0. FIGS. 16A-D show the optimal ΔG₁ and ΔG₂ corresponding to the maximum value of the determinant.

FIG. 16C illustrates Changes in the Hessian determinant with the concentration of the second ligand. Each determinant is plotted as a function of _{┌}G₁ and ΔG₂ for a given value of =n₂/n₁, with log₁₀ n^{l}={−3.0, −3.5, . . . , −8.5, −9.0}. The efficacies are fixed at A₁=1, A₂=0. FIGS. 16A-F show the optimal ΔG₁ and ΔG₂ corresponding to the maximum value of the determinant.

FIG. 16D illustrates Changes in the Hessian determinant with the concentration of the second ligand. Each determinant is plotted as a function of _{┌}G₁ and ΔG₂ for a given value of =n₂/n₁, with log₁₀ n^{l}={−3.0, −3.5, . . . , −8.5, −9.0}. The efficacies are fixed at A₁=1, A₂=0. FIGS. 16A-F show the optimal ΔG₁ and ΔG₂ corresponding to the maximum value of the determinant.

FIG. 16E illustrates Changes in the Hessian determinant with the concentration of the second ligand. Each determinant is plotted as a function of _{┌}G₁ and ΔG₂ for a given value of =n₂/n₁, with log₁₀ n^{l}={−3.0, −3.5, . . . , −8.5, −9.0}. The efficacies are fixed at A₁=1, A₂=0. FIGS. 16A-F show the optimal ΔG₁ and ΔG₂ corresponding to the maximum value of the determinant.

FIG. 16F illustrates Changes in the Hessian determinant with the concentration of the second ligand. Each determinant is plotted as a function of _{┌}G₁ and ΔG₂ for a given value of =n₂/n₁, with log₁₀ n^{l}={−3.0, −3.5, . . . , −8.5, −9.0}. The efficacies are fixed at A₁=1, A₂=0. FIGS. 16A-F show the optimal ΔG₁ and ΔG₂ corresponding to the maximum value of the determinant.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

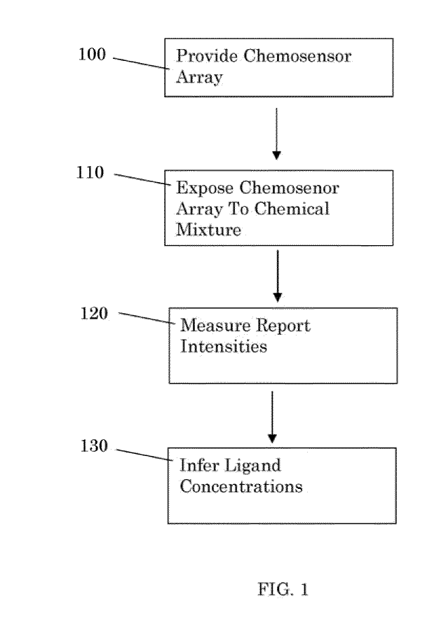

Referring to FIG. 1, an embodiment provides a method of analyzing a chemical mixture that may contain a plurality of ligands. The method may include a step 100 of providing a chemosensor array. The chemosensor array may include at least one sensor, and a respective reporter operably connected to each of the at least one sensor. Binding of at least one of the plurality of ligands to one of the at least one sensor may cause activation of the respective reporter to produce a respective report intensity. Each of the plurality of ligands may have a respective free energy of binding with each respective one of the at least one sensor. Each of the at least one sensor has a respective efficacy of activation by each respective one of the plurality of ligands. Each of the at least one sensor may have a respective background intensity. The method may include at least one of: step 110 of exposing the chemosensor array to the chemical mixture, step 120 of measuring each of the respective report intensities, and step 130 of inferring a respective concentration for each of the plurality of ligands from the respective report intensities based on the respective free energies, the respective efficacies and the respective backgrounds.

The plurality of ligands may include 2, 3, 4, 5, 6, 7, 8, 9, 10 or more ligands having a respective free energy of binding and a respective efficacy for each of the at least one sensor. The at least one sensor may include 1, 2, 3, 4, 5, 6, 7, 8, 9, 10 or more sensors. Multiple sensors may be provided in the at least one sensor that have the same free energy of binding and efficacy to one of the plurality of ligands. Additional sensors may be provided having different free energies of binding or efficacies toward the one of the plurality of ligands than the multiple sensors.

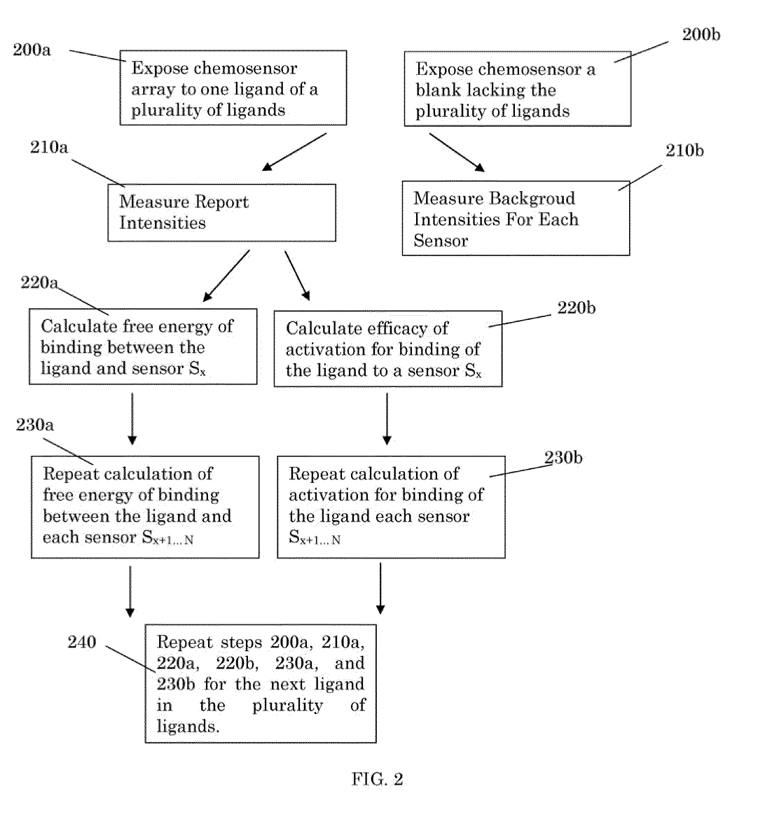

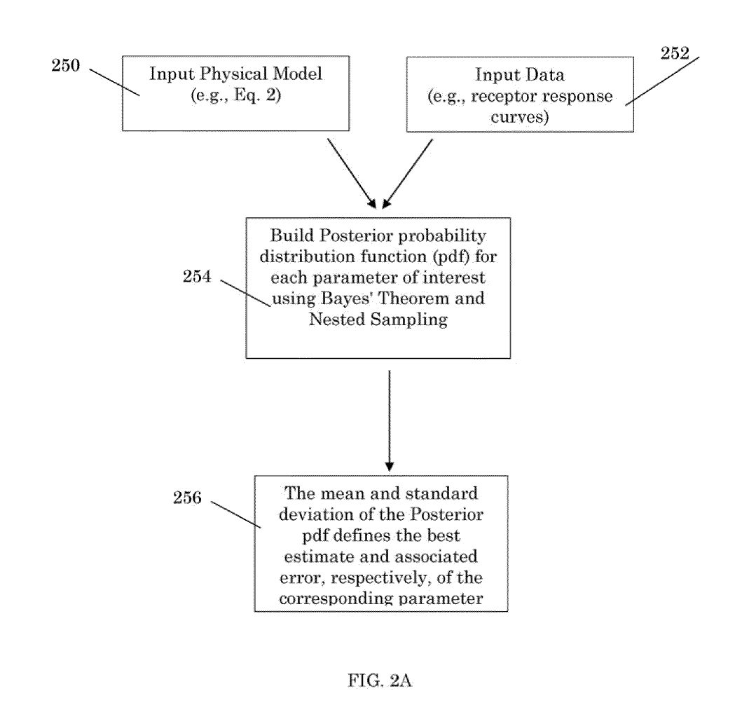

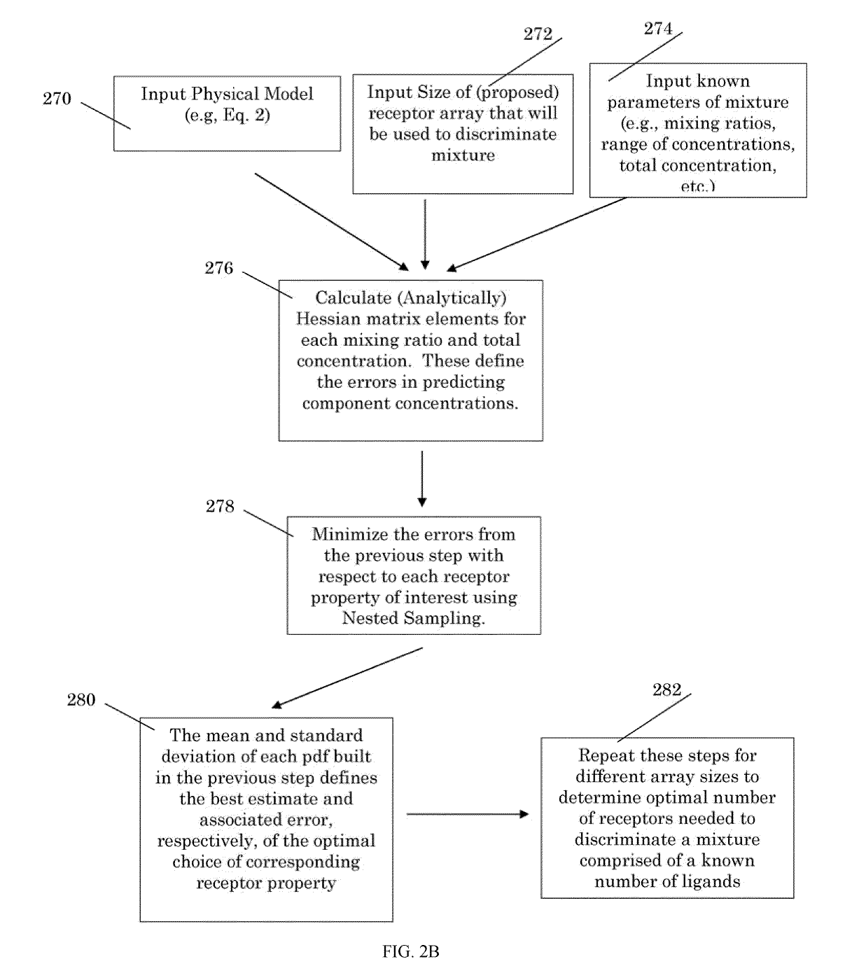

The method may also include obtaining the respective free energy and respective efficacy for each of the at least one sensor in comparison to each of the plurality of ligands. This value may be referred to as the sensor efficacy. Obtaining any one or more of these values may be done by experimental calibration. Referring to FIG. 2, experimental calibration may include step 200 of exposing the chemosensor array to one of the plurality of ligands. Experimental calibration may also include step 210a of measuring the report intensities from the sensors after exposing the chemosensor array to the one ligand. Based on the measured report intensities at step 210a, the method may include step 220a of calculating the free energy of binding between one of the sensors and the ligand, and step 220b of calculating the efficacy of activation for the ligand with respect to one sensor. Calculating the free energy of binding for the ligand may be repeated for each of the remaining sensors, as shown at step 230a. Also, the step of calculating the efficacy of activation for the ligand with respect to a sensor maybe repeated for each of the remaining sensors, as shown at step 230b.

Still referring to FIG. 2, the method may also include obtaining the respective backgrounds for each sensor at steps 200b and 210b. As shown, the respective backgrounds may be obtained by exposing the chemosensor array to a blank that lacks the plurality of ligands. The blank may have the same constituents as the chemical mixture but for the presence of the plurality of ligands. Or the blank may have a different composition than the chemical mixture. In an alternative, the chemosensor array is not exposed to any additional chemical mixture at step 200b, but the background intensities due to ambient conditions are measured for each sensor at step 210b. The values obtained for the respective free energies, respective efficacies and respective backgrounds through experimental calibration may be utilized during step 130 in order to infer ligand concentrations.

The respective free energies, efficacies and backgrounds may be obtained by methods other than experimental calibration. One or more of these values may be provided based on prior experimental calibrations. One or more of these values may be stored in a computer-readable medium. One or more of these values may be listed in a manual or other index of the values. Whether obtained from experimental calibration, prior experimental calibrations, from an index, from a computer-readable medium or any other source, the respective free energies, efficacies and backgrounds may be obtained and utilized as part of step 130 in order to infer ligand concentrations.

In an embodiment, at least one of the presence or concentration of each ligand of a plurality of ligands in a chemical mixture can be inferred by calculating a fractional amount of each sensor that is bound to each of the plurality of ligands. This can be done for each ligand-sensor pair. By applying Bayesian inference with nested sampling to the resulting data sets, the total concentration of all of the ligands in the plurality of ligands and ratios of pairs of ligands in the plurality of ligands can be obtained. From this information, the concentration of each one of the plurality of ligands in the chemical mixture can be deduced.

Referring to FIG. 2A, a method of Bayesian inference is illustrated. As shown, the method of Bayesian inference may include inputting a physical model at step 250. The physical model may be any physical model of ligand-sensor interaction. In an embodiment, the model is Eq. 2. However, other models may be utilized. The method of Bayesian inference may also include inputting data at step 252. The data may be in the form of receptor response curves. The method of Bayesian inference may also include building a posterior probability distribution function (pdf) for each parameter of interest using Bayes' Theorem. Nested Sampling may be utilized in this step. The mean and standard deviation of the Posterior pdf defines the best estimate and associated error, respectively, of the corresponding parameter.

The Bayesian method allows quantifying how much to believe a given model accurately represents a set of data. Bayesian inference yields the posterior distribution; i.e., the probability of the parameters of interest given the data. The narrower this distribution, the more confidence in a best estimate of the parameters. There are numerous sampling algorithms used to generate the posterior probability distributions (including but not limited to simulated annealing, Metropolis-Hastings, slice sampling, and importance sampling). Nested sampling may be used because of its robustness in high-dimensional problems such as the ones encountered when dealing with large receptor arrays and mixtures comprised of many components. Nested sampling also has an advantage of yielding the value of the evidence.

A model of sensor-ligand interactions may be used to infer the concentrations of individual ligands in a chemical mixture. The model may take in to account the physics of sensor-ligand interactions.

In an embodiment, a method of designing a chemosensor array is provided. A model taking in to account the physics of sensor-ligand interaction may be utilized in the method of design. Referring to FIG. 2C, a method of designing a chemosensor array is provided. The method may include inputting a physical model at step 270. In an embodiment, the physical model is Eq. 2. But other models may be utilized. The method of design also includes inputting the size of a proposed receptor array that will be used to discriminate (analyze) a chemical mixture. At step 274, the method may include inputting known parameters of the chemical mixture. The known parameters may include mixing ratios, range of concentrations, total concentration, etc. At step 276, the method of design includes calculating (Analytically) Hessian matrix elements for each mixing ratio and total concentration. These define the errors in predicting component concentrations. The method may also include minimizing the errors from the previous step with respect to each receptor property of interest using Nested Sampling. As shown at box 280, the mean and standard deviation of each pdf built previously defines the best estimate and associated error, respectively, of the optimal choice of corresponding receptor property. As shown at step 282, the method may include repeating these steps for different array sizes to determine optimal number of receptors needed to discriminate a mixture comprised of a known number of ligands.

In an embodiment, a method of making a chemosensor array includes selecting a plurality of ligands to be analyzed by the chemosensor array. Each ligand in the plurality of ligands may have a range of relative concentrations with respect to the remaining ligands in the plurality of ligands. The method may include selecting a plurality of sensors having i) a respective free energy of binding between with each of the plurality of ligands, and ii) a respective efficacy of activation by each of the plurality of ligands. The method may include defining errors in predicting component concentrations by inferring a concentration of each of the ligands in the plurality of ligands and determining the difference between the inferred concentration and the actual concentration. The method may include minimizing errors by sampling for binding free energies and efficacies between each of the at least one sensor and each of the plurality of ligands and determining a best estimate and associated error for each of the at least one sensor. The method may include selecting sensors from the plurality of sensors for the chemosensor array based the best estimate and associated error for each of the plurality of sensors that are capable of detecting whether one of the ligands in the plurality of ligands is present in a chemical mixture that may contain one or more of the plurality of ligands and the concentration of the one of the ligands. Selecting sensors may include choosing a set of sensors having less associated error than remaining sensors in the plurality of sensors. Selecting sensors may include choosing a set of sensor having the least associate error. The method may include repeating the steps of selecting a plurality of sensors, determining, analytically calculating, and minimizing errors for the plurality of sensors, wherein the plurality of sensors includes a different number of individual sensors for one or more of the repetitions.

A non-limiting example of a sensor-ligand interactions is provided herein to describe an embodiment of a physical model of sensor-ligand interactions that can be used to infer concentrations of individual ligands in a chemical mixture. This exemplary combinatorial chemosensor array includes sensors in the form of four engineered GPCRs with distinct but overlapping specificities for four types of nucleotide sugars: UDP-glucose (UDP-Glc), UDP-galactose (UDP-Gal), UDP and UDP-glucosamine (UDP-GlcNAc). The receptors were evolved in vivo from the human UDP-glucose receptor using directed mutagenesis of the residues involved in ligand binding, as described below in the examples section. Nucleotide sugars and their derivatives are key constituents in polysaccharide synthesis and other cellular processes. Their structural similarity makes them a challenging target for array-based discriminatory analysis. And the details described with reference to this example may be utilized to implement any method of analyzing a chemical mixture other than the exemplary chemical mixture. Further, the information may be utilized to implement other methods of designing a chemosensor array, other chemosensor systems, other computer-readable media having instructions for analyzing a chemical mixture, other chemosensor arrays.

To assess receptor ligand interactions quantitatively in the chemosensor array, the receptors were functionally expressed in yeast. To do so, the yeast pheromone receptor was replaced with one of the sensor GPCRs in strains in which the pheromone response pathway was modified to respond to the heterologous receptor by inducing transcription of the E. coli lacZ gene. See the example section below. In this fashion, the extent of GPCR activation following ligand addition could be monitored as the level of β-galactosidase produced in the cell, which was measured using a fluorescence-based assay. See the example section below.

Applying a mixture of nucleotide sugars to the receptor array yields a complex pattern of responses of the four receptor bearing strains. The response of each receptor depends on the concentration of the components in the mixture, on the receptor-ligand binding affinities and on the efficacy with which each ligand activates the receptor. The contents of arbitrary mixtures can be deciphered using array readout as input to a physical model of receptor ligand interactions.

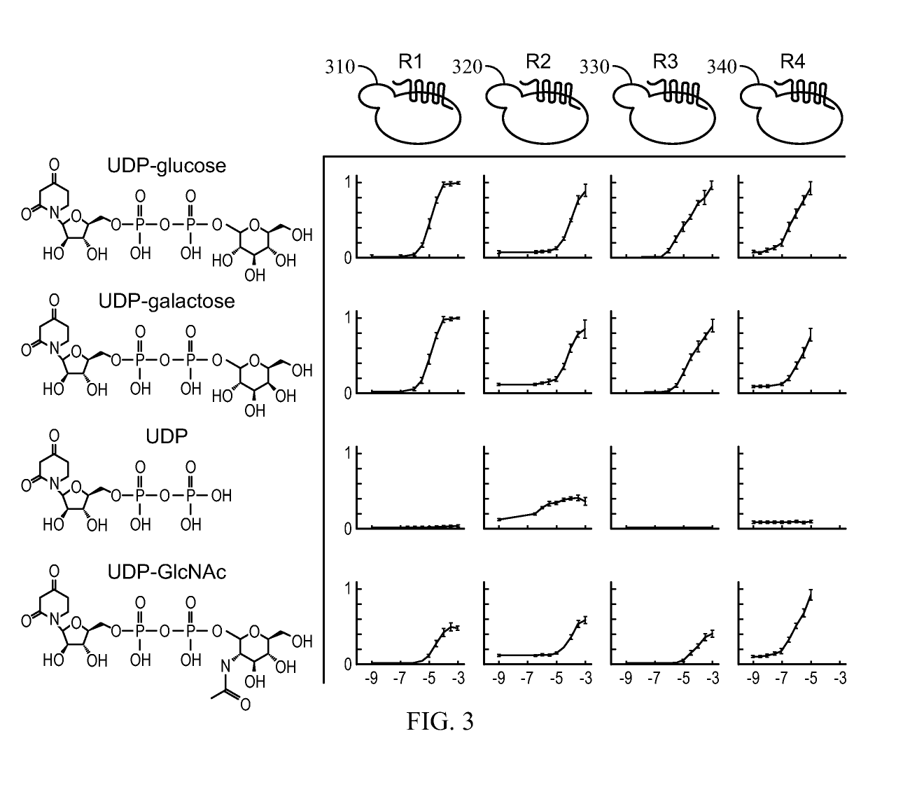

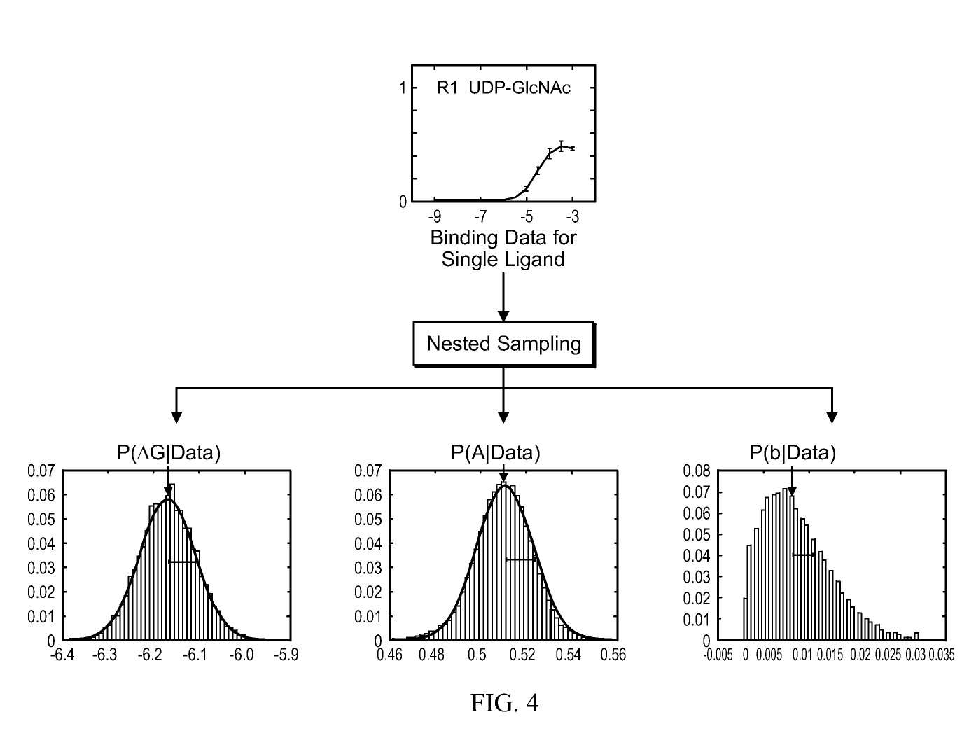

Receptor responses to binding of a single ligand. It was assumed that the observed signal in the receptor-bearing reporter strain is proportional to the probability that the receptor is bound by the ligand. This proportionality value, A, which is referred to as the receptor efficacy, can range from 1, for a full agonist, to 0, for a full antagonist, with intermediate values indicating partial agonist activity. In the simplest case of a single receptor interacting with a single ligand, the amount of activation of the reporter in the receptor bearing strain is given by:

$${I}^{l} ( Δ G , A , b ) = A \frac{{e}^{- β ( Δ G - {μ}^{l} )}}{1 + {e}^{- β ( Δ G - {μ}^{l} )}} + b , \qquad ( 1 )$$

where A is the receptor efficacy, ΔG is the receptor-ligand binding free energy, b is the background intensity, β=1/k_{B}T (k_{B} is the Boltzmann constant, and T is the temperature), and μ^{l}=k_{B}T log n^{l}, which is the chemical potential, where n^{l} is the ligand concentration. In the example of fluorescing products, I can be measured by a fluorescent assay, but the intensity of any report may be utilized. Referring to FIG. 3, binding curves for each single receptor-single ligand combination are shown. Receptors R1 (310), R2 (320), R3 (330), and R4 (340) are illustrated in a grid with the four ligands UDP-glucose, UDP-galactose, UDP and UDP-GlcNAc. In this example, the four receptors are R1: H-20, R2: K-3, and R3: L-3, R4: 2211. See the example section below for details regarding these receptors. Each receptor-ligand combination is tested for functional activation, yielding 16 binding curves, shown in the grid between the receptors and the ligands. For each curve, intensity normalized by the maximum intensity on the plate is plotted against log₁₀ n (n is the ligand concentration in M). The error bars on each curve are from four biological replicates. The single receptor-single ligand binding curves can be used to calibrate the biophysical model (Eq. (1)) by inferring ΔG, A and b for each receptor-ligand combination and knowledge of μ^{l}. Specifically, Bayesian inference is applied. Referring to FIG. 4, the posterior probability P(ΔG, A, b, σ|{Ĩ}) is found by nested sampling (see below), where Ĩ=(l=1 . . . N) is the lth fluorescent and a is the noise parameter. FIG. 4 illustrates single ligand-single receptor binding curves used to infer binding free energy ΔG, efficacy A, and background intensity b for every receptor-ligand combination. Histograms for each predicted parameter are based on an ensemble of 50000 models sampled by Metropolis Monte Carlo (See Metropolis N, et al. (1953) Equation of state by fast computing machines. J. Chem. Phys. 21:1087-1092, which is incorporated herein by reference as if fully set forth) starting from the log-likelihood maximum found by nested sampling (See Sivia D, Skilling J (2006) Data analysis: A Bayesian tutorial (Oxford University Press, Oxford), which is incorporated herein by reference as if fully set forth). Arrows and error bars indicate the most likely value of each parameter and its standard deviation. This step provides calibration by returning the most likely value of ΔG, A and b for each receptor-ligand pair, as well as a value σ, which represents the noise in the response. The average value of each parameter obtained by marginalization of the posterior probability can be subsequently used for analysis of a mixture of compounds. Examples of such average values are provided in Table A, below.

TABLE A

| | | UDP-Gal | UDP-Glc | UDP-GlcNAc | UDP |
|---|---|---|---|---|---|
| H-20 (R1) | ΔG | −6.69 ± .04 | −6.29 ± .06 | −6.16 ± .06 | −7.42 ± .05 |
| | A | .994 ± .005 | .74 ± .01 | .51 ± .01 | .008 ± .009 |
| | b | .015 ± .009 | .014 ± .009 | .008 ± .006 | .006 ± .005 |
| | σ | .041 ± .005 | .037 ± .005 | .029 ± .004 | .036 ± .004 |
| K-3 (R2) | ΔG | −5.64 ± .07 | −5.36 ± .04 | −5.36 ± .06 | −8.2 ± .2 |
| | A | .81 ± .02 | .94 ± .02 | .55 ± .01 | .18 ± .01 |
| | b | .11 ± .01 | .069 ± .008 | .111 ± .006 | .10 ± .02 |
| | σ | .043 ± .005 | .030 ± .004 | .022 ± .003 | .022 ± .003 |
| L-3 (R3) | ΔG | −6.21 ± .07 | −6.6 ± .1 | −5.60 ± .06 | −7.4 ± .1 |
| | A | .85 ± .03 | .83 ± .03 | .43 ± .01 | .02 ± .02 |
| | b | .02 ± .01 | .04 ± .02 | .007 ± .004 | .01 ± .01 |
| | σ | .049 ± .007 | .070 ± .009 | .018 ± .002 | .064 ± .009 |
| 2211 (R4) | ΔG | −7.69 ± .09 | −8.48 ± .08 | −8.00 ± .09 | −10.3 ± .3 |
| | A | .82 ± .04 | .85 ± .02 | .89 ± .04 | .010 ± .009 |
| | b | .094 ± .008 | .08 ± .01 | .11 ± .01 | 0.05 ± .01 |
| | σ | .035 ± .005 | .046 ± .006 | .044 ± .006 | .019 ± .002 |

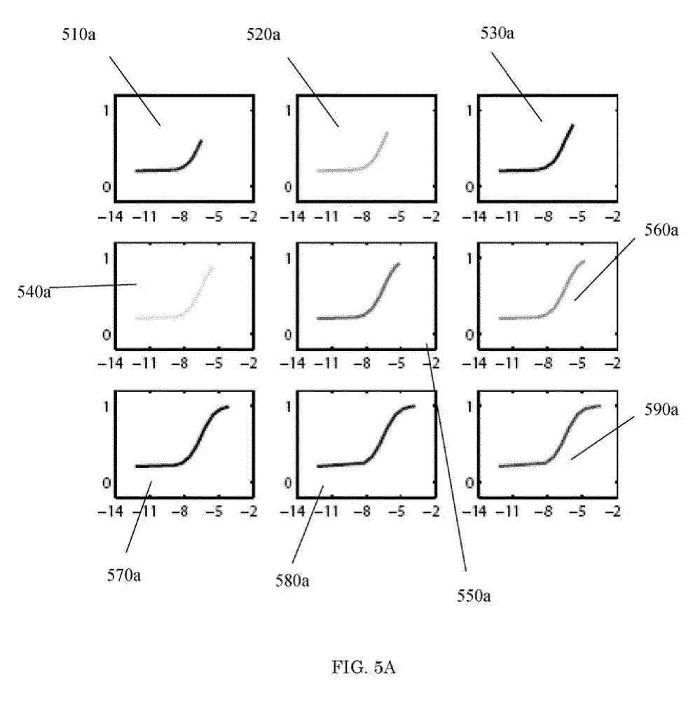

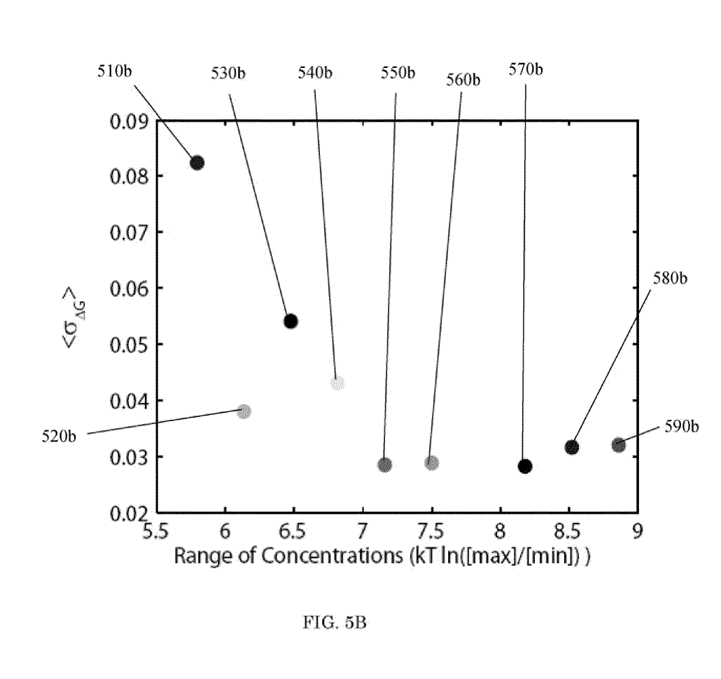

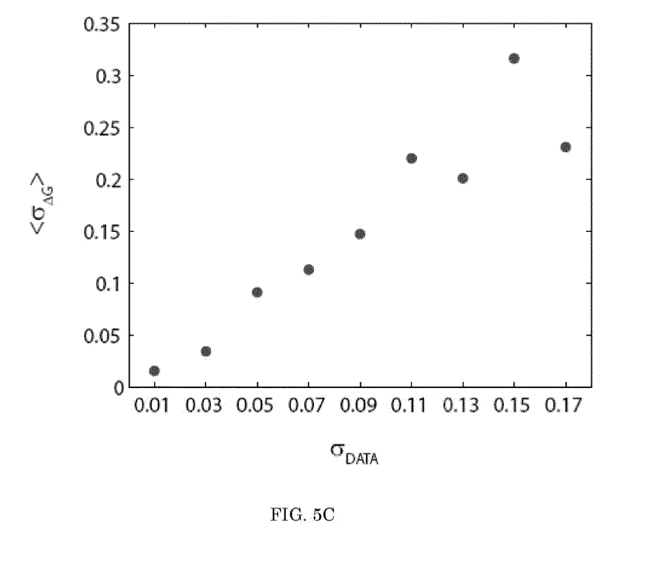

Referring to FIGS. 5A, 5B and 5C the accuracy of parameter predictions may depend on the range of concentrations available in these calibration experiments and on the amount of noise in the data. Synthetic data was generated using Eq. (1) with A=0.8, b=0.2, and ΔG=−6.5 kcal/mol. To account for experimental error, Gaussian noise with σDATA=0.02 was added to the intensity from Eq. (1). The maximum total concentration of the ligand was gradually increased for each ligand in comparison to each receptor, as shown in the nine panels 510a, 520a, 530a, 540a, 550a, 560a, 570a, 580a and 590a in FIG. 5A. This process yielded more and more complete binding curves: log₁₀ [max]={−2.5, −2.75, −3.0, −3.5, −3.75, −4.0, −4.25, −4.5, −4.75}. log₁₀ [min] was −9.0 in all cases, and 4 replicates with 9 datapoints per curve were created for each concentration range. In FIG. 5A, I^{l} is plotted as a function of μ^{l} in the absence of noise. For each concentration range, 1000 nested sampling runs were carried out to predict ΔG, A and b. The standard deviation σΔG from each run was averaged and plotted in FIG. 5B as a function of the total range of ligand concentrations k_{B}T ln([max]/[min]). Each dot 510b, 520b, 530b, 540b, 550b, 560b, 570b, 580b and 590b in FIG. 5B corresponds the FIG. 5A binding curve 510a, 520a, 530a, 540a, 550a, 560a, 570a, 580a and 590a, respectively. For FIG. 5C, synthetic data was generated using Eq. (1) with A=0.8, b=0.2, and ΔG=−6.5 kcal/mol. In analogy with the experiments, the concentration was changed in the log₁₀ nₗ={−3.0, −3.5, . . . , −6.5, −9.0} range and 4 replicates were created, yielding 36 datapoints. To model the increase in experimental error, Gaussian noise with σ_{DATA} ranging from 0.01 to 0.17 was added to the intensity from Eq. (1). For each value of σ_{DATA}, 1000 nested sampling runs were carried out to predict ΔG, A and b. The standard deviation σΔG from each run was averaged and plotted as a function of σ_{DATA}.

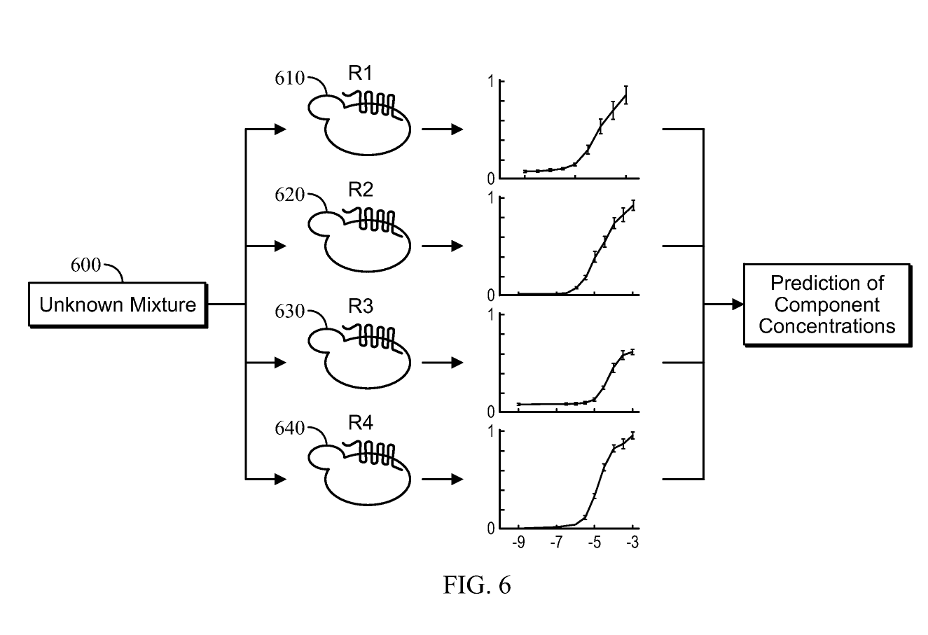

Analyzing ligand mixtures with multiple receptors. Referring to FIG. 6, each ligand in unknown mixture 600 may contribute to the overall receptor occupancy and thus to the observed intensity. In considering the response of receptor-bearing strains to mixtures of ligands, each ligand may contribute to the overall receptor occupancy and each receptor molecule R1 (610), R2 (620), R3 (630), R4 (640) on the cell surface may activate its respective reporter with an efficacy specified by the ligand to which it is bound. In the embodiment illustrated in FIG. 6, the unknown mixture 600 of four ligands is applied to each of the four receptors R1 (610), R2 (620), R3 (630), R4 (640). In this example, the receptors are R1: H-20, R2: K-3, R3: L-3, R4: 2211. See below, for details of these receptors. The resulting fluorescent response curves are used as input to the Bayesian algorithm designed for predicting the absolute concentrations of each ligand in the mixture. The efficacy may be different for different ligands. For example, see Table A, above. By assuming that all ligands bind competitively, that is to the same site on the receptor, it is possible to computationally model the response of the receptor-bearing strain to mixtures of compounds by calculating the fractional amount of the receptor bound to each ligand and the extent to which each separate fraction of ligand bound receptor results in a report, which in this example is induction of β-galactosidase. The former value is a function of the concentrations of all the ligands and the free energies of receptor ligand interactions, and the latter value can be assumed to be equivalent to that obtained with single ligand assays. Accordingly, the observed intensity (reporter response) to mixtures of ligands can be represented as:

$${I}_{k}^{l} = {\sum }_{m = 1}^{{N}_{lig}} {A}_{m}^{k} {p}_{m}^{k , l} + {b}^{k} , \qquad ( 2 )$$

where Iₖ^{l} is the respective report intensity, k=1 . . . N_{rec} for each of the at least one sensor, m=1 . . . N_{lig} for each of the plurality of ligands, pₘ^{k,l}=e^{-β(ΔG}^{ₘ}_{^{k}}^{-μ}^{ₘ}_{^{l}}⁾/Z^{k,l} is the probability that a respective one of the at least one sensor (k) is bound by one of the at least one ligand (m), Z^{k,l}=1=Σᵢ₌^{N}^{_{lig}}e^{-β(ΔG}^{ᵢ}_{^{k}}^{-μ}^{ᵢ}_{^{l}}⁾, β1/k_{B}T, k_{B} is the Boltzmann constant, ΔGₘ^{k} is the respective free energy of binding between receptor k and ligand m, Aₘ^{k} is the respective efficacy (which depends on both ligand and receptor types), b^{k} is the respective background intensity. Binding affinities, receptor efficacies, and background intensities are already known for each receptor from calibration experiments. The background intensity for receptor k may be the average from all calibration experiments involving that receptor. μₘ^{l}=k_{B}T log nₘ^{l} is the chemical potential of one of the ligands, which can be expressed through the total chemical potential μ^{l}=k_{B}T log n^{l}(n^{l}=ρᵢ₋₁^{N}^{_{lig}}nᵢ^{l} is the total concentration) and the mixing ratios αₘ=nₙ₊₁^{l}/n₁^{l}(∀l, m=1 . . . N_{lig}−1):

$${μ}_{1}^{l} = {μ}^{l} + {k}_{B} T log \frac{1}{S} , \\ {μ}_{m}^{l} = {μ}^{l} + {k}_{B} T log \frac{{α}_{m - 1}}{S} , \\ m = 2 , 3 , … , \qquad ( 3 )$$

where S=1+Σᵢ₌₁^{N}^{_{lig−1}}αᵢ, and μ^{l} is given by μ^{l}=μ−(l−1)Δp^{l} (l=1 . . . N), which is Eq. 6. N is the number of measurements in the series, and the dilution steps Δμ^{l} depend on the value of μ which is defined as μ=−3 k_{B}T log(10). Each series of measurements may be carried out multiple times; e.g., four times, with the same mixture.

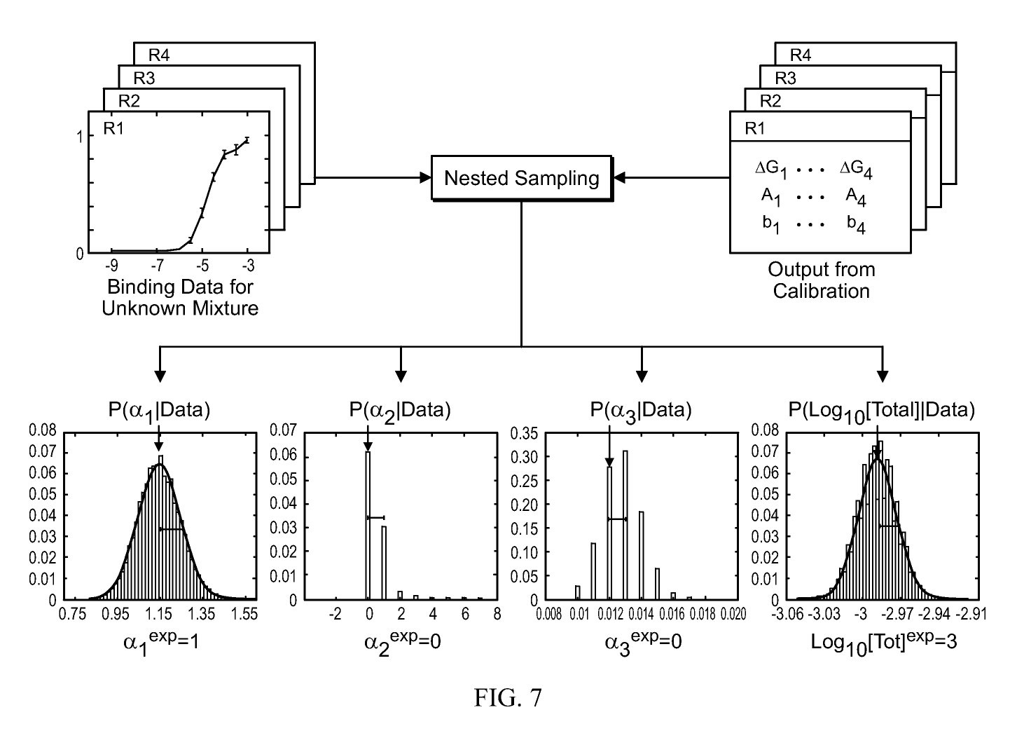

Referring to FIG. 7, nested sampling was used to estimate the posterior probability P({α}, μ, {σ}|{Ĩ}) (Eq. 12, below) and its information content (See, for example, FIG. 7). This step is similar to that illustrated in FIG. 4 for calibrating, or obtaining ΔG, A and backgrounds for single receptor-single ligand experiments. To avoid fitting too many parameters simultaneously, a may be inferred from each single receptor—multiple ligand binding curve and kept fixed in subsequent predictions which integrate data from multiple receptors. As illustrated in FIG. 7, model parameters from FIG. 4 together with the response curves for all receptors serve as input to the nested sampling algorithm which predicts relative concentrations α₁ of each component (with respect to one arbitrarily chosen component, cf. Eq. (3)) and the total concentration log₁₀ n of all ligands in the mixture. Together these predictions yield absolute concentrations for each constituent ligand. Histograms, arrows, and error bars have the same meaning as in FIG. 4, and experimentally known values are shown below each panel ([Tot]=1 mM at the reference point).

In applying Eq. 2 to determine the composition of mixtures of ligands, each of the receptor bearing strains is treated with an unknown mixture, which may be diluted to provide a series of samples of the unknown across a thousand fold range of concentrations. As described above, by applying Bayesian inference with nested sampling to the resulting data sets for all the receptors and using the individual free energies of ligand-receptor interactions and efficacy values calculated from the calibration studies, the most likely total concentration of all ligands and the concentration ratios of pairs of ligands can be recovered. From these values, the concentration of each of the ligands in the mixture is deduced.

Hessian matrix as a measure of model performance. With sufficiently flat priors, variation of the posterior probability with model parameters is determined by the log-likelihood (Eq. (12), below). The log-likelihood as a function of model parameters can be viewed as a multidimensional landscape. The global maximum on this landscape corresponds to the model that best describes the data, while the curvature at the maximum reveals how sensitive the likelihood is to the change in each parameter. Narrow peaks result in precisely defined models, whereas a wide plateau leading to a relatively flat maximum yields many nearly equivalent parameter sets. Expanding the log-likelihood in the vicinity of its maximum and truncating the expansion at second order yields a Hessian matrix which contains information about the sharpness of the log-likelihood peak. In the low-noise limit, the Hessian can be written as:

$$\frac{{\partial }^{2} ℒ}{\partial {γ}_{i} \partial {γ}_{j}} = - {\sum }_{k = 1}^{{N}_{rec}} \frac{1}{{σ}_{k}^{2}} {\sum }_{l = 1}^{{N}_{k}} \frac{\partial {I}_{k}^{l}}{\partial {γ}_{i}} \frac{\partial {I}_{k}^{l}}{\partial {γ}_{j}} , \qquad ( 4 )$$

where {γ}=({α}, μ). See the examples below for details. Intuitively, if the intensity does not change with one of the parameters, the inference of that parameter becomes impossible, and zero entries appear in the Hessian matrix, leading to infinite error for that parameter. Conversely, making all elements in the Hessian matrix uniformly larger leads to smaller uncertainties σᵢ in each predicted parameter βᵢ:

$${σ}_{i}^{2} = - {‖ \frac{{\partial }^{2} ℒ}{\partial {γ}_{i} \partial {γ}_{j}} ‖}_{ii}^{- 1} \qquad ( 5 )$$

Although Hessian analysis relies on the quadratic expansion in the vicinity of the log likelihood maximum, at least in a one-receptor, two-ligand model system it captures all of the main features of the uncertainty in a predicted using full nested sampling approach.

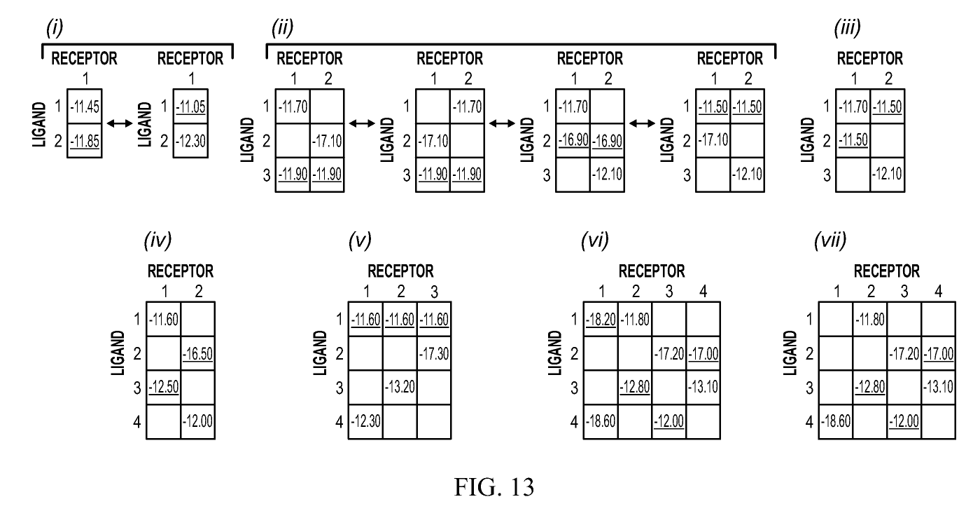

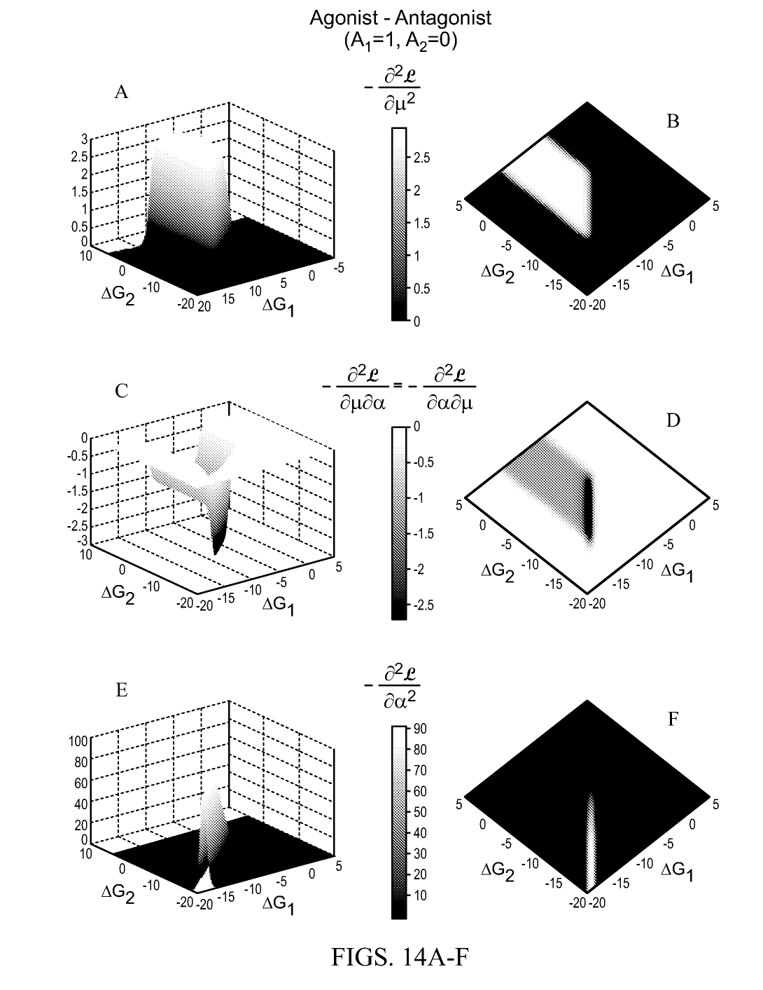

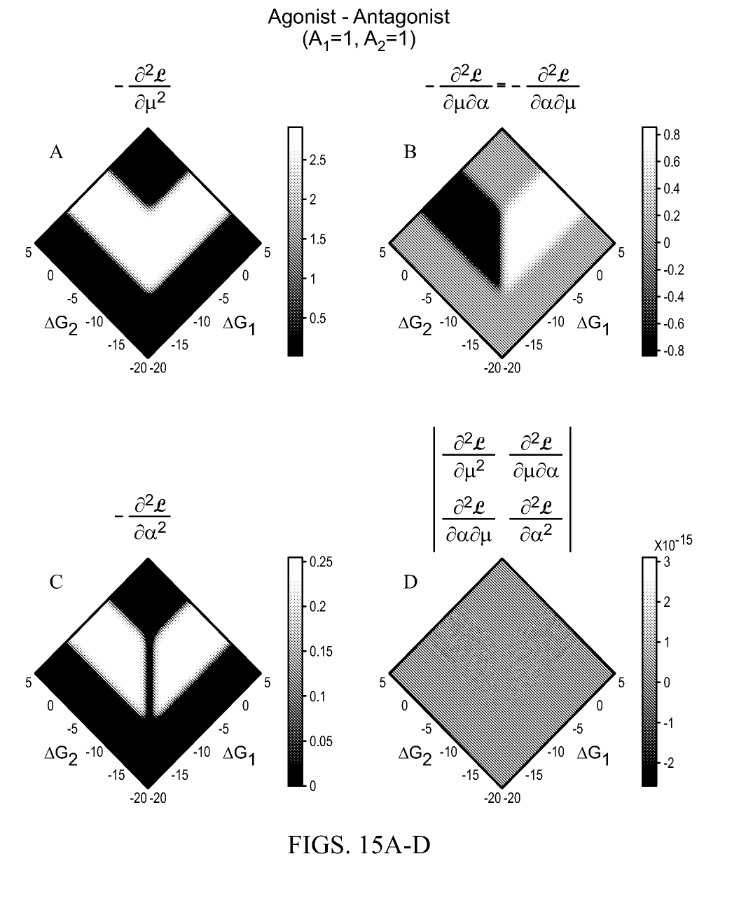

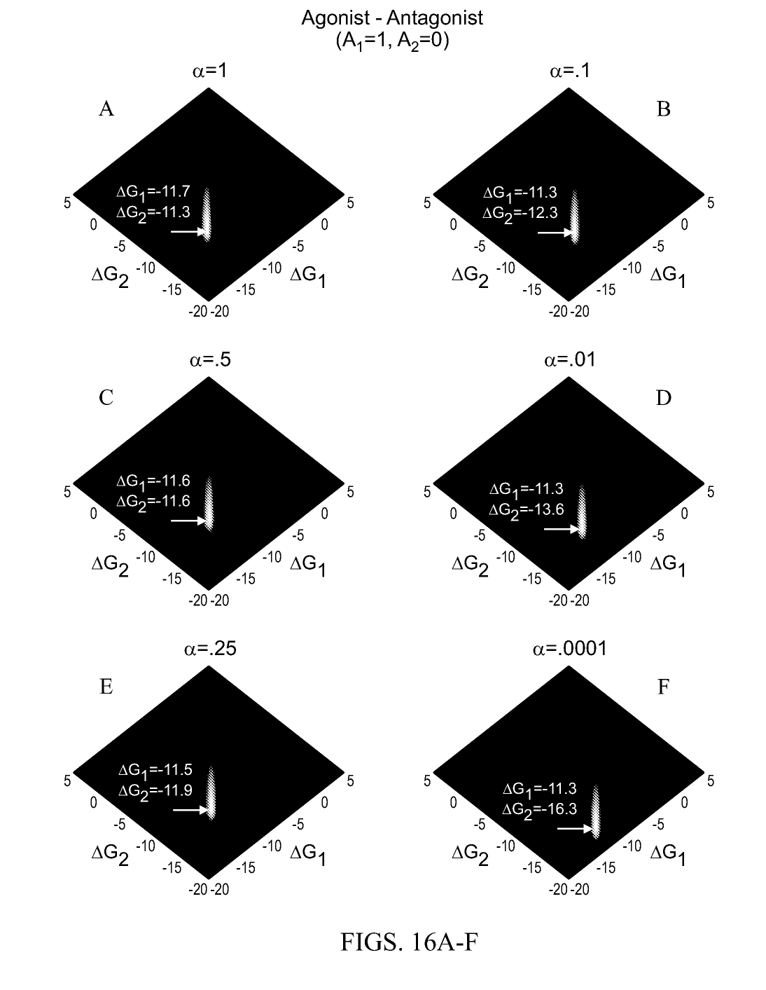

See also FIGS. 14A-F, 15A-F illustrating matrix elements of the Hessian in a agonist-antagonist and two agonist cases. See FIGS. 16A A-F illustrating changes in the Hessian determinant with concentration of a second ligand.

Theoretical limits of ligand mixture recognition. Not all receptors are equal candidates for inclusion in a biosensor array together. For example, receptors with similar sets of efficacies and binding affinities may be less useful than receptors with more “orthogonal” binding and activation patterns. In an embodiment, quantitative guidelines for biosensor array design are provided using Hessian methodology.

The strategy for biosensor design is opposite to the strategy of component inference in a complex mixture. In the inference problem, the receptor binding affinities and efficacies are already known, either a priori or from a separate set of calibration experiments. In design, a goal may be to make a fixed number of measurements using the array of a given size (typically, a series in which the total concentration is changed within a certain range), and the question is the most optimal choice of receptor properties. The optimal properties may depend on the relative concentration of each component in a mixture: an array fine-tuned for detecting small admixtures of compound B in the background of compound A may function less well if the concentrations of A and B become approximately equal. The design may, thus, tune an array for the mixture contemplated for testing.

From the Bayesian point the view, the best array will have the smallest errors in predicting component concentrations (Eq. (5)). Because each error is inversely proportional to the Hessian determinant, it is possible (and technically easier) to maximize the determinant instead of minimizing the errors directly.

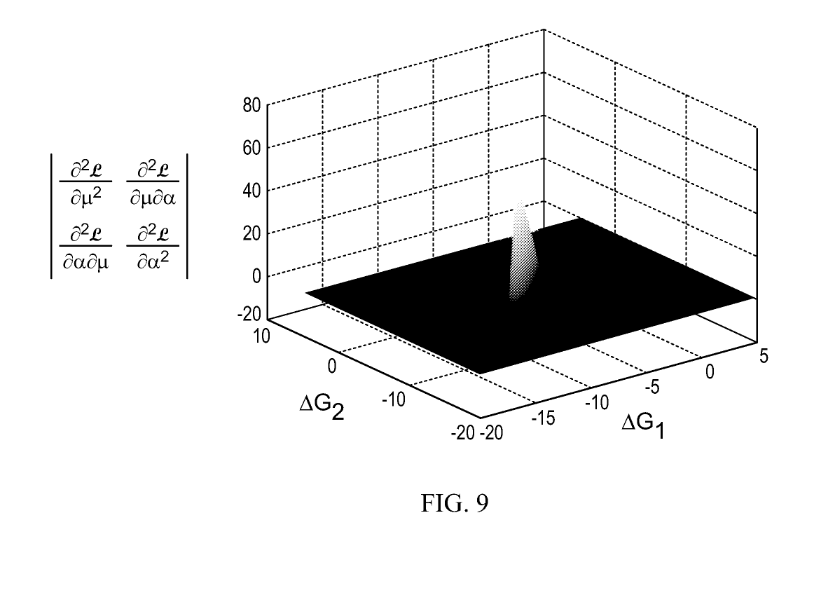

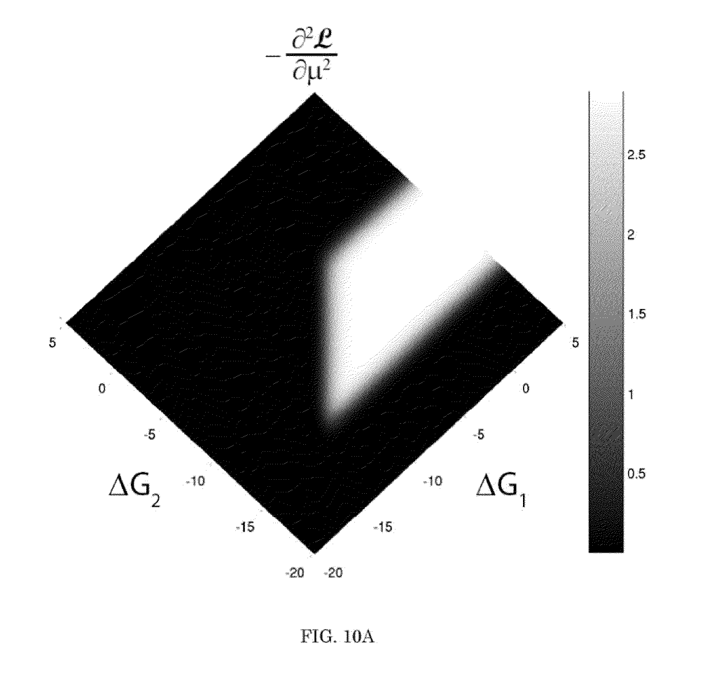

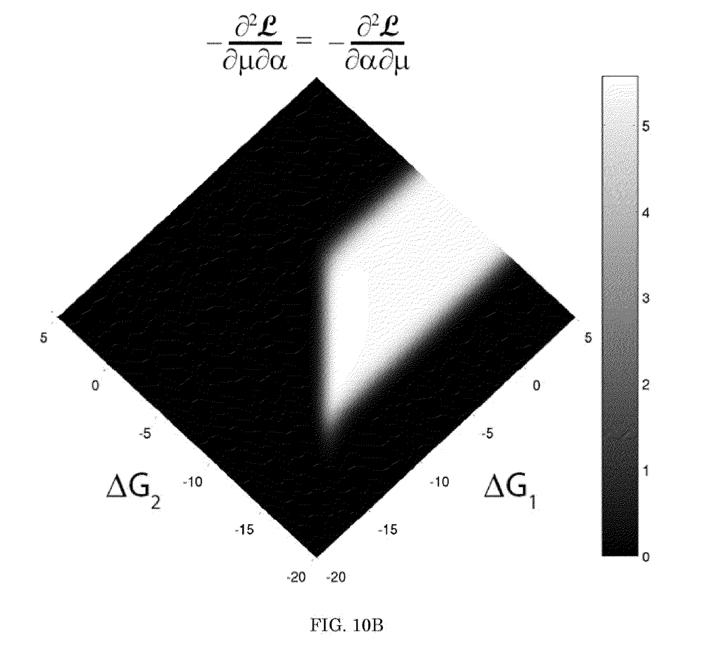

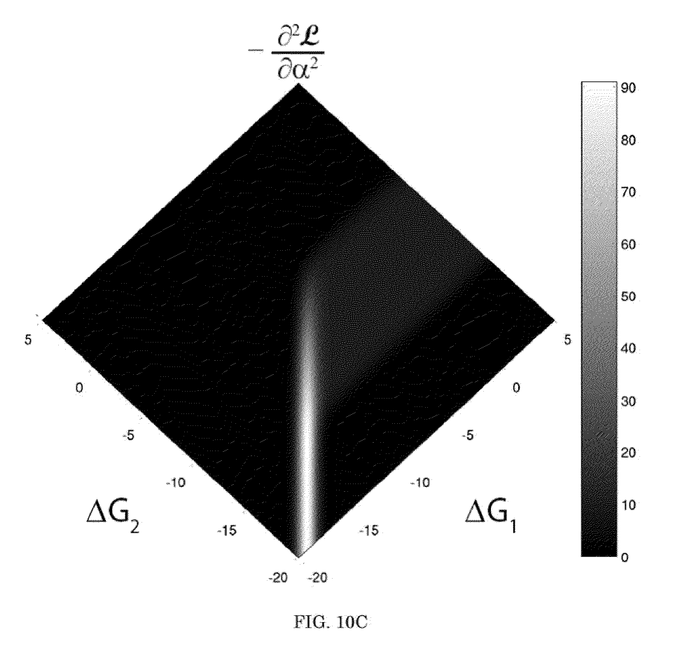

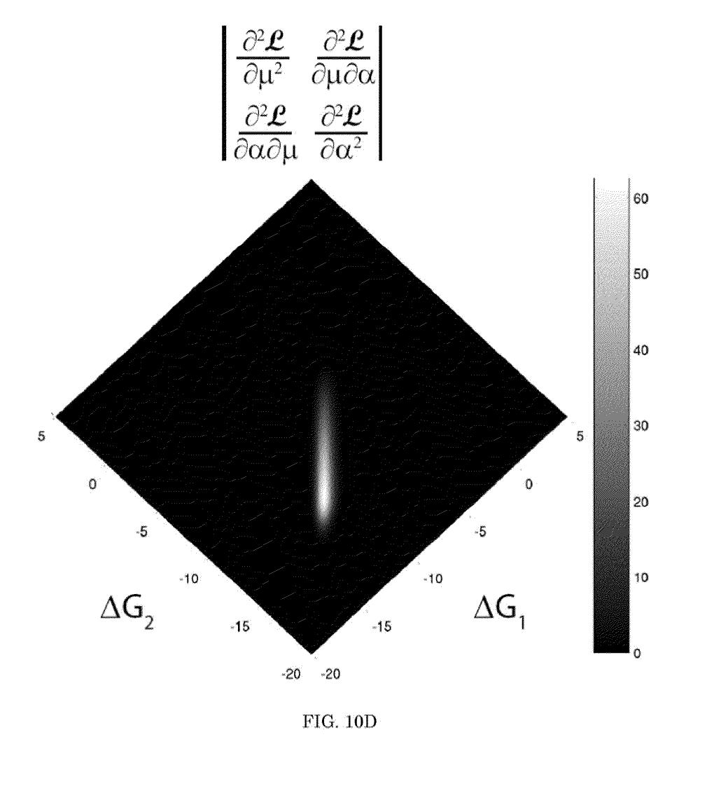

Two ligands interacting with a single receptor: The design strategy for a single receptor interacting with a mixture of two ligands was developed. The following is a guideline, but other design strategies may be employed. By maximizing the determinant of the Hessian, in this case a 2×2 matrix, the receptor can best discriminate both components of the mixture if one ligand acts as an agonist and the other as an antagonist; i.e., each component binds strongly to the receptor but the efficacies become zero and one (A₁=1 and A₂=0 or A₁=0 and A₂=1). The actual values of the binding energies, ΔGᵢ, i=1, 2 will depend on the relative concentration, α. For example, in FIG. 9 the determinant of the Hessian is shown as a function of ΔG₁ and ΔG₂ for α=0.25 and A₁=1, A₂=0. In this case, the optimal values of the binding energies are ΔG₁=−11.45 kcal/mol and ΔG₂=−11.85 kcal/mol. Referring to FIGS. 10A-D, if the relative concentrations of the agonist and antagonist are exchanged by relabeling A₁=0 and A₂=1 (but keeping α=0.25) a different set of optimal ΔG's is obtained, namely, ΔG₁=−11.05 kcal/mol and ΔG₂=−12.30 kcal/mol. The height of the peak in each determinant landscape is the same indicating that both choices will lead to equally good receptor performance, as long as the ΔG's are tuned appropriately.

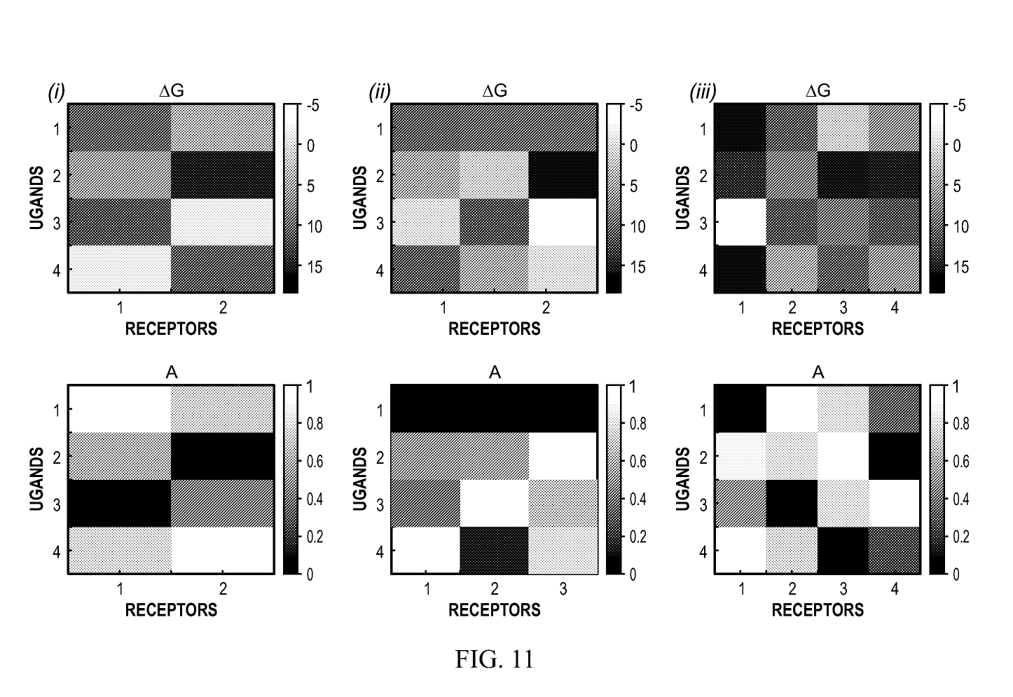

Multiple ligands interacting with multiple receptors: A design for more complicated arrays consisting of two or more receptors interacting with multiple ligands is provided in an embodiment. Interestingly, the agonist-antagonist pattern observed in the one-receptor, two-ligand case is repeated: the array as a whole performs best if each receptor binds both an agonist and an antagonist, regardless of the number of receptors N_{rec} in the array. An example of this is shown in FIG. 11 where the optimal binding energies ΔG and efficacies A are presented for three cases: (i) N_{rec}=2, N_{lig}=4, (ii) N_{rec}=3, N_{lig}=4, and (iii) N_{rec}=4, N_{lig}=4.

In the first case (panel (i)), receptor 1 binds ligands 1 and 3 strongly with A₁≈1 and A₂≈0, while receptor 2 binds ligands 2 and 4 strongly with A₂≈0 and A₄≈1. Each ligand binds to one of the receptors, and there is no ‘ligand overlap;’ i.e., there are no overlapping black or dark gray squares in both columns of a single row of the ΔG matrix.

In the second case (panel (ii)), each receptor once again binds both an agonist and antagonist but since there are now three receptors, and still only four ligands there is ‘ligand overlap.’ Ligand 1 acts as an antagonist to all three receptors. Similarly, in the third case (panel (iii)) there are four incidents of overlap. Ligand 1 acts as an antagonist to receptor 1 and an agonist to receptor 2; ligand 2 acts as an agonist to receptor 3 and an antagonist to receptor 4; ligand 3 acts as an antagonist to receptor 2 and an agonist to receptor 4; and ligand 4 acts as an agonist to receptor 1 and an antagonist to receptor 3.

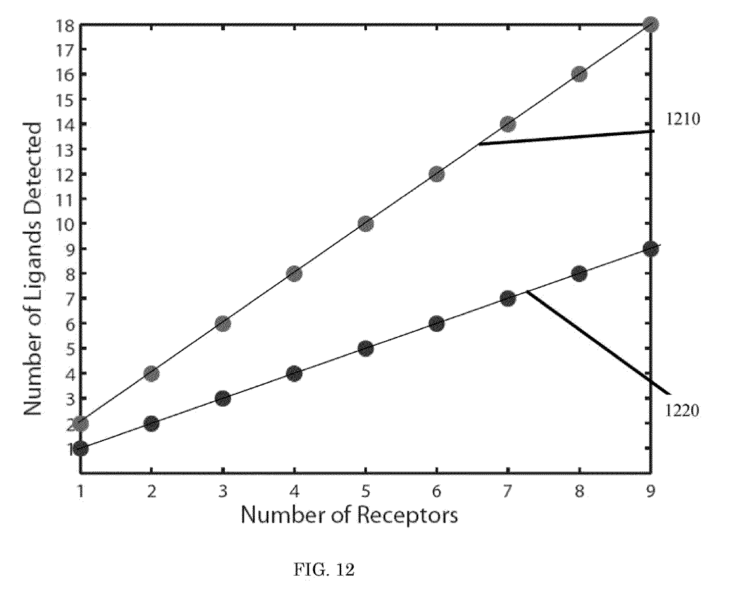

Referring to FIG. 12, the behavior of a system with mixtures including agonist/antagonist pairs or agonists only was analyzed. The number of successfully discriminated ligands increases linearly with the number of receptors: N_{lig}=2N_{rec} when the determinant of the Hessian with respect to all free energies ΔG and efficacies A (for each number of receptors N_{rec}) are maximized; N_{lig}=N_{rec} when the efficacies Aᵢ=1 (∀ᵢ) are fixed. Ligands are scored as successfully discriminated if α_{μ}²<2, σ_{α}_{ᵢ}², <2∀ᵢ in a given nested sampling prediction. For a given N_{rec} in an array, the maximum number of successfully discriminated ligands N_{lig}=2N_{rec} (line 1210, agonists and antagonists). Moreover, if all efficacies are fixed at Aᵢ=1 (∀ᵢ) to eliminate the agonist/antagonist ‘advantage’, the slope of this relationship is halved (line 1220, agonists only).

Not only can the algorithm described herein be used to interpret output of any type of sensor array, it can also provide a theoretical framework for determining the optimum set of sensors for analyzing particular mixtures. Three general principles may be followed in design embodiments herein. First, the optimum parameters of the sensors are sensitive to the use for which the detector is designed. That is, determining the amounts of each of two compounds in a mixture where both compounds are present in roughly similar amounts is better accomplished using a set of sensors different than those designed to measure a small amount of one of those compounds in the presence of a large excess of the other. Second, the maximum number of ligands in a mixture whose levels can all be determined simultaneously by an array may be twice the number of sensors in the array. This linear relationship is different from the exponential relationship between ligands and receptors in olfactory systems. Third, the optimum design of receptors for the array may include having one of the ligands function as a strong agonist of a receptor and a second ligand as a strong antagonist of that receptor. As the number ligands of interest increases, with a corresponding increase in the number of receptors needed, the design may be maintained for each receptor to see one ligand as an agonist and another as an antagonist. Moreover, if this binary condition is met, the parameters of other ligand-receptor interactions in the array are freely variable. Thus, somewhat surprisingly, antagonist activity of analytes toward sensors in an array plays a significant role in honing the performance of a detector array.

Deciphering the optimality code for receptor array design: In order to take full advantage of the information provided herein about optimal receptor properties, patterns in the ΔG values for each receptor-ligand pair may be examined. The simplest case of one receptor interacting with two ligands may be a starting point. Referring to FIG. 9, a set of optimal ΔG's for A₁=1, A₂=0, and α=0.25 was found. As described above, if the relative concentrations of the agonist and antagonist are exchanged by relabeling A₁=0 and A₂=1 (but keeping α the same) a different set of optimal ΔG's are obtained. In the special case of α=1, the second set of ΔG's would just reflect a trivial swapping of ligand labels; i.e., ΔG₁ to ΔG₂ and ΔG₂ to ΔG₁. The height of the peak in each determinant landscape is the same indicating that both choices will lead to equally good receptor performance, as long as the ΔG's are tuned appropriately. In reference to FIG. 13, panel (i), different nested sampling runs will result in either one or the other of these predictions since both are global maxima in the landscape of interest. FIG. 13 illustrates optimal ΔG values for several cases: (i) one-receptor, two-ligand (ii) two-receptor, three-ligand (iii) two-receptor, three-ligand (at a local maximum) (iv) two-receptor, four-ligand (v) three-receptor, four-ligand (vi)) four-receptor, four-ligand and (vii)) four-receptor, four-ligand with an ‘auxiliary’ receptor. Underlined values correspond to an efficacy of A=0 (antagonist), while values without an underline correspond to A=1 (agonist).

Referring to FIG. 13, panel (ii), in a two-receptor, three-ligand case an arbitrary choice can be made where α₁≠α₂ so that each ligand in the mixture is present at a unique concentration; e.g., α₁=0.0001 and α₂=0.5. In this case, there are three global maxima as well as multiple local maxima in the landscape of the determinant of the Hessian as a function of the ΔG's. Each of the global maxima corresponds to ‘antagonist overlap;’ i.e., the situation where one of the three ligands acts as an antagonist to both of the receptors. The left most double arrow in FIG. 13, panel (ii) indicates a trivial swapping of receptor labels, whereas the subsequent double arrows show the differences between three unique global solutions: ligand 1, 2, or 3 acting as the double antagonist.

The local maxima are characterized as either ‘agonist overlap’—where one of the ligands acts as an agonist to both receptors, or ‘agonist/antagonist overlap’—where one of the ligands acts as an agonist to one receptor and as an antagonist to the other. For example, see FIG. 13, panel (iii). Interestingly, all of these scenarios can be described by just 6 different values of ΔG, one for each ligand acting as an agonist and one for each ligand acting as an antagonist. In general, for any choice of a combination of N_{lig} and N_{rec}, only 2N_{lig} ΔG's are necessary to describe all of the peaks in the determinant landscape, both global and local. The number of these peaks can also be determined.

Comparing FIGS. 9, 11 (panel (i)), and 13 (panels (i) and (iv)), a situation where only global maxima exist comes about when N_{lig}=2N_{rec}. This is because each receptor is saturated, discriminating two unique ligands, so there is no ‘ligand overlap’ and permutations like the ones in FIG. 13, panels (ii) and (iii) are not possible. To see what happens when receptor saturation is relaxed the two-receptor, four-ligand case was compared with the three-receptor, four-ligand case (FIG. 11, panel (ii) and FIG. 13, panel (v)) and the four-receptor, four-ligand case (FIGS. 11, panel (iii) and FIG. 13, panels (vi) and (vii)). An decrease in errors in the prediction of component concentrations is observed (the Hessian determinant increased by a factor of 5×108) by increasing from two receptors to three receptors. However, a slight improvement in concentration predictions was seen when a fourth receptor was added (the determinant of the Hessian increased by a factor of 4.5). Adding receptors to an array is not always optimal. More is not necessarily better, so the cost of designing and including extra receptors must be weighed against the small amount of additional information gained from those additional sensors. Design of a chemosensor array may include an analysis of the optimal number of sensors. In this case the optimal number of receptors is 3.

Specific embodiments herein employ Bayesian analysis to infer the identities and concentrations of ligands, but alternative signal processing techniques might be used that employ a physical model for receptor/ligand interactions. These include but are not limited to conventional statistical analysis, nonlinear programming, decision theory, control theory, neural networks, machine learning, or artificial intelligence.

Any of the findings described herein may be implemented as embodiments of the design of a chemosensor array, chemosensor array system or computer-readable medium. Chemosensor arrays may be constructed using sensors chosen from at least one of biological, nonbiological chemical or physical sensors. Biological or nonbiological chemical sensors that may be provided include but are not limited to enzymes, receptors, antibodies, carbohydrates, peptide aptamers, DNA aptamers, RNA aptamers, chemically derivatized peptides, chemically derivatized enzymes, chemically derivatized antibodies, chemically derivatized carbohydrates, chemically derivatized receptors, chemical dyes, porphyrins, dendrimers, molecularly-imprinted polymers, electrochemical sensors, tin oxide sensors, lambda sensors, mixed-potential sensors, derivatized polymer matricies, nanomechanical sensors, derivatized nanotube sensors, conductometric sensors, metal oxide field effect transistor (MOSFET) sensors, conductive polymer chemiresistors, or acoustic wave sensors. Examples of sensors, reporters, and operable connections between sensors and reporters can be found in Albert K, et al. (2000) Cross-reactive chemical sensor arrays. Chem. Rev. 100:2595-2626, which is incorporated herein by reference as if fully set forth. A chemosensor array may be implemented through mass spectrometry or an JPL Electronic Nose (ENose) as described in Gen TechTips, Genengnews.com, November 2010, page 10, which is incorporated herein by reference as if fully set forth. The ENose is an array-based sensing system which contains 32 conductometric sensors. The Second Generation ENose was trained to detect, identify and quantify 21 chemical species, the majority of which are organic solvents or commonly used organic compounds, which might be released through a leak or a spill in a spacecraft crew cabin. Past ENose investigations have focused on organic compounds such as common solvents and a few selected inorganic compounds, ammonia, water and hydrazine. For the new ENose to be performed on the ISS, two inorganic species have now been added to the analyte set, mercury and sulfur dioxide. To accommodate these inorganic species, the sensor array will incorporate a hybrid sensor approach, including both new sensing materials and new sensing platforms made up of microhotplate sensor substrates. The ENose is low mass (less than 4 kg), small volume (less than 4 liters) and low power (less than 20 W), in addition to being microgravity-insensitive, robust, and rugged. It is capable of analyzing volatile aerosols as well as vapors. Any one or more of these sensors may be provided in a chemosensor array, system or method herein.

In an embodiment one or more sensor in a chemosensor array herein is a biological receptor. The biological receptor may be a G-protein-coupled-receptor a histidine kinase, an ion channel, a receptor tyrosine kinase an integrin or any other classe of cell-surface receptor. The biological receptor may be an enzyme, a DNA/RNA aptamer, a carbohydrate, or an antibody. A reporter may be provided that is operably linked to the biological receptor. As used herein, an “operably linked” reporter refers to a reporter that is functionally linked to the sensor regardless of whether it is physically linked.

In an embodiment, a reporter may be a fluorescent moiety associated with the sensor. For example, the fluorescent moiety may be limited in fluorescing when the sensor is in a first state, and unlimited in a second state. When the biological receptor is in the second state, the report from such a fluorescent reporter may be fluorescence. Binding of a ligand to the sensor may shift the sensor from the first to second states, and thus affect the fluorescence. The shift from first to second states may include a conformational change in the sensor; e.g., a conformational change in a biological receptor. The reporter readout may be coupled to membrane potentials, cell morphology, enzyme activity, or molecular binding.

In an embodiment, a reporter may be a gene; i.e., a “reporter gene,” where the expression of the gene is affected by binding of a ligand to the sensor. The report from the reporter in this embodiment may be the transcribed RNA, or the translated protein. The transcribed RNA may be detected by any method, including hybridization. The protein may be detected by any method, including physical assays, immunological assays, or functional assays. The report may be a product produced by the action of the gene product. For example, the report may be a product of a reaction catalyzed by an enzyme where the enzyme is the gene product. Any assay capable of detecting the gene product or a product made via the gene product may be utilized to detect the report. The enzyme may be a protein enzyme or a ribozyme. Non-limiting examples of reporter genes that may be provided in embodiments herein include lacZ, CAT, gus, and GFP, which code for β-galactosidase, chloramphenicol acetyltransferase, β-glucuronidase, and green fluorescent protein, respectively. An assay for β-galactosidase may be a colorimetric or fluorometric assay for detecting the products of reaction with model substrates. An assay for chloramphenicol acetyltransferase may be an ELISA for the gene product. An assay for β-glucuronidase may be a colorimetric assay for detecting the products of reaction with model substrates. An assay for green fluorescent protein may be detection of fluorescence. In an embodiment, the reporter is LacZ, and reporter system, model substrates and detection LacZ are as described in Chambers J, et al. (2000) A G protein-coupled receptor for UDP-glucose. J. Biol. Chem. 275:10767-10771, which is incorporated herein by reference as if fully set forth.

When a biological receptor is a sensor, and the biological receptor is a G-protein coupled receptor, any G-protein coupled receptor may be utilized. In an embodiment, the portions of the G-protein coupled receptor responsive to a ligand may be cloned and expressed in a chimeric background where binding of the ligand affects a secondary messenger system coupled to a specific reporter gene.

A G-protein coupled receptor provided in embodiments herein may be UDP-glucose receptor, 2211, H-20, K-3, L-3, HTR1A, HTR1B, HTR1D, HTR1E, HTR1F, HTR2A, HTR2B, HTR2C, HTR4, HTR5A, HTR6, HTR7, CHRM1, CHRM2, CHRM3, CHRM4, CHRM5, ADORA1, ADORA2A, ADORA2B, ADORA3, ADRA1A, ADRA1B, ADRA1D, ADRA2A, ADRA2B, ADRA2C, ADRB1, ADRB2, ADRB3, C3AR1, C5AR1, GPR77, ΔGTR1, ΔGTR2, APLNR, GPBAR1, NMBR, GRPR, BRS3, BDKRB1, BDKRB2, CNR1, CNR2, CCR1, CCR2, CCR3, CCR4, CCR5, CCR6, CCR7, CCR8, CCR9, CCR10, CXCR1, CXCR2, CXCR3, CXCR4, CXCR5, CXCR6, CX3CR1, XCR1, CCKAR, CCKBR, DRD1, DRD2, DRD3, DRD4, DRD5, EDNRA, EDNRB, GPER, FPR1, FPR2, FPR3, FFAR1, FFAR2, FFAR3, GPR42, GALR1, GALR2, GALR3, GHSR, FSHR, LHCGR, TSHR, GNRHR, GNRHR2, HRH1, HRH2, HRH3, HRH4, KISS1R, LTB4R, LTB4R2, CYSLTR1, CYSLTR2, OXER1, FPR2, LPAR1, LPAR2, LPAR3, S1PR1, S1PR2, S1PR3, S1PR4, S1PR5, MCHR1, MCHR2, MC1R, MC2R, MC3R, MC4R, MC5R, MTNR1A, MTNR1B, MLNR, NMUR1, NMUR2, NPFFR1, NPFFR2, NPSR1, NPBWR1, NPBWR2, NPY1R, NPY2R, PPYR1, NPY5R, NTSR1, NTSR2, GPR81, GPR109A, GPR109B, OPRD1, OPRK1, OPRM1, OPRL1, HCRTR1, HCRTR2, P2RY1, P2RY2, P2RY4, P2RY6, P2RY11, P2RY12, P2RY13, P2RY14, QRFPR, PTAFR, PROKR1, PROKR2, PRLHR, PTGDR, GPR44, PTGER1, PTGER2, PTGER3, PTGER4, PTGFR, PTGIR, TBXA2R, F2R, F2RL1, F2RL2, F2RL3, RXFP1, RXFP2, RXFP3, RXFP4, SSTR1, SSTR2, SSTR3, SSTR4, SSTR5, TACR1, TACR2, TACR3, TRHR, TAAR1, UTS2R, AVPR1A, AVPR1B, AVPR2, OXTR, CCRL2, CMKLR1, CXCR7, GPR183, GPR42, GPR1, GPR3, GPR4, GPR6, GPR12, GPR15, GPR17, GPR18, GPR19, GPR20, GPR21, GPR22, LPAR4, GPR25, GPR26, GPR27, GPR31, GPR32, GPR33, GPR34, GPR35, GPR37, GPR37L1, GPR39, GPR45, GPR50, GPR52, GPR55, GPR61, GPR62, GPR63, GPR65, GPR68, GPR75, GPR78, GPR79, GPR82, GPR83, GPR84, GPR85, GPR87, GPR88, LPAR5, GPR101, GPR119, GPR120, GPR132, GPR135, GPR139, GPR141, GPR142, GPR146, GPR148, GPR149, GPR150, GPR151, GPR152, GPR153, GPR160, GPR161, GPR162, GPR171, GPR173, GPR174, GPR182, LGR4, LGR5, LGR6, MAS1, MAS1L, MRGPRD, MRGPRE, MRGPRF, MRGPRG, MRGPRX1, MRGPRX2, MRGPRX3, MRGPRX4, OPN3, OPN5, OXGR1, LPAR6, P2RY8, P2RY10, SUCNR1, TAAR2, TAAR3, TAAR5, TAAR6, TAAR8, TAAR9, CCBP2, CCRL1, DARC, OR2W1, MOR272-1, MOR271-1, MOR41-1, OR1A1, MOR203-1, MOR256-17, MOR1-1, MOR2-1, MOR273-1, MOR139-1, MOR189-1, MOR136-1, OR51E1, MOR37-1, MOR30-1, OR51E2, OR2J2, MOR261-1, OR5P3, MOR258-1, MOR185-1, OR51L1, MOR9-1, MOR15-1, MOR106-1, MOR105-1, MOR40-1, MOR33-1, MORS-1, MOR25-1, MOR31-1, MOR23-1, OR10J5, OR2C1, MOR260-1, MOR277-1, MOR128-2, MOR107-1, OR2M7, MOR268-1, MOR236-1, MOR223-1, MOR269-1, MOR259-1, MOR4-1, MOR184-1, MOR182-1, MOR253-1, MOR251-1, MOR222-1, MOR18-1, MOR180-1, MOR205-1, MOR140-1, MOR250-1, MOR204-6, MOR162-1, MOR129-1, MOR161-1, MOR207-1, or MOR170-1. The whole G-protein coupled receptor may be provided, or portions responsive to ligand binding. Portions responsive to ligand binding may be provided alone, or in combination with other moieties to form a G-protein responsive signaling event.

Ligands that may be detected in embodiments herein may be selected from any moiety capable of binding to a sensor. Ligands that may be detected in embodiments herein may be selected from any moiety capable of binding to a biological receptor. Ligands that may be detected in embodiments herein may be selected from any moiety capable of binding to a G-protein-coupled-receptor. Ligands that may be detected in embodiments herein include but are not limited to nucleotide sugars, drugs and their metabolites, hormones, neurotransmitters, immunomodulators, coumarin, acetophenone, 4-chromanone, allyl phenylacetate, dihydrojasmone, nonanoic acid, octanoic acid, decanoic acid, cyclohexanone, heptanoic acid, vanillic acid, (−)-camphor, (+)-camphor, benzophenone, (+)-dihydrocarvone, (−)-carvone, (+)-carvone, prenylacetate, hexana, lyra, propionic acid, geraniol, (−)-β-citronellol, octanethiol, nonanethiol, 2-coumaranone, allyl benzene, phenyl acetate, benzyl acetate, hexanoic acid, (−)-fenchone, ethyl isobutyrate, (+)-fenchone, nonanal, decanal, 1-octanol, 1-heptanol, 1-nonanol, 1-decanol, butyl butyryllactate, (−)-2-phenylbutyric acid, (+)-2-phenylbutyric acid, 1-caprolactone, 2-octanone, 2-nonanone, 3-octanone, 3-heptanone, 2-heptanone, pentanoic acid, 34-hexanedioine, 23-hexanedionie, 1-hexanol, amyl hexanoate, benzene, 2-pentanone, 2-hexanone, 4-hydroxycoumarin, 1-pentanol, allyl heptanoate, hexyl acetate, heptanal, octanal, or butyl formate. Receptors capable of binding to these ligands may be provided in embodiments herein.

Ligands that may be detected in embodiments herein include but are not limited to ligands in a medical sample, an environmental toxicology sample, a remediation sample, a materials quality control sample, a food sample, an agricultural product sample, an industrial manufacturing sample, an ambient air sample, a workplace sample, an emissions sample, a product sample, a leak sample, a drug testing sample, a drug compliance sample, a hazardous spill sample, or a potential or actual explosives sample. Receptors capable of binding to these ligands may be provided in embodiments herein.

Ligands in a medical sample that may be detected in embodiments herein include but are not limited to any clinical chemistry ligand. Ligands in a medical sample that may be detected in embodiments herein include but are not limited to drugs, drug metabolites, biomarkers, troponin, creatine phosphokinase, tumor specific antigens, microbial antigens, hormones, carbohydrates or proteins, proteins, Acetyl-CoA, O-Acetyl-L-serine, N-Acetyl-D-mannosamine Acetylphosphate, 2-Actamido-2-deoxy-D-mannose, N-Acetyl-D-mannosamine, ACTH, Adenine, Adenosine, Adenosine 5′-phosphosulfate, Adenosine diphosphoglucose (ADPglucose), Adenosine-5′-diphosphate (ADP), Adenosine-5′-monophosphate (AMP), Adenosine-5′-triphosphate (ATP), Adenylosuccinate=N6-(1,2-Dicarboxyethyl)-AMP, Adiponectin, (4-Aminobutyl)guanidine, Aldosterone, Allantoate, Allantoin, Alpha,alpha-Trehalose, Alpha-D-Glucose, Alpha-D-Glucose 1-phosphate, Alpha-D-Glucose 6-phosphate, Alpha-Ketohydrocinnamicacid, Alzheimer secretase, 3-Amino-1,2-propanediol, 1-Amino-2-propanol, 2-Amino-6-hydroxypurine, 4-Aminobenzoic acid (PABA), gamma-aminobutanal, agmatine, 4-Aminobutyricacid (GABA), 5-Aminolevulinic acid, Antibrombin, Apo A-I, Apo A-II, Apo B-100, Apo E, APTT, Arbutin, Arsenic, Ascorbic acid (Vitamin C), Beta thromboglobulin, Beta-D-Fructose, Beta-D-Fructose 6-phosphate, Beta-D-Fructosel-phosphate, Beta-D-Glucose, Beta-D-Glucose 1-phosphate, Beta-D-Glucose 6-phosphate, Bicyclo-PGE, Biotin, (R,R)-2,3-Butanediol, (S,S)-2,3-Butanediol, Butanedionic acid, n-Butylamine, C4-b binding protein, Cadaverine, Cadmium, Calcitonin, Carbamide, 3-Carboxy-3-hydroxy-4-methylpentanoate, 6-Carboxyhexanoate, Cathepsin K, Cathepsin L, Cathepsin S, Cathepsin V, Cephalin, Cholecystokinin (CCK), Cholesterol, Cholesterol-ester, β-Human Chorionic Gonadotropin (β-HCG), Chromium, Cis-Aconitic acid, Citrate, CoA-SH (Coenzyme A), Cobalt, Copper, Corticosterone, Cortisol, COX-1, COX-2, C-reactive protein, Creatinin, Crotonoyl-CoA, Crotonyl-CoA, Cytidine, Cytidine 5′-diphosphate (CMP), Cytidine 5′-diphosphate (CDP), Cytidine 5′-triphosphate (CTP), Cytosine, D-Biotin, Decanoyl-CoA, 11-dehydro-TXB2,5′-Deoxy-5′-(methylthio)adenosine, 2′-Deoxyadenosine, 2′-Deoxyadenosine 5′-monophosphate (dAMP), 2′-Deoxyadenosine 5′-triphosphate (dATP), 2-Deoxy-beta-D-erythro-pentose, 2′-Deoxycytidine, 2′-Deoxycytidine 5′-diphosphate (dCDP), 2′-Deoxycytidine 5′-monophosphate (dCMP), 2′-Deoxycytidine 5′-triphosphate (dCTP), 2-Deoxy-D-ribose 1-phosphate, 2-Deoxy-D-ribose 5-phosphate, 2′-Deoxyguanosine, 2′-Deoxyguanosine 5′-diphosphate (dGDP), 2′-Deoxyguanosine 5′-monophosphate (dGMP), 2′-Deoxyguanosine 5′-triphosphate (dGTP), Deoxythymidine, 2′-Deoxythymidine 5′-phosphate (dTMP), 2-Deoxyuridine, 2′-Deoxyuridine 5′-phosphate (dUMP), 2′-Deoxyuridine 5′-triphosphate (dUTP), Dephospho-CoA, D-Erythrose 4-phosphate, D-fructose 1,6-bisphosphate, D-Galactose, D-Glucaric acid, D-Gluco-hexonic acid, D-Gluconic acid, D-Glucosaccharic acid (=d-Saccharic acid), D-Glucosamine 6-phosphate, D-Glyceraldehyde (=propanal, 2,3 dihydroxy), D-Glyceraldehyde-3-phosphate, D-Glycerate-2-phosphate (=2-phosphoglyceric acid), D-Glycerate-3-phosphate (=3-phosphoglyceric acid), 13,14-dihydro-15-keto-PGF, Dihydrofolate, Dihydroneopterin, (S)-4,5-Dihydroorotate, Dihydropteridine, 1,25-dihydroxy vitamin D, 1,25-dihydroxy vitamin D, 24,25-dihydroxy vitamin D, 24,25-dihydroxy vitamin D, 1,3-Dihydroxyacetone, Dihydroxyacetonephosphate=DHAP=Glyceronephosphate, 2,3-Dihydroxybenzoicacid, Dinor-6-keto-PGF1a, Dinor-TXB2, Diphosphate, D-Lyxulose, D-Mannitol, D-Mannitol 1-phosphate, D-Mannose (=carubinose), D-Mannose 6-phosphate, D-Ribose, D-Ribose 5-phosphate, D-Ribulose=D-Riboketose=D-Arabinoketose, D-Ribulose 5-phosphate, D-Tagatose (=lyxo-hexylose), dTDP, dTDP-D-glucose, dTTP, D-Xylose, D-Xylulose, Endothelin-1, Estradiol, Ethanedioicacid, Ethylenesuccinicacid, Factor VIIa, Factor WI; Factor WIIc, Factor X antigen, Factor XIIa, Fibrinogen, Fibrinogen degradation products (FgDP), Fibrinogen(antigen), t-Fibronectin, Flavin adenine dinucleotide (FAD), Flavin mononucleotide (FMN=Riboflavin 5′-phosphate), Flavonoids, Folate, Folate, Follicle Stimulating Hormone (FSH), Formate (=Methanoic acid), Fragment 1+2, Free fatty acid, Free fatty acid profile (C14-C24), Free fatty acid profile (C14-C24), Free Thyroxine (FT4), Fumarate, 1-beta-D-Galactopyranosyl-4-alpha-D-glucopyranose, GCP-2, Ghrelin, GLP-1, Glucagon, Glucagon-like peptide 1 (GLP-1), Gluconicacidlactone, Gluconiclactone, 1-alpha-D-glucopyranosyl-2-beta-D-fructofuranoside, 1-alpha-D-Glucopyranosyl-4-alpha-D-glucopyranose, Glucose, Glucuronic acid, Glutathione reduced (gamma-L-Glutamyl-L-cysteinyl-glycine), Glutathoine oxidized, (R)-Glyceric acid, Glycerol, sn-Glycerol-3-phosphate, Glyoxylate, Granzyme B, Guanine, Guanosine, Guanosine 5′-diphosphate (GDP), Guanosine 5′-monophosphate (GMP), Guanosine 5′-triphosphate (GTP), HbAlc, HDL-cholesterol, Hexanoyl-CoA, Homocystine, Human Chorionic Gonadotropin (HCG), Human Growth hormone, 25-hydroxy vitamin D, 25-hydroxy vitamin D, 2-Hydroxy-1,2,3-propanetricarboxylic acid, Hydroxyproline, 1-Hydroxypropane-1,2,3-tricarboxylicacid, Hypoxanthine (=Purine-6-ol), IFN-gamma, IGF-1,1-kappaB, I-kappaB, 5′-Inosinate, Inosine, Inosine 5′-diphosphate (IDP), Inosine 5′-monophosphate (IMP, inosinic acid), Inosine 5′-triphosphate (ITP), 5′-Inosine monophosphate=5′-Inosinate, Inositol, Insulin, Interleukin-10, Interleukin-12, Interleukin-18, Interleukin-1β, Interleukin-4, Interleukin-6, Interleukin-8, Isocitrate, Isomaltose, 1-Amino-2-propanol, 2-Isopropylmalicacid, 2-Keto-3-methylbutyricacid, 2-Ketobutyric acid, keto-Phenylpyruvate, 2-Ketovaline, Folinic acid, (S)-Lactate, Lactose, L-Alanine, L-Arabinose, L-Asparagine, L-Aspartic acid, Lauroyl-CoA, L-Cystathionine, L-Cysteine, L-Dicysteine, Lead, Leptin, Leptin, L-Glutamate, L-Glutamine, L-Histidine, L-Homocysteine, L-Homoserine, Lipoamide, L-Isoleucine, LL-2,6-Diaminoheptane-dioic acid, L-Leucine, L-Lysine, L-Methionine, L-Ornithine, L-Phenylalanine, L-Proline, L-Serine, LTB, LTC, LTE, L-Threonine, L-Tryptophan, L-Tyrosine, Luteinising hormone (LH), L-Valine, Lysine carboxylic acid, (S)-Malate, Malonyl-CoA, Maltose, Manganese, Mannose, (Alpha-) D-Mannose 1-phosphate, Melibiose, Menaquinone, Mercaptopyruvate, Mercapturic acids, Mercury, 3-Methyl-2-oxobutanoate, (S)-3-Methyl-2-oxopentanoate, 4-Methyl-2-oxopentanoate, 4-Methyl-5-(2′-hydroxyethyl)-thiazole, 3-Methylbut-2-enoyl-CoA (=3-methylcrotonyl-CoA), 3-methylcrotonyl-CoA=(3-Methylbut-2-enoyl-CoA), Methylsterols, 5-Methylthioadenosine, β-2 microglobulin, (=tetradecanoyl-CoA), N(alfa)-Acetyl-L-ornithine, N-Acetyl-D-glucosamine 1-phosphate, N-Acetyl-D-glucosamine 6-phosphate, N-Acetyl-L-glutamate, NAD, NADH, NADP, NADPH, NF-kappaB, NF-kappaB, N-Formyl-L-methionine, Niacin, Nickel, Nicotinamide, Nicotinamide D-ribonucleotide, Nicotinate, Nicotinicacidamide, 3-nitro-tyrosin, NO, NOx, Octanoyl-CoA, Oestradiol (E2), Orotate, Orotidine-5′-monophosphate (Orotidylic acid), Orthophosphate, Osteocalcin, O-Succinyl-L-homoserine, Oxalic acid, 2-Oxobutanoicacid, 2-Oxobutyricacid (=2-Ketobutyric acid), Oxoglutaricacid, 2-Oxoisocaproate, 2-Oxopropanoicacid, PABA, t-PA antigen, Palmitoyl-CoA, Pantothenic acid, (R)-Pantothenicacid, Pentosidine, PGD2, PGE2, PGE2, 11β-PGF, 6-keto PGF1a+2,3 dinor 6-Keto-PGF1a(urine), 6-keto-PGF1a, 8-iso-PGF2-alpha, 8-iso-PGF2-alpha (urine), PGF2a, 3-Phenyl-2-oxopropanoate, Phenylpyruvate, Phosphate, (3-Phosphatidyl)-ethanolamine, Phosphatidylglycerol, 3′-Phosphoadenylylsulfate (PAPS), 6-Phospho-D-gluconate (=6-phosphogluconic acid), Phosphoenolpyruvate (PEP), 6-Phosphogluconic acid=(6-Phospho-D-gluconate), Phosphoglycolic acid, Plasminogen, Platelet factor 4, Porphobilinogen, Prephenic acid, Progesterone (Prog), Prokallikrein, Prolactin (PRL), Propanoic acid, Propanoyl-CoA, Prostate Specific Antigen (PSA), Protein C antigen, Prothrombin, Pseudouridine, Pteroylglutamicacid, Putrescine, 3-Pyridinecarboxylicacid, Pyridoxal, Pyridoxal-5-phosphate, Pyridoxine, Pyridoxol, Pyrophosphate, Pyruvate, PYY, Renin, Resistin, Riboflavin, (9-D-Ribosylxanthine)-5′-phosphate, SAA, Saccharose, Salicin, Selenium, Selenomethionine, s-E-Selectin, Shikimic acid, s-ICAM, Soluble fibrin, Somatostatin, Sorbitol, Spermidine, Spermine, Succinate, Succinyl-CoA, Sucrose 6-phosphate, TAFI antigen, Testosterone, 5,6,7,8-Tetrahydrofolate, Tetrahydrofolicacid, TGF-β2, TGF-β1, Thiamine-diphosphate, Thiaminemonophosphate, Threamine, Thrombin generation, Thrombin-antithrombin (TAT), s-Thrombomodulin, Thymidine, Thymidine 5′-diphosphate (TDP), Thymidine 5′-monophosphate, Thymidine 5′-triphosphate (TTP), Thymidine-5′-monophosphate, Thyroid Stimulating Hormone (TSH), TNFa, TNFa converting enzyme, Trans-4-Hydroxy-L-proline, Trans-butenedioicacid, Trehalose 6-phosphate, Triglycerides, Triiodothyronine (T3), TXA2+11-dehydro-TXB2 (urine), TXB2, UDP-D-galactose, UDP-D-glucose, UDP-N-acetyl-D-glucosamine, Undecaprenol, Uracil-6-carboxylicacid, Urate, Urea, Uridine, Uridine 5′-monophosphate (UMP), Uridine 5′-triphosphate (UTP), Urine=8-iso-PGF2-alpha, Urocanate, Vanadium, s-VCAM, Vitamin A, Vitamin B1, Vitamin B12, Vitamin B2, Vitamin B3, Vitamin B6, Vitamin C, Vitamin D, Vitamin E, Vitamin K1, Von Willebrand factor, Xanthine, Xanthosine, Xanthosine 5′-monophosphate, Zinc, or prostate-specific antigen. Receptors capable of binding to these ligands may be provided in embodiments herein.

Ligands in an environmental toxicology sample that may be detected in embodiments herein include but are not limited to any toxic or potentially toxic ligand. Ligands in an environmental toxicology sample that may be detected in embodiments herein include but are not limited to Acenaphthene; Acenaphthylene; Anthracene; Arsenic; Asphalt; Benzene; Benzo(a)pyrene; Benzo(b)fluoranthene; Benzo(e)pyrene; Benzo(g,h,i)perylene; Benzo(j)fluoranthene; Benzo(k)fluoranthene; Beryllium; Biphenyl (Diphenyl; Phenylbenzene; 1,1-Biphenyl; Cadmium; Carbon Tetrachloride; Chrysene, C1-(C1-Chrysene); Copper; Cyanide(s); Dibenz(a,h)anthracene; Dibenzothiophene; Dichloroethane-1,2; Vinylidene chloride; Dichloroethylene; Diesel Oil; Ethylbenzene; Fluoranthene; Fluorene; Fuel Oil Number 2; Fuel Oil Number 4; Fuel Oil Number 6; Gasoline, General; Lead; Mercury; Mineral Oil Pharmaceuticals; Mineral; MTBE; Trimethyl naphthalene; Naphthalene, 1-Methyl-Naphthalene; Naphthalene, 2-Methyl-Naphthalene; Nickel; Motor Oil [560]; Pentachlorophenol; Perylene; Petroleum, General; Phenanthrene; Pyrene; Selenium; Silver; Strontium; Tetrachloroethylene; Toluene; Trichloroethane; Turpentine; Uranium; Vinyl Chloride; m-Xylene; o-Xylene; p-Xylene; Toluene; or Zinc.

Ligands in explosives samples that may be detected in embodiments herein include but are not limited to any explosive or potentially explosive compounds, including Acetylides of heavy metals; Aluminum containing polymeric propellant; Aluminum ophorite explosive; Amatex; Amatol; Ammonal; Ammonium nitrate explosive mixtures (cap sensitive); Ammonium perchlorate composite propellant; Ammonium perchlorate explosive mixtures; Ammonium picrate [picrate of ammonia, Explosive D]; *ANFO [ammonium nitrate-fuel oil]; Aromatic nitro-compound explosive mixtures; Azide explosives; Baranol; Baratol; BEAF [1,2-bis(2,2-difluoro-2-nitroacetoxyethane)]; Black powder; Black powder based explosive mixtures; Blasting gelatin; Blasting powder; BTNEC [bis(trinitroethyl) carbonate]; BTNEN [bis (trinitroethyl) nitramine]; BTTN [1,2,4 butanetriol trinitrate]; Bulk salutes; Butyl tetryl; Calcium nitrate explosive mixture; Cellulose hexanitrate explosive mixture; Chlorate explosive mixtures; Composition A and variations; Composition B and variations; Composition C and variations; Copper acetylide; Cyanuric triazide; Cyclonite [RDX]; Cyclotetramethylenetetranitramine [HMX]; Cyclotol; Cyclotrimethylenetrinitramine [RDX]; DATB [diaminotrinitrobenzene]; DDNP [diazodinitrophenol]; DEGDN [diethyleneglycol dinitrate]; Dimethylol dimethyl methane dinitrate; Dinitroethyleneurea; Dinitroglycerine [glycerol dinitrate]; Dinitrophenol; Dinitrophenolates; Dinitrophenyl hydrazine; Dinitroresorcinol; Dinitrotoluene-sodium nitrate; DIPAM [dipicramide; diaminohexanitrobiphenyl]; Dipicryl sulfone; Dipicrylamine; DNPA [2,2-dinitropropyl acrylate]; DNPD [dinitropentano nitrile]; Dynamite; EDDN [ethylene diamine dinitrate]; EDNA [ethylenedinitramine]; Ednatol; EDNP [ethyl 4,4-dinitropentanoate]; EGDN [ethylene glycol dinitrate]; Erythritol tetranitrate; Esters of nitro-substituted alcohols; Ethyl-tetryl; Flash powder; Fulminate of mercury; Fulminate of silver; Fulminating gold; Fulminating mercury; Fulminating platinum; Fulminating silver; Gelatinized nitrocellulose; Guanyl nitrosamino guanyl tetrazene; Guanyl nitrosamino guanylidene hydrazine; Heavy metal azides; Hexanite; Hexanitrodiphenylamine; Hexanitrostilbene; Hexogen [RDX]; Hexogene or octogene and a nitrated N-methylaniline; Hexylites; HMTD [hexamethylenetriperoxidediamine]; HMX [cyclo-1,3,5,7-tetramethylene 2,4,6,8-tetranitramine; Octogen]; Hydrazinium nitrate/hydrazine/aluminum; Hydrazoic acid; KDNBF [potassium dinitrobenzo-furoxane]; Lead azide; Lead mannite; Lead mononitroresorcinate; Lead picrate; Lead styphnate; Liquid nitrated polyol and trimethylolethane; Magnesium ophorite explosives; Mannitol hexanitrate; MDNP [methyl 4,4-dinitropentanoate]; MEAN [monoethanolamine nitrate]; Mercuric fulminate; Mercury oxalate; Mercury tartrate; Metriol trinitrate; Minol-2 [40% TNT, 40% ammonium nitrate, 20% aluminum]; MMAN [monomethylamine nitrate]; methylamine nitrate; Mononitrotoluene-nitroglycerin; Monopropellants; NIBTN [nitroisobutametriol trinitrate]; Nitrate explosive mixtures; Nitrated carbohydrate explosive; Nitrated glucoside explosive; Nitrated polyhydric alcohol explosives; Nitrocellulose explosive; Nitroderivative of urea explosive mixture; Nitrogelatin explosive; Nitrogen trichloride; Nitrogen tri-iodide; Nitroglycerine [NG, RNG, nitro, glyceryl trinitrate, trinitroglycerine]; Nitroglycide; Nitroglycol [ethylene glycol dinitrate, EGDN]; Nitroguanidine explosives; Nitronium perchlorate propellant mixtures; Nitroparaffins; Ammonium nitrate mixtures; Nitrostarch; Nitro-substituted carboxylic acids; Nitrourea; Octogen [HMX]; Octol [75 percent HMX, 25 percent TNT]; Organic amine nitrates; Organic nitramines; PBX [plastic bonded explosives]; Penthrinite composition; Pentolite; Perchlorate explosive mixtures; Peroxide based explosive mixtures; PETN [nitropentaerythrite, pentaerythrite tetranitrate, pentaerythritol tetranitrate]; Picramic acid and its salts; Picramide; Picrate explosives; Picrate of potassium explosive mixtures; Picratol; Picric acid (manufactured as an explosive); Picryl chloride; Picryl fluoride; PLX [95% nitromethane, 5% ethylenediamine]; Polynitro aliphatic compounds; Polyolpolynitrate-nitrocellulose explosive gels; Potassium chlorate and lead sulfocyanate explosive; Potassium nitrate explosive mixtures; Potassium nitroaminotetrazole; PYX [2,6-bis(picrylamino)]-3,5-dinitropyridine; RDX [cyclonite, hexogen, T4, cyclo-1,3,5,-trimethylene-2,4,6,-trinitramine; hexahydro-1,3,5-trinitro-5-triazine]; Silver acetylide; Silver azide; Silver fulminate; Silver oxalate explosive mixtures; Silver styphnate; Silver tartrate explosive mixtures; Silver tetrazene; Sodatol; Sodium amatol; Sodium azide explosive mixture; Sodium dinitro-ortho-cresolate; Sodium nitrate explosive mixtures; Sodium nitrate-potassium nitrate explosive mixture; Sodium picramate; Styphnic acid explosives; TATB [triaminotrinitrobenzene]; TATP [triacetonetriperoxide]; TEGDN [triethylene glycol dinitrate]; Tetranitrocarbazole; Tetrazene [tetracene, tetrazine, 1(5-tetrazolyl)-4-guanyl tetrazene hydrate]; Tetryl [2,4,6 tetranitro-N-methylaniline]; Tetrytol; TMETN [trimethylolethane trinitrate]; TNEF [trinitroethyl formal]; TNEOC [trinitroethylorthocarbonate]; TNEOF [trinitroethylorthoformate]; TNT [trinitrotoluene, trotyl, trilite, triton]; Torpex; Tridite; Trimethylol ethyl methane trinitrate composition; Trimethylolthane trinitrate-nitrocellulose; Trimonite; Trinitroanisole; Trinitrobenzene; Trinitrobenzoic acid; Trinitrocresol; Trinitro-meta-cresol; Trinitronaphthalene; Trinitrophenetol; Trinitrophloroglucinol; Trinitroresorcinol; Tritonal; Urea nitrate; Water-bearing explosives having salts of oxidizing acids and nitrogen bases, sulfates, or sulfamates (cap sensitive); Water-in-oil emulsion explosive compositions; or Xanthamonas hydrophilic colloid explosive mixture.

Ligands in exhaust samples that may be detected in embodiments herein include but are not limited to molecular oxygen, nitrogen, hydrogen, NO, NO₂, carbon monoxide, carbon dioxide, water, ammonia, methane, ethane, propane, other hydrocarbons, and other fuels and byproducts of combustion.

Receptors capable of binding to any ligand herein may be provided as a sensor in embodiments herein.

In an embodiment, a chemosensor system is provided having a chemosensor array, a processor and a computer-readable medium. The chemosensor array may include two more sensors selected from any sensors capable of binding a ligand. The chemosensor array may include at least one sensor, and a respective reporter operably connected to each of the at least one sensor. Binding of at least one of a plurality of ligands to one of the at least one sensor may cause activation of the respective reporter to produce a respective report intensity. Each of the plurality of ligands may have a respective free energy of binding with each respective one of the at least one sensor. Each of the at least one sensor may have a respective efficacy of activation by each respective one of the plurality of ligands. Each of the at least one sensor may have a respective background intensity. The processor may be operably connected to the chemosensor array. As used herein, “operably connected” means that data from the chemosensor array may be provided to the processor. Data may be provided directly from the array to the processor. Data may be provided by first harvesting the data from the sensor, and then providing the harvested data to the machine in which the processor resides. Harvesting the data may include saving the data. The computer-readable medium may be operably connected to the processor. As used herein, the operable connection between the computer-readable medium and the processor is such that information and/or instructions in the computer-readable medium may be provided to the processor, or that results of processing may be provided to the computer-readable medium. The computer-readable medium may be operably connected to the chemosensor array directly or through the machine in which the processor resides. The computer-readable medium may include processor executable instructions for analyzing a chemical mixture that may include the plurality of ligands. The processor executable instructions may include directions for receiving data including at least one of the respective report intensities, the respective free energies, the respective efficacies, or respective backgrounds. The processor executable instructions may include directions for inferring a respective concentration for each of the plurality of ligands from the respective report intensities received after exposing the chemosensor array to the chemical mixture. Inferring may be based on the respective free energies, the respective efficacies and the respective backgrounds. Inferring may be done by a Bayesian method. The chemosensor system may have any chemosensor array herein, and utilize any method of analysis herein.

A chemosensor system herein may have a memory storing the respective free energy and respective efficacy for each of at least one sensor in a chemosensor array in comparison to each of the plurality of ligands that may bind the sensors thereon. The memory may be the computer-readable medium. The processor and/or the computer-readable medium may be within any kind of device such as but not limited to a personal computer, a desktop computer, a multiprocessor system, a microprocessor-based or programmable consumer electronics device, or network personal computers.

The chemosensor system may also include one or more servers and network connectivity channels operably connecting a plurality of client devices and the one or more servers. Devices that may operate as the server include but are not limited to personal computers, desktop computers, multiprocessor systems, microprocessor-based or programmable consumer electronics, network personal computers.

In an embodiment, a computer-readable medium is provided. The computer-readable medium may store a set of processor-executable instructions for execution by a general purpose computer to perform a method of analyzing a chemical mixture that may contain a plurality of ligands. When executed by at least one processor, the instructions may cause the at least one processor to perform a method of analyzing a chemical mixture that may contain a plurality of ligands. The instructions may include obtaining data from a chemosensor array. The chemosensor array may include at least one sensor, and a respective reporter operably connected to each of the at least one sensor. Binding of at least one of the plurality of ligands to one of the at least one sensor may cause activation of a respective reporter to produce a respective report intensity. Each of the plurality of ligands may have a respective free energy of binding with each respective one of the at least one sensor. Each of the at least one sensor may have a respective efficacy of activation by each respective one of the plurality of ligands. Each of the at least one sensor may have a respective background intensity. The instructions may also be for inferring a respective concentration for each of the plurality of ligands from the respective report intensities based on the respective free energies, the respective efficacies and the respective backgrounds. Inferring may be done by Bayesian inference. The computer readable-medium may also include instructions for at least one of providing the chemosensor array, exposing the chemosensor array to a chemical mixture or measuring each of the respective report intensities. The term “computer-readable medium” includes but is not limited to a register, a cache memory, a read-only memory (ROM), a semiconductor memory device such as a Dynamic Random Access Memory (D-RAM), Static RAM (S-RAM), or other RAM, a magnetic medium such as a flash memory, a hard disk, a magneto-optical medium, an optical medium such as a CD-ROM, a digital versatile disk (DVDs), or Blu-Ray disc (BD), other volatile or non-volatile memory, or other type of device for electronic data storage.

A chemosensor system may include a memory device that is a device configurable to read and/or write data to/from one or more computer-readable media.

Any single embodiment herein may be supplemented with one or more element from any one or more other embodiment herein.

### EXAMPLES

The following non-limiting examples are provided to illustrate particular embodiments. The embodiments throughout may be supplemented with one or more detail from any one or more example below.

### Example 1

A first test of the physical model. The simple model in Eq. (2) assumes that each ligand type makes a separate contribution to the total fluorescent response of a cell. Moreover, the contribution is taken to be directly proportional to the occupancy of cell surface receptors by the corresponding ligand. The occupancy is a measure of the fraction of time spent by each receptor in the ligand-bound state or, equivalently, the fraction of ligand-bound surface receptors at any given moment. Different efficacies observed with different receptors (See Table A, above) may reflect conformational changes in the seven-helix bundle in the model sensors which affect G-protein activation immediately downstream.

To see whether the assumptions are correct and, thus, whether the simple model in Eq. (2) is capable of yielding accurate predictions of ligand concentrations in arbitrary mixtures, a series of tests were carried out in which a known combination of ligands was applied to receptor-bearing strains of yeast. The reporter response in each of the strains was used to decipher the contents of the mixture, using the nested sampling algorithm described with respect to FIGS. 4 and 6. As an initial test, equal portions of 2, 3 and 4 ligands were mixed in all possible combinations and absolute ligand concentrations were predicted. The concentrations and combinations are given in Table 1, below. The model from Eq. (2) in which four ligands interact with four receptors was utilized, even if only 1, 2 or three ligands were present in the mixture. Nested sampling of the four-receptor, four-ligand model was used to infer relative concentrations of all ligands (3 α's) in the mixture as well as the total ligand concentration (μ) at the standard reference point (known to be 1 mM). These predictions were converted into absolute concentrations (in mM) of each component

TABLE 1

| | | UDP | UDP-Gal | UDP-Glc | UDP-GlcNAc | Total |
|---|---|---|---|---|---|---|
| UDP-Gal | predicted | .009 ± .0004 | .89 ± .04 | .32 ± .02 | .02 ± .01 | 1.2 ± .05 |
| | actual | 0 | 1.0 | 0 | 0 | 1.0 |
| UDP-Glc | predicted | .006 ± .0007 | .28 ± .06 | .58 ± .07 | .69 ± .10 | 1.6 ± .09 |
| | actual | 0 | 0 | 1.0 | 0 | 1.0 |
| UDP-GIcNAc | predicted | .01 ± .0005 | .01 ± .002 | .02 ± .003 | 1.1 ± .05 | 1.2 ± .05 |
| | actual | 0 | 0 | 0 | 1.0 | 1.0 |
| UDP | predicted | 1.7 ± .30 | .02 ± .004 | .02 ± .003 | .03 ± .012 | 1.8 ± .32 |
| | actual | 1.0 | 0 | 0 | 0 | 1.0 |
| UDP-Gal + UDP-Glc | predicted | .006 ± .0007 | .48 ± .03 | .54 ± .03 | .01 ± .009 | 1.0 ± .04 |
| | actual | 0 | .5 | .5 | 0 | 1.0 |
| UDP-Gal + UDP-GlcNAc | predicted | .006 ± .0005 | .54 ± .05 | .15 ± .04 | .56 ± .06 | 1.3 ± .09 |
| | actual | 0 | .5 | 0 | .5 | 1.0 |
| UDP-Glc + UDP-GlcNAc | predicted | .007 ± .0007 | .01 ± .007 | .63 ± .06 | .29 ± .05 | .94 ± .06 |
| | actual | 0 | 0 | .5 | .5 | 1.0 |
| UDP + UDP-Gal | predicted | .09 ± .02 | .05 ± .008 | .0006 ± .0001 | .20 ± .03 | .35 ± .03 |
| | actual | .5 | .5 | 0 | 0 | 1.0 |
| UDP + UDP-Glc | predicted | .05 ± .007 | .01 ± .003 | .08 ± .01 | .004 ± .004 | .15 ± .02 |
| | actual | .5 | 0 | .5 | 0 | 1.0 |
| UDP + UDP-GlcNAc | predicted | .44 ± .07 | .002 ± .0005 | .003 ± .001 | .18 ± .03 | .62 ± .10 |
| | actual | .5 | 0 | 0 | .5 | 1.0 |
| UDP-Gal + UDP-Glc + UDP-GlcNAc | predicted | .005 ± .0009 | .24 ± .03 | .46 ± .04 | .02 ± .03 | .72 ± .04 |
| | actual | 0 | .33 | .33 | .33 | 1.0 |
| UDP + UDP-Gal + UDP-Glc | predicted | .04 ± .006 | .10 ± .01 | .03 ± .009 | .10 ± .01 | .26 ± .03 |
| | actual | .33 | .33 | .33 | 0 | 1.0 |
| UDP + UDP-Gal + UDP-GlcNAc | predicted | .08 ± .03 | .008 ± .002 | 10⁻⁴ ± 8.4 × 10⁻⁵ | .47 ± .05 | .56 ± .04 |
| | actual | .33 | .33 | 0 | .33 | 1.0 |
| UDP + UDP-Glc + UDP-GlcNAc | predicted | .08 ± .05 | .04 ± .04 | .07 ± .03 | .08 ± .05 | .23 ± .05 |
| | actual | .33 | 0 | .33 | .33 | 1.0 |
| All Four | predicted | .06 ± .007 | .17 ± .02 | .02 ± .008 | .23 ± .03 | .48 ± .04 |
| | actual | .25 | .25 | .25 | .25 | 1.0 |

As can be seen in Table 1, the approach is successful in identifying both zero and non-zero ligand concentrations in the mixtures. For example, with single ligands the correct chemical is predicted to have the highest concentration in 3 out of 4 cases and with binary mixtures the correct pair of chemicals is predicted to have the highest concentration in 5 out of 6 cases. However, the predictions are less accurate and the error in the total concentration is larger with UDP-containing mixtures. UDP is an antagonist for all four receptors, with small A's and large negative ΔG's (See Table A, above). Favorable binding affinity allows UDP to saturate the receptors, making inference of the other components more difficult. Indeed, the determinant of the Hessian (Eq. (4)) is consistently smaller when UDP is involved, indicating larger errors. For example, the value of the determinant with binary mixtures (computed using true values of and μ as well as parameters from Table A, above, is 763.6 for UDP-Gal+UDP-Glc, 2889.8 for UDP-Glc+UDP-GlcNAc, and 9485.1 for UDP-Gal+UDP-GlcNAc. In contrast, the determinant is 2.6×10⁻⁴ for UDP+UDP-Gal, 2.6×10⁻⁴ for UDP+UDP-GlcNAc, and 2.3×10⁻⁴ for UDP+UDP-Glc, indicating that the origin of larger errors can be traced to the fundamental limitations of the UDP antagonist activity. In all other cases, the model accurately predicts the presence, as well as the concentration, of the ligands present in the applied mixture.

### Example 2

A second test. The second test involved combining UDP-Glc and UDP-Gal in several unequal proportions (ranging from 90/10 to 10/90) and using the four-receptor array readout to predict and rank ligand concentrations. See Table 2, below. A four-ligand model was used. The four ligand model should predict zero concentrations for both UDP-GlcNAc and UDP. The α₁=[UDP-Glc]/[UDP-Gal] column in Table 2 shows that the ratio of [UDP-Glc] to [UDP-Gal] is successfully ranked in all cases with the exception of the 60/40 and 40/60 mixtures, which are predicted to be the same. Apart from the incorrectly excessive values of α₂ in the 90/10 and 80/20 cases, which are nonetheless not as large as α₁, concentrations of all ligands absent from the mixture are correctly inferred to be close to zero. Similar results were obtained with the alternative definition of α's (e.g., α₁=[UDP-Gal]/[UDP-Glc], etc.) (See Table 3, below), showing that the approach is not overly sensitive to the choice of ligand concentration. In sum, the algorithm provides accurate identification of ligands present in a mixture and a reasonable assessment of the relative amounts of each.

TABLE 2

| [UDP-Glc]/[UDP-Gal] | | a₁ | a₂ | a₃ | Log₁₀[TOT] |
|---|---|---|---|---|---|
| 90/10 | predicted | 31.3 ± 21 | 20.7 ± 13 | .0007 ± .001 | −2.73 ± 0.03 |
| | actual | 9.0 | 0 | 0 | −3 |
| 80/20 | predicted | 2.9 ± 1.3 | 1.6 ± .6 | .0002 ± .0002 | −2.77 ± 0.03 |
| | actual | 4.0 | 0 | 0 | −3 |
| 60/40 | predicted | 1.1 ± .2 | .07 ± .07 | .0004 ± .0003 | −2.88 ± 0.03 |
| | actual | 1.5 | 0 | 0 | −3 |
| 40/60 | predicted | 1.1 ± .2 | .008 ± .02 | .0004 ± .0003 | −2.87 ± 0.02 |
| | actual | 0.66 | 0 | 0 | −3 |
| 20/80 | predicted | .95 ± .2 | .02 ± .05 | .002 ± .001 | −2.81 ± 0.02 |
| | actual | 0.25 | 0 | 0 | −3 |
| 10/90 | predicted | .32 ± .08 | .004 ± .007 | .003 ± .0009 | −2.82 ± 0.02 |
| | actual | 0.11 | 0 | 0 | −3 |

TABLE 3

| [UDP-Gal]/[UDP-Glc] | | α₁ | α₂ | α₃ | log₁₀[TOT] |
|---|---|---|---|---|---|
| 10/90 | predicted | .009 ± .03 | .64 ± .11 | .0002 ± 0 | −2.74 ± 0.03 |
| | actual | .11 | 0 | 0 | −3 |
| 20/80 | predicted | .47 ± .1 | .59 ± .1 | .0002 ± 0 | −2.78 ± 0.03 |
| | actual | .25 | 0 | 0 | −3 |
| 40/60 | predicted | .96 ± .17 | .05 ± .07 | .0004 ± .0002 | −2.88 ± 0.02 |
| | actual | .66 | 0 | 0 | −3 |
| 60/40 | predicted | 1.1 ± .3 | .04 ± .08 | .0006 ± .0053 | −2.87 ± 0.02 |
| | actual | 1.5 | 0 | 0 | −3 |
| 80/20 | predicted | 1.1 ± .2 | .02 ± .02 | .003 ± .001 | −2.81 ± 0.02 |
| | actual | 4.0 | 0 | 0 | −3 |
| 90/10 | predicted | 3.6 ± 1.2 | .04 ± .06 | .01 ± .004 | −2.81 ± 0.02 |
| | actual | 9.0 | 0 | 0 | −3 |

### Example 3

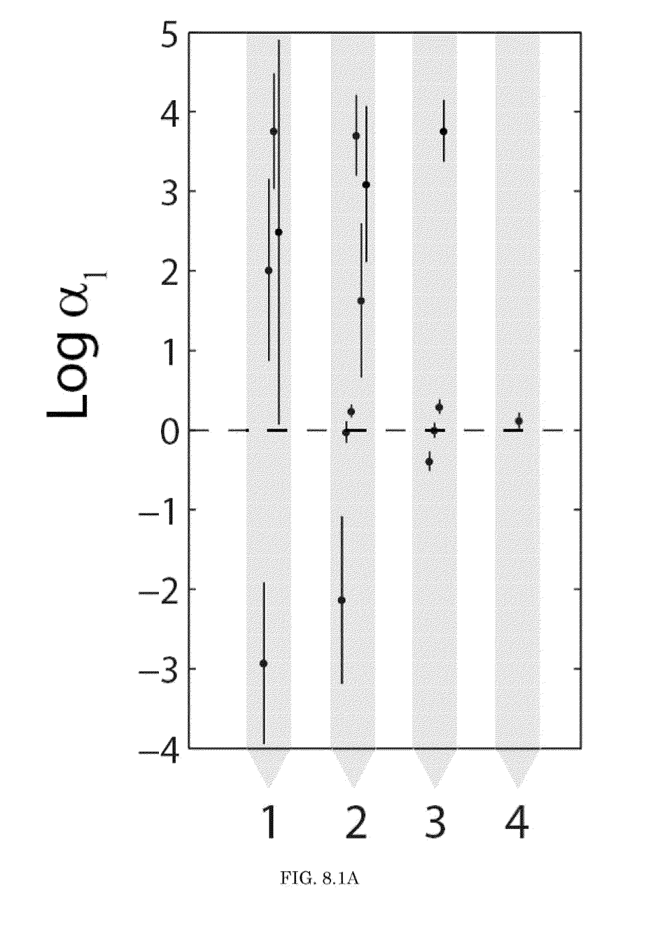

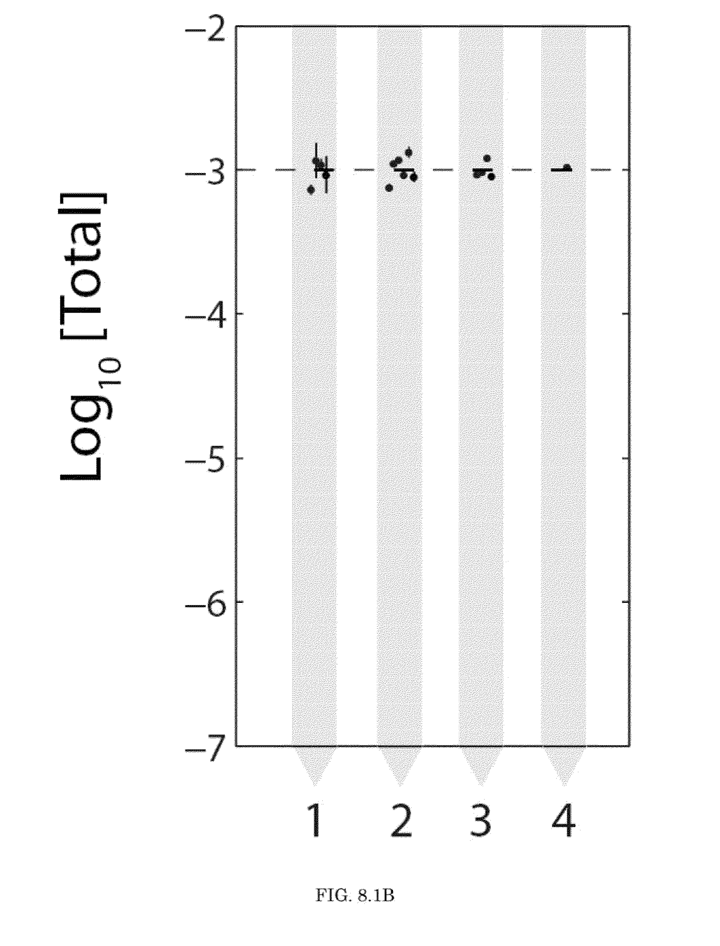

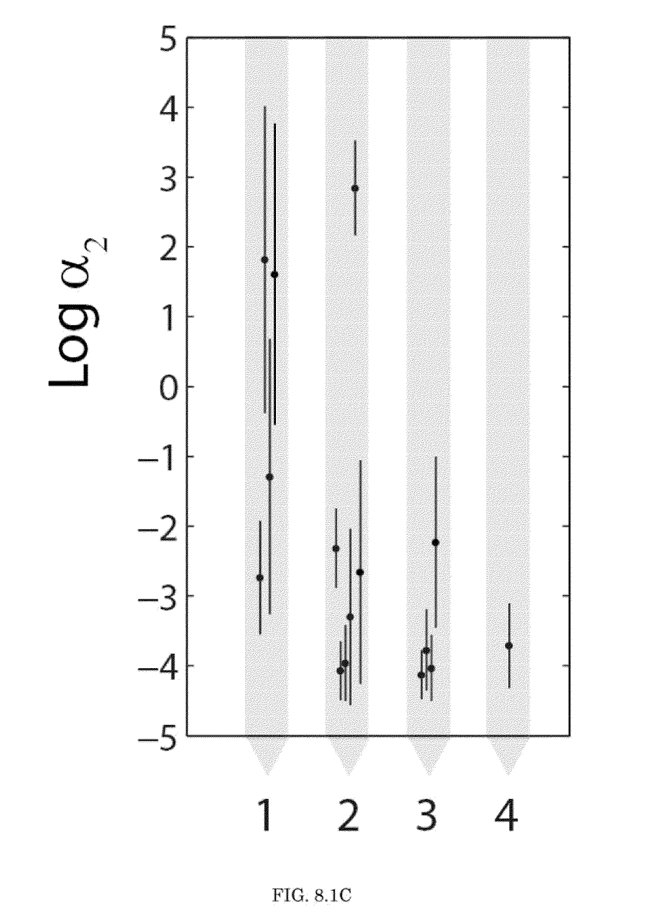

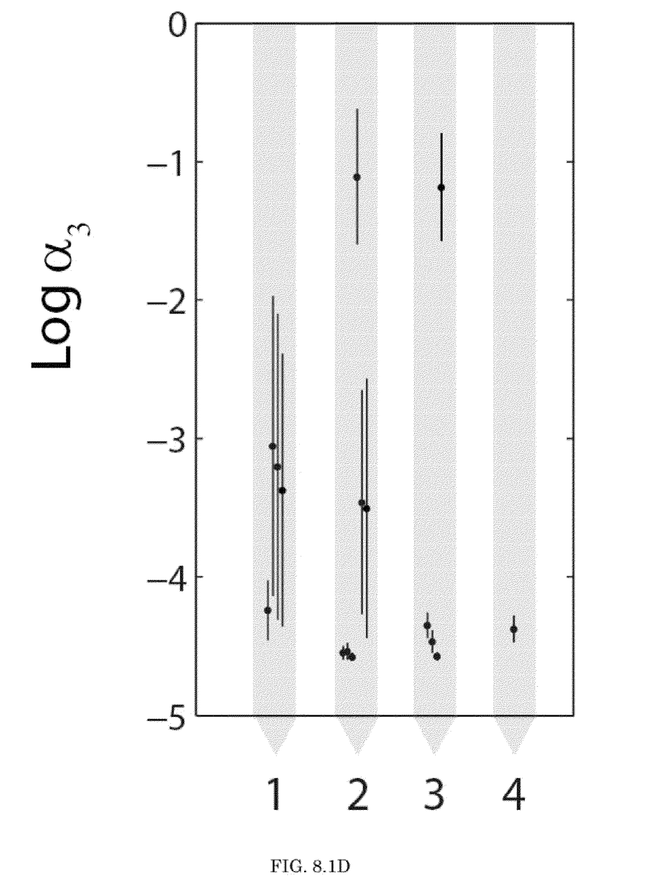

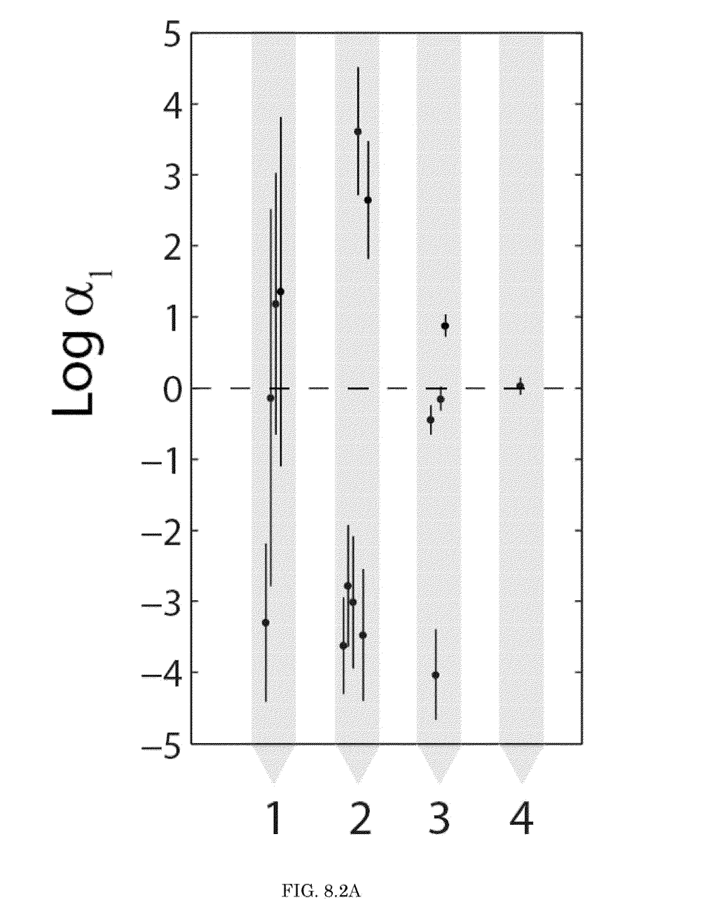

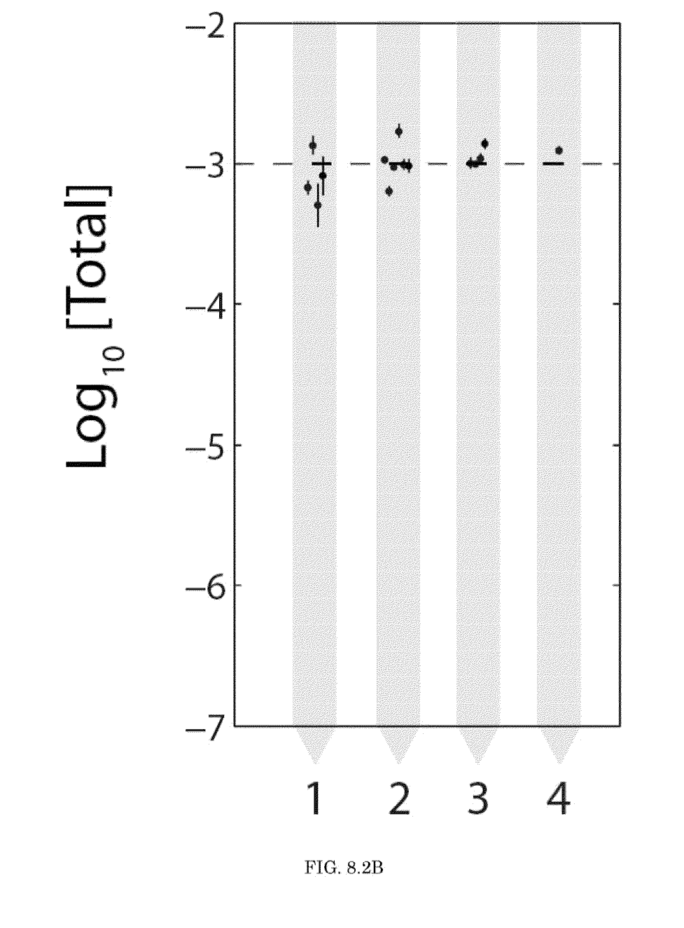

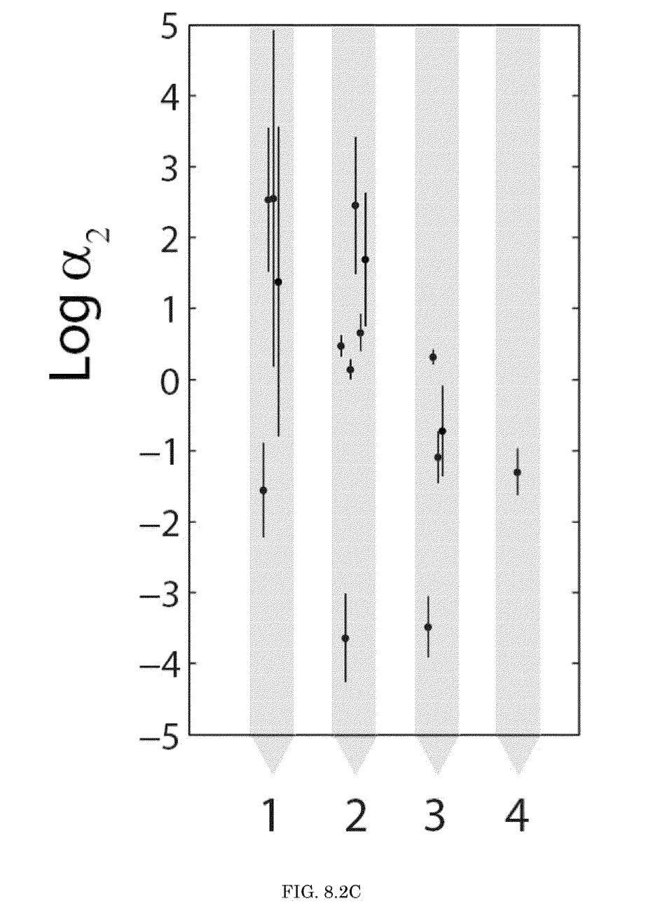

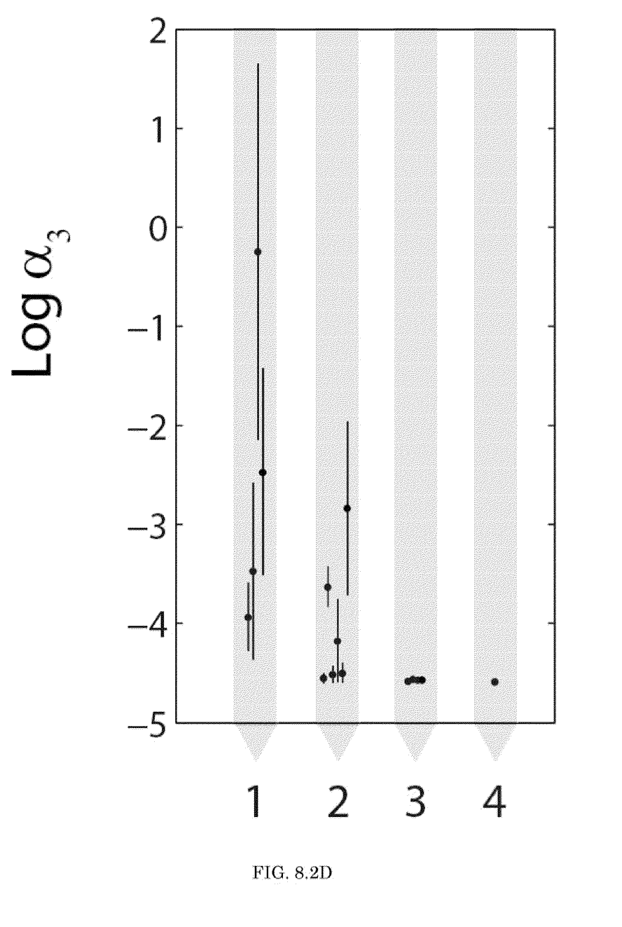

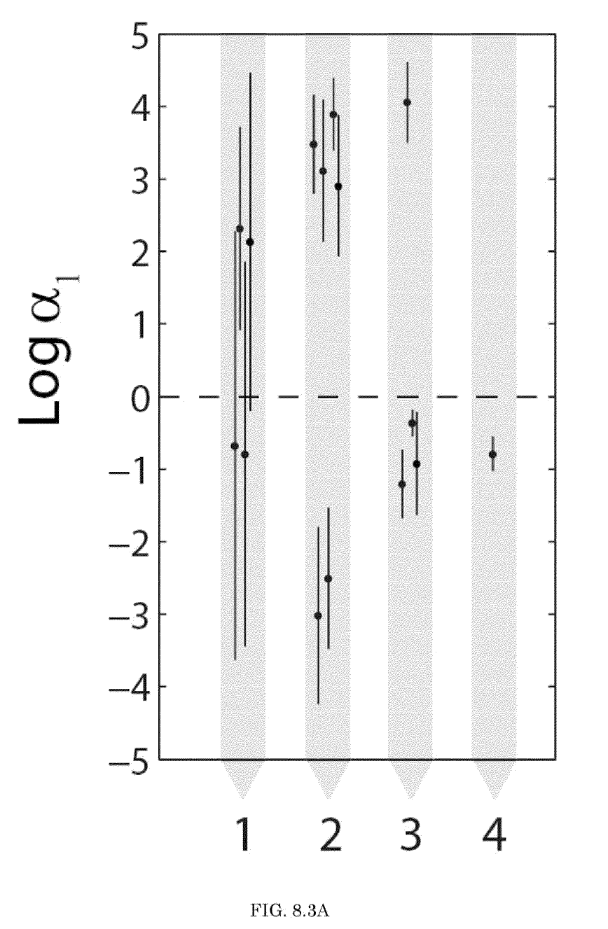

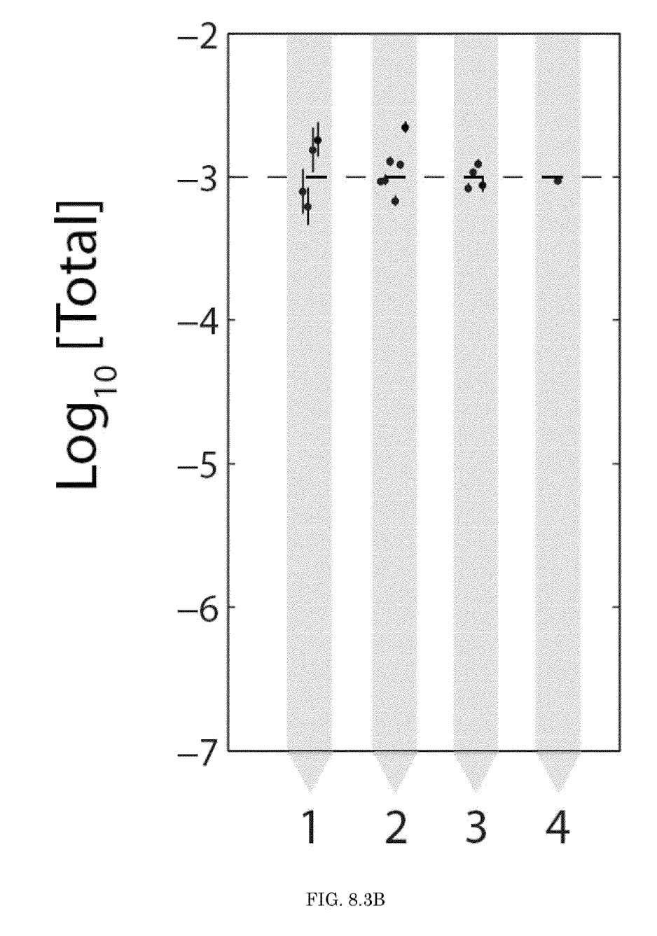

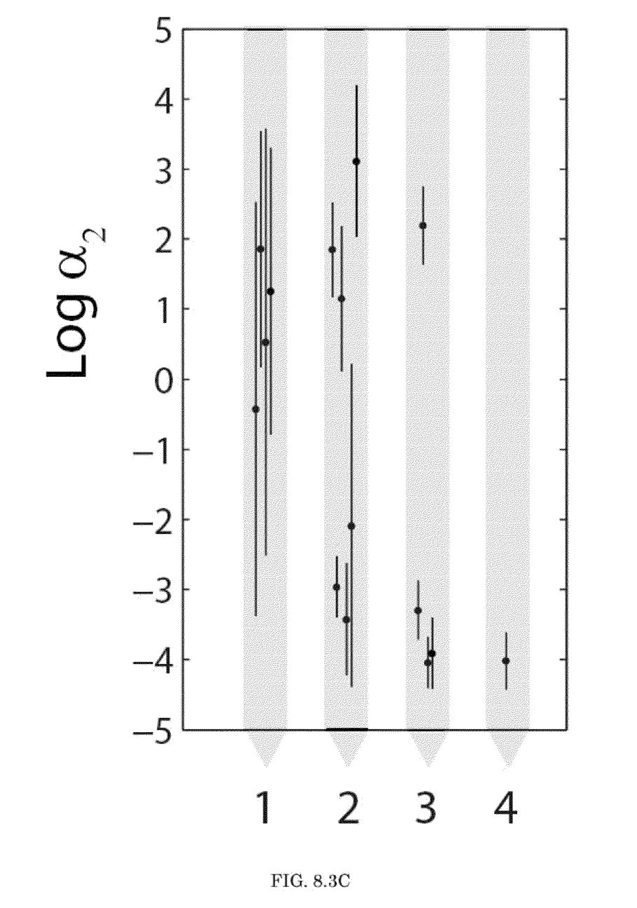

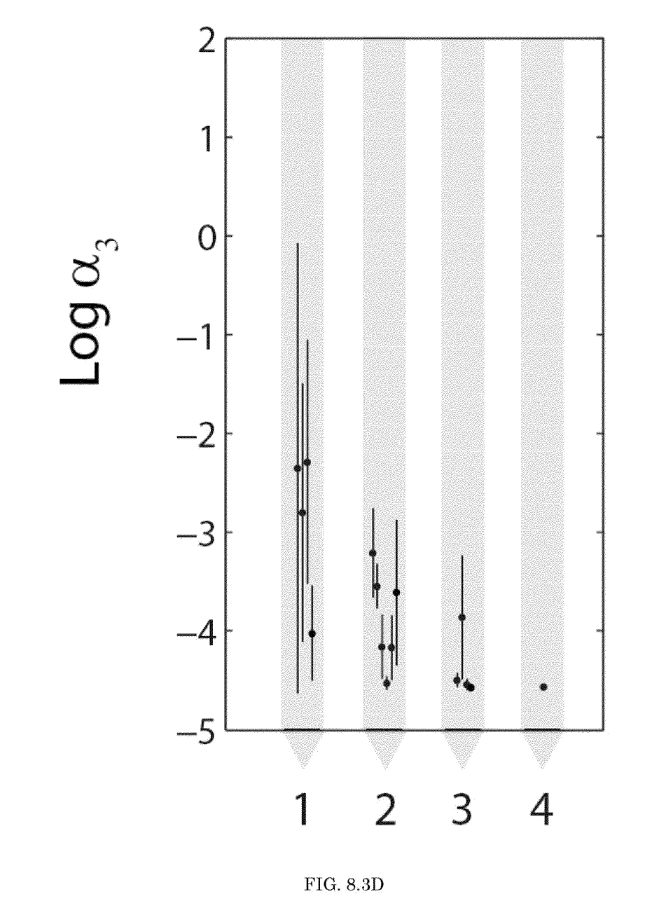

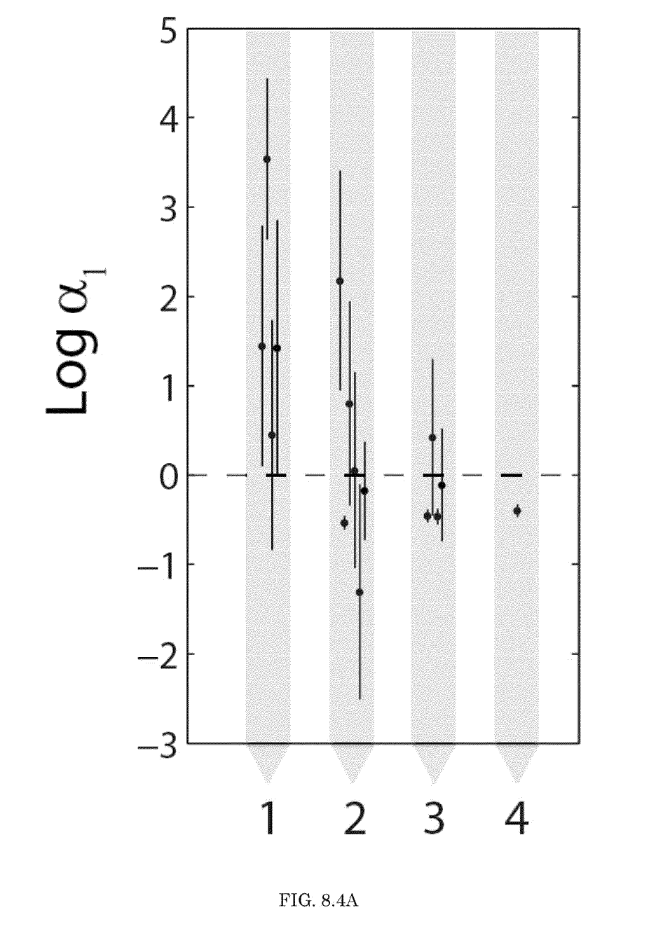

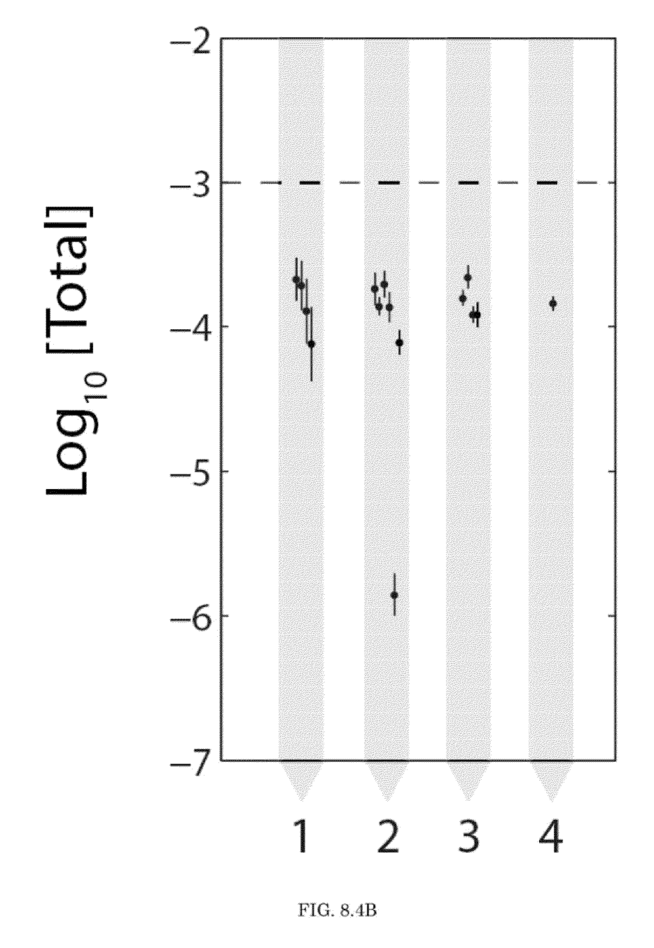

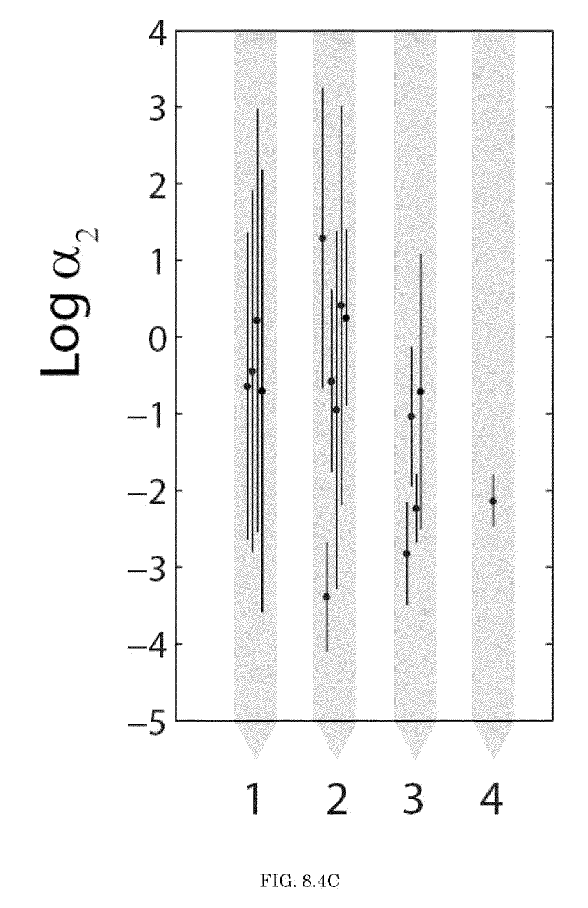

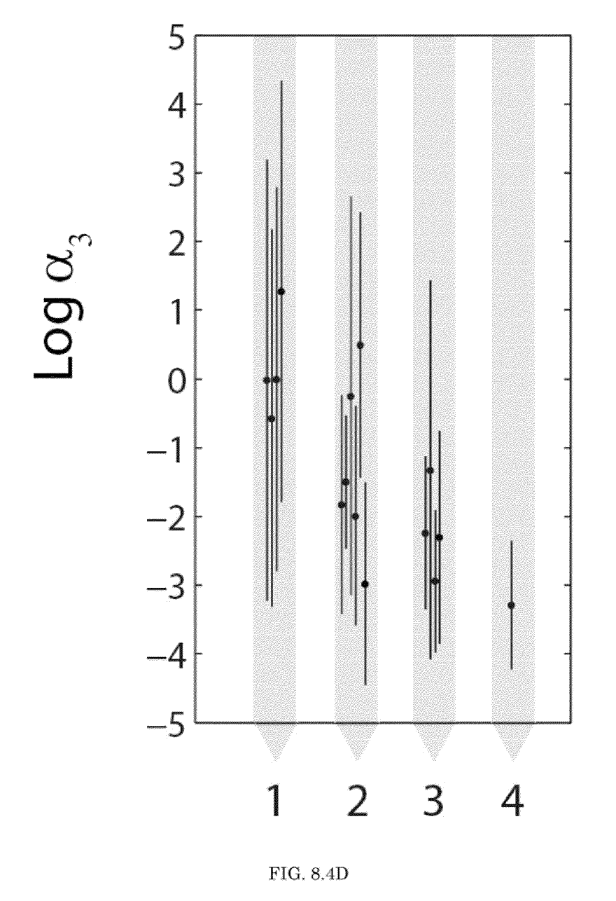

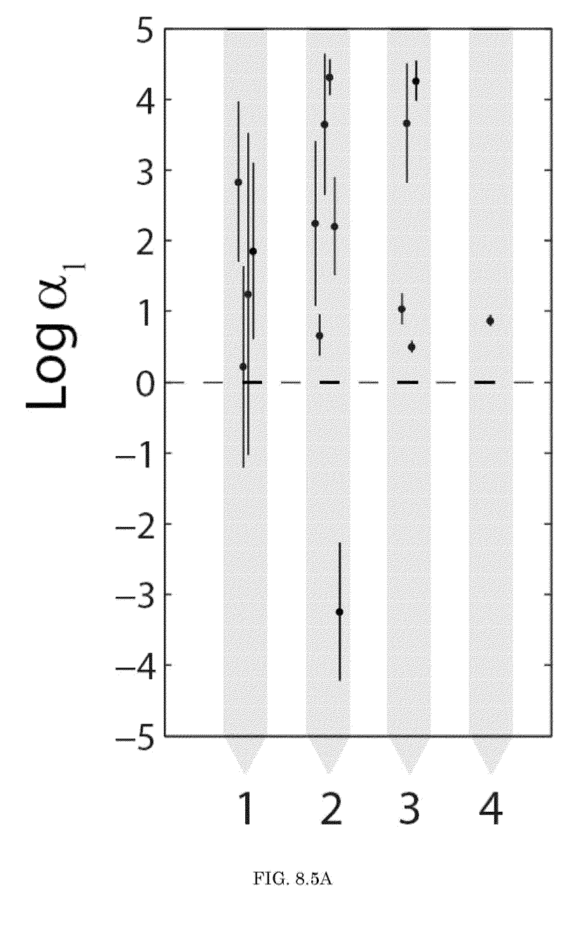

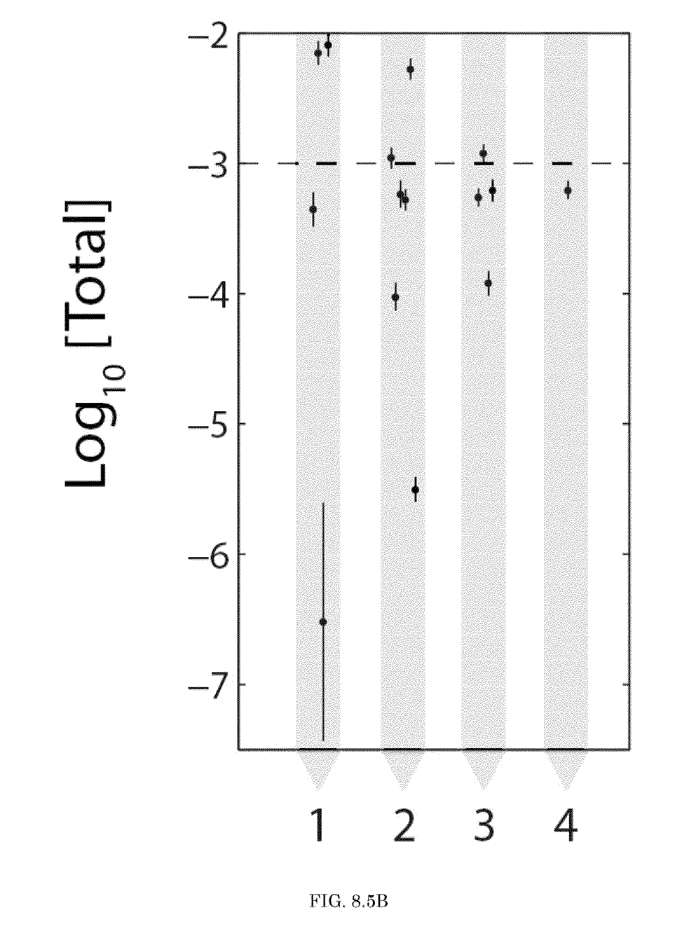

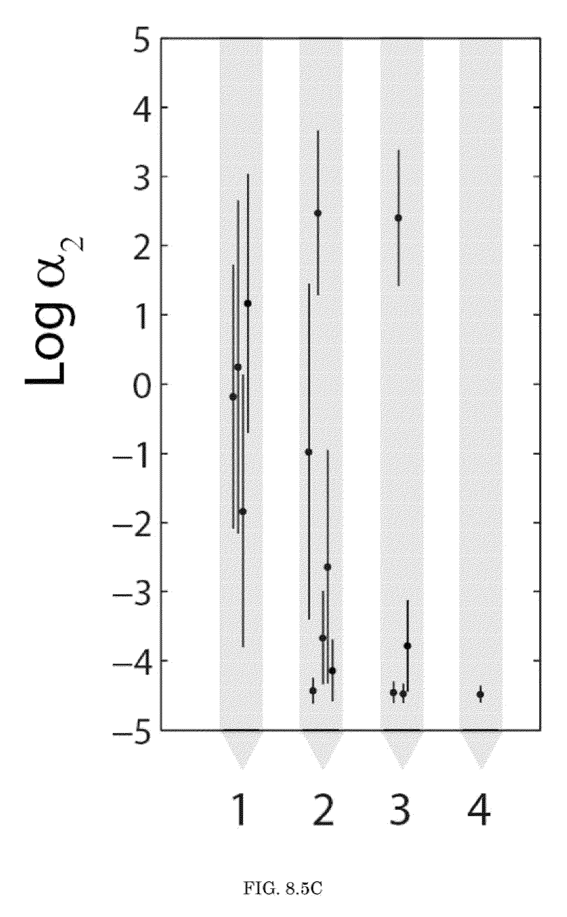

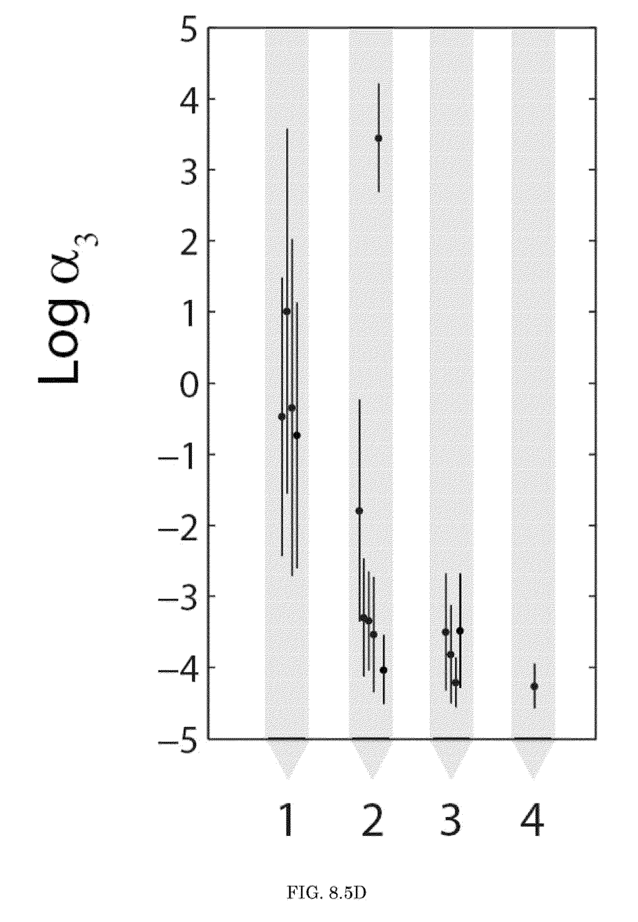

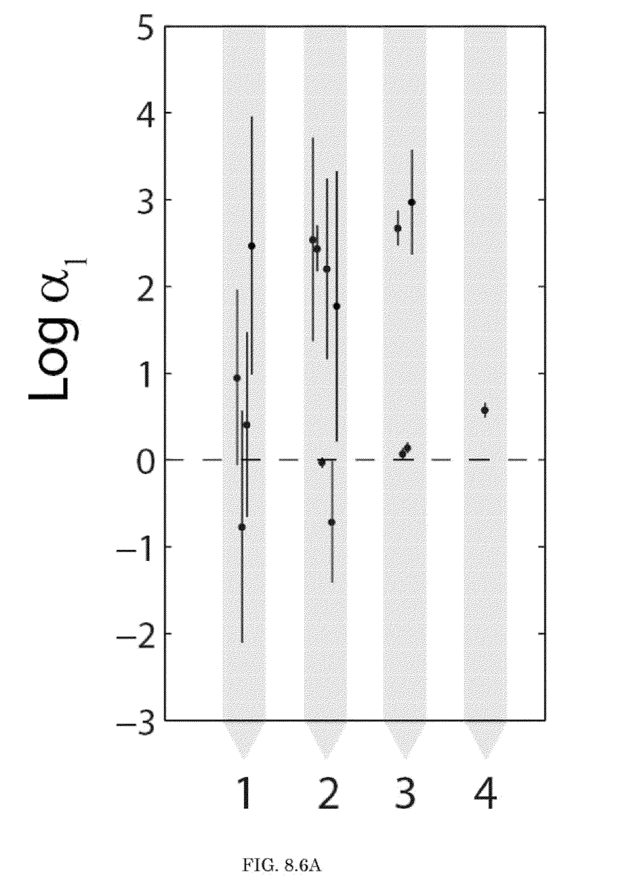

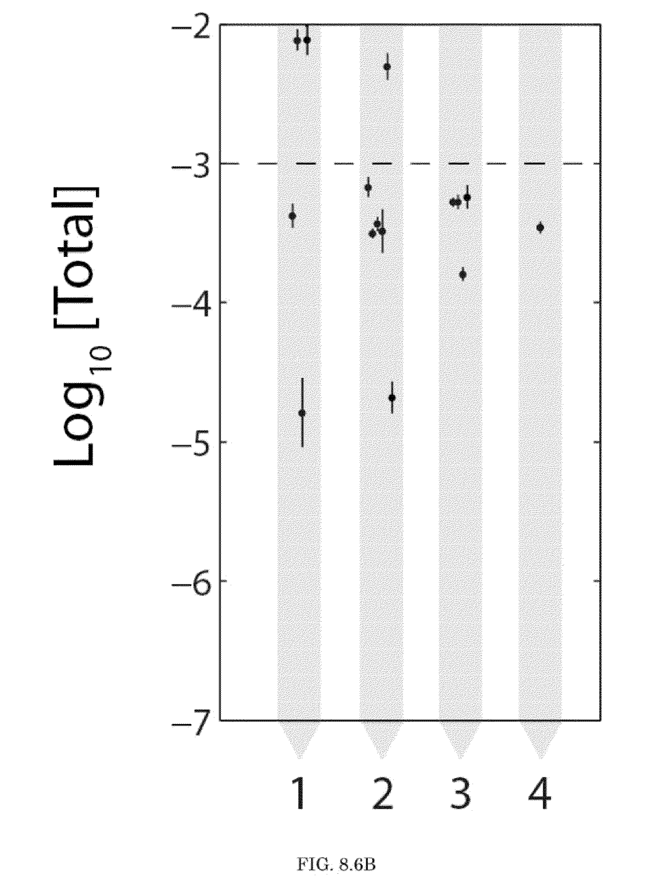

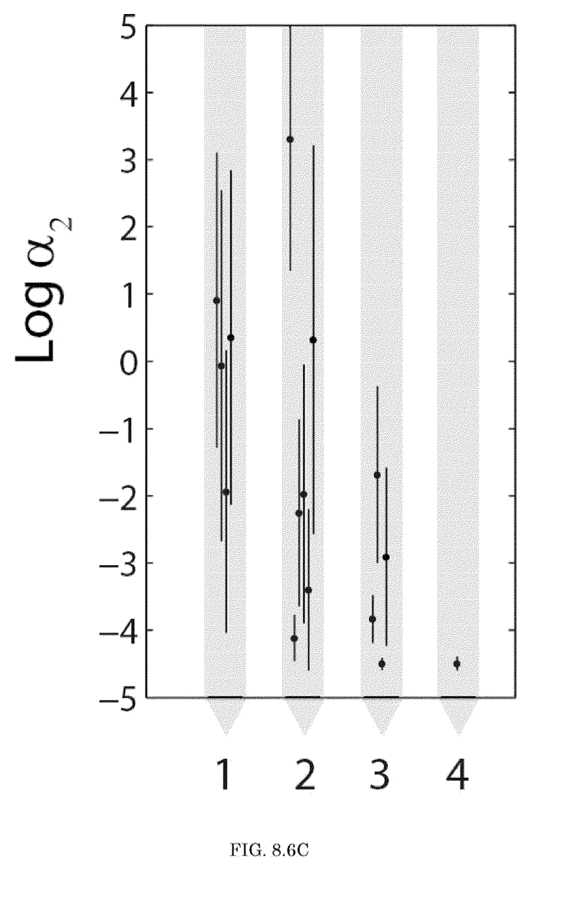

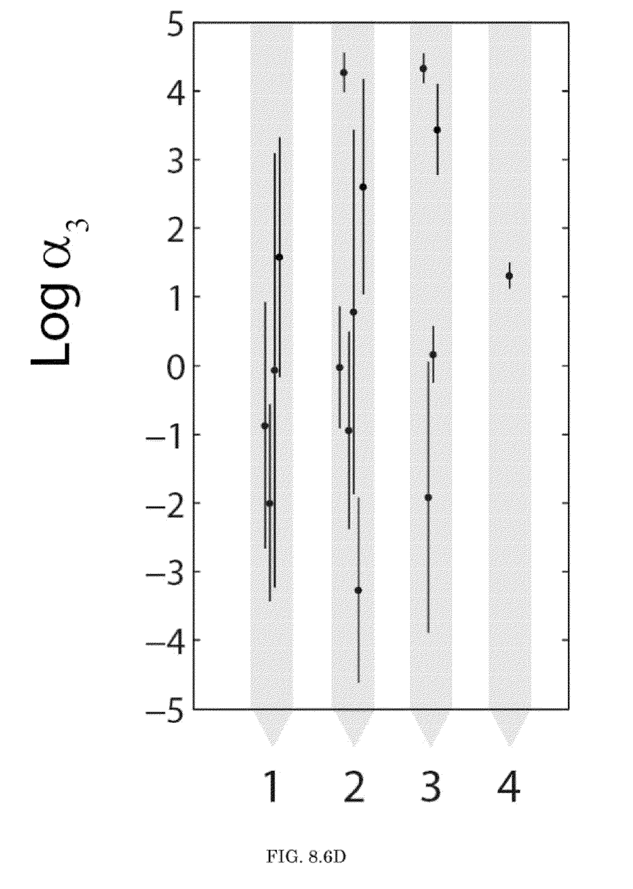

Increasing the number of sensors. Increasing the number of receptors may improve prediction accuracy by providing additional information about the mixture. Referring to FIGS. 8.1A-D through 8.6A-D, the four-ligand model was used to infer α₁ (FIGS. 8.1A, 8.2A, 8.3A, 8.4A, 8.5A and 8.6A), α₂ (FIGS. 8.1C, 8.2C, 8.3C, 8.4C, 8.5C and 8.6C), α₃ (FIGS. 8.1D, 8.2D, 8.3D, 8.4D, 8.5D and 8.6D) and log₁₀ n (FIGS. 8.1B, 8.2B, 8.3B, 8.4B, 8.5B and 8.6B) for six distinct 50/50 binary mixtures of two nucleotide sugars: UDPgal+UDP-Glc; UDPgal+UDP-GlcNAc; UDP-Glc+UDP-GlcNAc; UDP+UDP-Glc; UDP+UDP-GlcNAc; and UDP+UDP-Gal. This experiment was designed to test the extent of improvements from increasing receptor number. The results for nucleotide sugar pairs are separated in these figures as follows: FIGS. 8.1A -D/UDPgal+UDP-Glc; FIGS. 8.2A-D/UDPgal+UDP-GlcNAc; FIGS. 8.3A-D/UDP-Glc+UDP-GlcNAc; FIGS. 8.4A-D/UDP+UDP-Glc; FIGS. 8.5A-D/UDP+UDP-GlcNAc; and FIGS. 8.6A-D/UDP+UDP-Gal. The following receptors were utilized: receptor R1, R2, R3 and R4, which are the 11-20, K-3, L-3 and 2211 receptors, respectively. The mean values and error bars are predicted by nested sampling using the four-ligand model. The 50-50 binary mixture of the two above listed ligands in each experiment led to αₗ=1, α₂=α₃=0, and log₁₀ [Total]=−3 at the standard reference point ([Total]=[UDP-Glc]+[UDP-GlcNAc]+[UDP-Gal]+[UDP]). Each of FIGS. 8.1A-D through 8.6A-D include plots with panels 1, 2, 3 and 4, which separate the results for the number of receptors used to interrogate the above indicated binary mixture. In each panel 1, one receptor is used to interrogate the mixture, and the order of results from left to right is for receptor R1, R2, R3 and R4. In each panel 2, two receptors are used to interrogate the mixture, and the order of results from left to right is for the receptor pairs R1/R2, R1/R3, R1/R4, R2/R3, R2/R4 and R3/R4. In each panel 3, three receptors are used to interrogate the mixture and the order of results from left to right is for the receptor combinations R1/R2/R3, R1/R2/R4, R1/R3/R4 and R2/R3/R4. In each panel 4, four receptors are used to interrogate the mixture and the results are for the receptor combination R1/R2/R3/R4.

As expected, the errors rapidly become smaller with an increasing number of receptors, making larger arrays unnecessary for the four-ligand discrimination task. Surprisingly, in several cases adding extra receptors makes the errors somewhat worse before they become better again (cf. e.g. the R1 and R1/R2 error bars in the UDP+UDP-Gal α₁ panel of FIG. 8.6A). This is contrary to the naive expectation that having more data always improves performance, but can be understood if the new data is too noisy or does not add new information. In the multi-dimensional case, increasing the number of data points does not automatically lead to smaller errors or to the larger value of the Hessian determinant (Eq. (4)).

### Example 4

A GPCR based chemosensor array and a method of engineering biological receptors. The GPCR based chemosensor array having receptors titled “2211,” “H-20,” and “K-3” reported in Ault A, Broach J (2006) Creation of GPCR-based chemical sensors by directed evolution in yeast. Prot. Eng. Des. Sel. 19:1-8, which is incorporated herein by reference as if fully set forth, was used herein with an addition. A receptor titled “L-3” was added to the chemosenor arrry of Ault and Broach. The chemosensor array was produced by directed evolution, as follows.

The UDP-glucose receptor described in Chambers J, et al. (2000) A G protein-coupled receptor for UDP-glucose. J. Biol. Chem. 275:10767-10771, which is incorporated herein by reference as if fully set forth, was subjected to directed evolution. This UDP-glucose receptor is designated as KIAA0001 and its amino acid sequence (SEQ ID NO: 1) and its nucleic acid coding sequence (SEQ ID NO: 2) can be found at GenBank Accession No. D13626.

Materials: UDPG, UDP-galactose (UDP-Gal), UDP-N-acetylglucosamine (UDP-glcNAC), UDP-N-acetylgaltactosamine (UDPgalNAC), uridine triphosphate (UTP), uridine diphosphate (UDP), glucose-1-phosphate (G-1-P), glucose-6-phosphate (G-6-P), UDP-glucose-pyrophosphorylase (UGPase), glycogen synthase (GS), pyrophosphatase (PPase) and fluorescein (FDG) were purchased from Sigma-Aldrich (St. Louis, Mo.). Mutazyme was purchased from Stratagene.

Strains and plasmids: Mutagenesis and selection were performed in yeast strain CY10560 (P_{FUS1}-HIS3 ade2D3447 ade8D3457 can1-100 far1D1442 his3D200 leu2-3,112 lys2 sst2D1056 step14::trp1::LYS2 step18g6-3841 step3D1156 trp1-1 ura3-52). B-Galactosidase assays were performed using yeast strain CY10981 (PFus1-HIS3 can1-100 far1D1442 his3D200 leu2-3,112 lys2 sst2D2 step14::trp1::LYS2 step3D1156 trpl-1 ura3-52) carrying plasmid Cp1021 (P_{FUS1}-LacZ 2 μm URA3). The UDP-glucose receptor was cloned into plasmid Cp1651 to yield plasmid pAH1 (P_{PGK1}-hP2Y14 2 μm LEU2) for expression in the host strains.

Mutagenesis and selection of sensitized receptor mutants: The entire UDPG receptor gene was mutagenized via errorprone mutagenesis to an estimated frequency of −2-5 mutations/kb following the Mutazyme protocol. A library of mutants was generated by gap repair cloning and plated to near confluence on selective media. A total of (1-2)×10⁵ colonies were screened by replica plating to SC-His medium (Kaiser, C., Michaelis, S, and Mitchell, A. (1994) Methods in Yeast Genetics: A Cold Spring Harbor Laboratory Course Manual. Cold Spring Harbor Laboratory Press, Cold Spring Harbor, N.Y., which is incorporated herein by reference as if fully set forth) with or without ligand. Yeast growth media was supplemented by 1 mM 3AT, a competitive inhibitor of the HIS3 reporter gene product, which sets the threshold for reporter gene activation.

Targeted mutagenesis and selection of functional receptor mutants: To generate targeted mutants, oligonucleotides with randomized sequences corresponding to the codons to be mutagenized were utilized to generate overlapping PCR products. The sequence numbering below refers the following sequence:

(SEQ ID NO: 3)
MINSTSTQPPDESCSQNLLITQQIIPVLYCMVFIAGILLNGVSGWIFFY
VPSSKSHIYLKNIVIADFVMSLTFPFKILGDSGLGPWQLNVFVCRVSAV
LFYVNMYVSIVFFGLISFDRYYKIVKPLWTSFIQSVSYSKLLSVIVWML
MLLLAVPNIILTNQSVREVTQIKCIELKSELGRKWHKASNYIFVAIFWI
VFLLLIVFYTAITKKIFKSHLKSSRNSTSVKKKSSRNIFSIVFVFFVCF
VPYHIARIPYTKSQTEAHYSCQSKEILRYMKEFTLLLSAANVCLDPIIY
FFLCQPFREILCKKLHIPLKAQNDLDISRIKRGNTTLESTDTL.

The sequence of SEQ ID NO: 3 is identical to the sequence of SEQ ID NO: 1 but starts several amino acids into SEQ ID NO: 1. The HIAR motif corresponds to P2Y14 amino acids 250-253 in TM6, the KExT motif corresponds to amino acids 277-280 in TM7, the NMY motif corresponds to amino acids 104-106 in TM3 and the AxxFY motif corresponds to amino acids 98-102 in TM3. Mutant libraries were generated by gap repair using overlapping PCR products and transforming to media selective for recombined plasmids. To select for functional mutants, libraries were replica plated to selective media containing one of six ligands: UDP-Gal, UDPG, UDP-galNAc, UDP-glcNAc, UDP or dTDP-glucose (50 ml of 1 mM concentration spread on 30 ml of SC-Leu-His agar medium in 8.5 cm Petri plates).

β-Galactosidase assays were carried out as described in Chambers J, et al. (2000) A G protein-coupled receptor for UDP-glucose. J. Biol. Chem. 275:10767-10771, which is incorporated herein by reference as if fully set forth, with the exception that cultures were incubated with ligand in 500 ml cultures in 48-well culture blocks rather than in microtiter plates as described. Schild plot analysis was carried out as described, using visual interpolation to read inhibitor concentrations corresponding to the EC20 of each plot (Limbird, L. E. (1996) Cell Surface Receptors: A Short Course on Theory and Methods. Kluwer, Boston, which is incorporated herein by reference as if fully set forth). The assay described in Chambers J, et al. is described in more detail in a subsequent example.

Cells were transformed with a plasmid library carrying the randomly mutated human UDPG receptor gene. Transformants were recovered on non-selective medium and then screened for growth on selective media without ligand or containing 0.03 mM UDPG or 0.3 mM UDP-Gal, UDP-GlcNAc or UDP-GalNAc. Some of the transformants exhibited constitutive growth in the absence of ligand. Most of the nonconstitutive mutant receptors that promoted growth in response to any one of the non-native ligands showed growth in response to each of the other ligands, including UDPG, and therefore did not show signs of altered ligand specificity.

Mutant 2211 was isolated with enhanced sensitivity. 2211 includes the mutations K54E, A98V, A193V, F243I and A252V in comparison to SEQ ID NO: 3 to give the following sequence:

(SEQ ID NO: 4)
MVNSTSTQPPDESCSQNLLITQQIIPVLYCMVFIAGILLNGVSGWIFFY
VPSSESFIIYLKNIVIADFVMSLTFPFKILGDSGLGPWQLNVFVCRVSG
VLFYVNMYVSIVFFGLISFDRYYKIVKPLWTSFIQSVSYSKLLSVIVWM
LMLLLAVPNIILTNQSVREVTQIKCIELKSELGRKWHKASNYIFVVIFW
IVFLLLIVFYTAITKKIFKSHLKSSRNSTSVKKKSSRNIFSIVFVFIVC
FVPYHIVRIPYTKSQTEAHYSCQSKEILRYMKEFTLLLSAANVCLDPII
YFFLCQPFREILCKKLHIPLKAQNDLDISRIKRGNTTLESTDTL*.

2111 responds to all three non-native ligands (UDP-Gal, UDP-GlcNAc and UDP-GalNAc). In liquid β-galactosidase assays, this receptor shows increased reporter activation at all concentrations of ligand, without significant changes in the EC₅₀. Like the wild-type UDPG receptor, the 2211 receptor did not promote detectable growth in plate assays in the absence of ligand. The 2211 receptor retains the essential signaling properties of the wild-type P2Y14 receptor while functioning more robustly in the yeast expression system. In any chemosensor array, chemosensor array system, method herein or computer-readable medium herein, a starting receptor could be similarly sensitized, or used as is. In this example, 2111 was used as a starting point for subsequent rounds of mutagenesis and selection.

Any type of mutagenisis, selection or screening could be utilized to develop receptors that are sensitized, have altered specificity, or have both an altered sensitivity and specificity. In this example, specificity was developed by targeted mutagenesis of 2111. Motifs to target for mutagenesis were selected based on conserved residues in the nucleotide receptor subfamily and a model of the transmembrane regions of the UDPG receptor based on the crystal structure of bovine rhodopsin (Moro et al., 1998; Palczewski et al., 2000; Jacobson et al., 2004). Overall, alignments of the transmembrane domains and conserved residues suggest a ligand binding pocket in the canonical ligand-binding region of GPCRs between transmembrane helices 3, 6 and 7.

The ‘HIAR’ motif in transmembrane domain 6 was targeted. The His250 and Arg253 residues in P2Y14 (the starting receptor) correspond to His and Lys residues, respectively, that are critical for activation of the P2Y1 receptor by ATP (Moro et al., 1998; Jacobson et al., 2004). Libraries containing the randomized HIAR motif were constructed in vivo by cotransforming strain CY10560 cells with three DNA fragments: a 2211 receptor plasmid cut to remove the HIAR domain and a pair of PCR products synthesized with oligonucleotides randomized over the HIAR region and 50 and 30 extensions overlapping both sides of the gap in the plasmid. Transformants were replicated to plates containing UDPG or one of the non-native ligands UDP-Gal, UDP-GlcNAc or UDP-GalNAc. Transformants were also replica plated to plates containing UDP and dTDP-glucose to test for the presence of mutant receptors capable of responding to ligands that do not activate the parent receptor. Twenty out of −5000 transformants grew in the presence of one or more ligands. The 20 receptors isolated in this primary screen were subsequently retested for growth in the presence of lower concentrations of each ligand, to ascertain whether the receptor had significant changes in ligand preference. One of the 20 receptors had a dramatically different profile of ligand responsiveness than the starting receptor. To determine whether the receptors that lacked appreciable changes in ligand specificity were indeed mutants and to verify the complexity of the mutant library, the DNA encoding each receptor was sequenced. Sequencing revealed that three plasmids contained unaltered 2211 receptor DNA. Thirteen of the 17 remaining plasmids contained unique, readable sequences, each of which contained randomized DNA across the HIAR motif. Strikingly, the histidine residue was conserved in every mutant receptor and the arginine residue was conserved in 12 of the 13 clones. The remaining clone contained HTVK in place of the HIAR motif and exhibited altered ligand specificity in growth assays, showing a preference for growth in the presence of UDP-Gal versus UDPG. The HTVK mutant, designated H-20, had the following sequence:

(SEQ ID NO: 5)
MVNSTSTQPPDESCSQNLLITQQIIPVLYCMVFIAGILLNGVSGWIFFY
VPSSESFIIYLKNIVIADFVMSLTFPFKILGDSGLGPWQLNVFVCRVSG
VLFYVNMYVSIVFFGLISFDRYYKIVKPLWTSFIQSVSYSKLLSVIVWM
LMLLLAVPNIILTNQSVREVTQIKCIELKSELGRKWHKASNYIFVVIFW
IVFLLLIVFYTAITKKIFKSHLKSSRNSTSVKKKSSRNIFSIVFVFIVC
FVPYHTVKIPYTKSQTEAHYSCQSKEILRYMKEFTLLLSAANVCLDPII
YFFLCQPFREILCKKLHIPLKAQNDLDISRIKRGNTTLESTDTL*

H-20 was selected as the template for mutagenesis of three additional motifs, ‘AxxFY’ and ‘NMY’ in TM3 and ‘KExT’ in TM7. These mutants were tested in the same manner as the HIAR mutants, focusing only on mutants with clear changes in relative growth on one or more ligands. Of these, one mutant, designated K-3, in which KEFT was replaced by KGFT, had the most dramatic changes. The K-3 mutant grew poorly relative to its parent in response to UDPG and UDP-Gal but, surprisingly, grew in the presence of UDP. The K-3 mutant had the following sequence:

(SEQ ID NO: 6)
MVNSTSTQPPDESCSQNLLITQQIIPVLYCMVFIAGILLNGVSGWIFFY
VPSSESFIIYLKNIVIADFVMSLTFPFKILGDSGLGPWQLNVFVCRVSG
VLFYVNMYVSIVFFGLISFDRYYKIVKPLWTSFIQSVSYSKLLSVIVWM
LMLLLAVPNIILTNQSVREVTQIKCIELKSELGRKWHKASNYIFVVIFW
IVFLLLIVFYTAITKKIFKSHLKSSRNSTSVKKKSSRNIFSIVFVFIVC
FVPYHIVRIPYTKSQTEAHYSCQSKEILRYMKGFTLLLSAANVCLDPII
YFFLCQPFREILCKKLHIPLKAQNDLDISRIKRGNTTLESTDTL*

The L-3 mutant was isolated in a similar manner as the H-20 and K-3 mutants: oligonucleotides with randomized sequences corresponding to the codons to be mutagenized were utilized to generate overlapping PCR products. The L-3 motif corresponds to amino acid residues LLxSA on TM7 starts at residue 281. Mutant libraries were generated by gap repair using overlapping PCR products and transforming media selective for recombined plasmids. To select for functional mutants, libraries were replica-plated to selective SC-His media (Kaiser, Michaelis et al. 1994) containing one of six ligands: UDPGal, UDPG, UDP-galNAc, UDP-glcNAc, UDP or dTDP-glucose (50 μl 1 mMspread on 30 ml SCLeu-His agar medium in 8.5 cm petri plates). Yeast growth media was supplemented by 1 mM 3AT, a competitive inhibitor of the HIS3 reporter gene product, which sets the threshold for reporter gene activation. Specificity of the L-3 mutant is described above. The L-3 mutant had the sequence:

(SEQ ID NO: 7)
MVNSTSTQPPDESCSQNLLITQQIIPVLYCMVFIAGILLNGVSGWIFFY
VPSSESFIIYLKNIVIADFVMSLTFPFKILGDSGLGPWQLNVFVCRVSG
VLFYVNMYVSIVFFGLISFDRYYKIVKPLWTSFIQSVSYSKLLSVIVWM
LMLLLAVPNIILTNQSVREVTQIKCIELKSELGRKWHKASNYIFVVIFW
IVFLLLIVFYTAITKKIFKSHLKSSRNSTSVKKKSSRNIFSIVFVFIVC
FVPYHIVRIPYTKSQTEAHYSCQSKEILRYMKEFTVFLSSANVCLDPII
YFFLCQPFREILCKKLHIPLKAQNDLDISRIKRGNTTLESTDTL*

As shown by the H-20, K-3 and L-3 mutants, targeted mutagenesis of conserved motifs in ligand binding domains of the UDPG receptor can yield receptors with altered ligand specificity. A similar strategy could be employed with any biological receptor to develop new receptors with different specificities.

### Example 5

β-Galactosidase assays. β-galactosidase assays were carried out as described in Chambers J, et al. (2000) A G protein-coupled receptor for UDP-glucose. J. Biol. Chem. 275:10767-10771, which is incorporated herein by reference as if fully set forth. The assay in Chambers J, et al. is a modification of that found in Klein C, et al. (1998) Nat. Biotechnol. 16, 1334-1337, which is incorporated herein by reference as if fully set forth.

As background, Klien C, et al. describes a reporter system as follows. Strain CY6571 was constructed by transforming plasmid Cp2311 into strain CY1141 (MATa far11E1442 FUS1-HIS3 step14::trp1::LYS2 step31E1156 gpa1(41)-Gai2 lys2 ura3 leu2 trp1 his3). Strain CY1141 contains an integrated copy of a hybrid Gα gene, gpal(41)-Gαi2, which encodes the N-terminal 41 amino acids of Gpα1p fused to sequence encoding human Gai2 (lacking codons for the N-terminal 33 amino acids). Expression of the HIS3 gene is under the control of the FUS1 promoter10. Strain CY6565 is equivalent to CY6571 except that it also carries plasmid Cp1584 (bla LEU2 ARS-2μ FUS1-lacZ). Human cells expressing FPR1 or FPRL-1 were derived from HEK293 cells constitutively expressing human Gα16 under the control of a CMV promoter. The expression of Gα16, under G₄₁₈ selection in these cells, facilitates the coupling of a broad range of GPCRs to the mobilization of intracellular calcium. See Offermanns, S, and Simon, M.I. 1995. G alpha 15 and G alpha 16 couple a wide variety of receptors to phospholipase C. J. Biol. Chem. 270:15175-15180, which is incorporated herein by reference as if fully set forth. Cells were transfected with Cp3155 or Cp3157, encoding FPR1 and FPRL-1 respectively, subjected to selection in the presence of 400 μg/ml hygromycin and 200 μg/ml G₄₁₈ and individual drug-resistant clones were assayed for receptor expression by northern blot and functional analysis. Cell lines responsive to ligand were expanded and maintained at 37° C./5% CO₂ in DMEM GlutaMax (Gibco-BRL, Gaithersburg, Md.) supplemented with 10% newborn calf serum, 200 μg/ml G₄₁₈ and 400 μg/ml hygromycin. A similar reporter system could be used in combination with any biological receptor sensor herein.

Receptor activation in yeast strains carrying a FUS1-HIS3 construct was evaluated by growth on LUH-AT media (synthetic dropout medium lacking leucine, histidine, and uracil) adjusted to pH 6.8 with KOH and supplemented with 2.5 mM 3-aminotriazole and 25 mM HEPES pH 6.8. Aminotriazole is a competitive inhibitor of IGP dehydratase, the product of HIS3, and can be used to suppress growth due to background signaling through the pheromone response pathway. Activation of receptor by exogenous peptide addition to strains containing FUS1-lacZ was measured in 96-well plates seeded with cells at a concentration of 0.15 OD600 units/ml. Serial dilutions of each peptide were added and the plate incubated 5 h at 30° C. Then a lysis buffer containing the substrate chlorophenol red-β-D-galactopyranoside was added and activity was assessed after incubation at 30° C. for 1 h by determining optical density at 575 nm. Activation of receptors in HEK293 cells was measured on a fluorometric imaging plate reader (Molecular Devices, Sunnyvale, Calif.). Cells were loaded with Fluo-3 (Molecular Probes, Eugene, Oreg.) in the presence of probenecid for 1 h at 37° C. Solution containing dye was removed and cells were washed once with HBSS/20 mM HEPES/probenecid prior to compound addition and assay. Neutrophils were isolated from whole blood obtained from healthy human donors. Cells were loaded with indo-1AM (Molecular Probes) and analyzed at room temperature on an Epics Elite flow cytometer equipped with a 20 mW HeCd laser to provide a 325 nm excitation source (Coulter Corporation, Hialeah, Fla.). Cells were analyzed with respect to forward low-angle light scatter of the ultraviolet beam, violet (382 nm) and blue (488 nm) fluorescence emissions using band pass filters, the ratio of violet to blue fluorescence, and the fluorescence ratio of the population with respect to time. The files were gated using scatter and dye loading criteria to exclude debris and moribund cells. Samples were analyzed for 5 min after addition of ligand and the peak Ca²⁺ response was determined using MTIME software (Phoenix Flow Systems, San Diego, Calif.).

The Chambers J, et al. modification of the Klein C, et al. assay was as follows. The assay was developed by the addition of 20 ml of substrate/lysis solution (0.92 mM fluorescein di-β-D-galactopyranoside, 2.3% Triton X-100, and 0.127 M Pipes, pH 7.2). Plates were incubated for 1 h at 37° C. and the reactions stopped by the addition of 20 ml of 1 M Nα₂CO₃. Plates were read in a Spectrafluor fluorimeter (Tecan U.S., Research Triangle Park, N.C.) at 485% (excitation) and 535A, (emission) at optimal gain.

In this example, yeast cultures expressing each of the four mutant receptors (2211, H-20, K-3 and L-3) were grown overnight and diluted to OD₆₀₀ of −0.05 in flasks. Cultures were then grown to an OD₆₀₀ of 0.1-0.2 and 80 μl of culture was aliquotted into deep-well 384 well plates along with 20 μL of ligand. Cultures in the 384 well plates were incubated with vigorous mixing for 4 hours (H-20, K-3, L-3) or overnight (2211). 50 μL of each sample was transferred to a black 384 well plate containing 25 μL fluorescein/lysis solution (as described in Chambers J, et al.). Fluorescence was read on a PerkinElmer fluorescent plate reader. For each mixture of ligands a series of measurements were performed at several predetermined values of total concentration: log 1₀n^{l}={−3.0, −3.5, . . . , −6.5, −9.0} for H-20, K-3, L-3, and {−5.0, −5.5, . . . , −9.0} for 2211. The chemical potential is then given by:

μ^{l}=μ−(l−1)Δμ^{l} (l=1 . . . N), (6)

where N is the number of measurements in the series and the dilution steps 41 depend on the value of μ, which was defined to be μ=−3 kBTlog(10). Each series of measurements was carried out four times with the same mixture.

### Example 5

Single receptor-single ligand model. Assuming that fluorescence measurements are Gaussian-distributed, the log-likelihood of the data is given by:

$$ℒ = log P ( \{ \tilde{I} \} \vert Δ G , A , b , σ ) = - \frac{1}{2 {σ}^{2}} {\sum }_{l = 1}^{N} {[ {I}^{l} ( Δ G , A , b ) - {\tilde{I}}^{l} ]}^{2} - \frac{N}{2} log ( 2 π {σ}^{2} ) , \qquad ( 7 )$$

where Ĩ^{l} (l=1 . . . N) are the measured intensity values, and a quantifies the amount of noise in the data. The log-likelihood is used to estimate the posterior probability for all model parameters in Eq. (1) according to the Bayes rule:

$$P ( Δ G , A , b , σ \vert \{ \tilde{I} \} ) = \frac{P ( \{ \tilde{I} \} \vert Δ G , A , b , σ ) P ( Δ G ) P ( A ) P ( b ) P ( σ )}{P ( \{ \tilde{I} \} )} , \qquad ( 8 )$$

where on the right-hand side the likelihood from Equation (7) is multiplied by the product of priors for each model parameter and divided by evidence. {Ĩ} combines data from all experimental replicates. Uniform priors (invariant with respect to translations, x→x+α) are used:

$$P ( x ) = \{ \begin{matrix}1 / ( {x}_{max} - {x}_{min} ) & if x ∈ [ {x}_{min} , {x}_{max} ] , \\ 0 & otherwise ,\end{matrix} \qquad ( 9 )$$

for ΔG, A and b, and Jeffrey's priors (invariant with respect to rescaling, x→αx) for a:

$$P ( x ) = \{ \begin{matrix}1 / ( x log ( {x}_{max} / {x}_{min} ) ) & if x ∈ [ {x}_{min} , {x}_{max} ] , \\ 0 & otherwise ,\end{matrix} \qquad ( 10 )$$

The following were used (ΔGₘᵢₙ, ΔGₘₐₓ)=(−20.0, 5.0) kcal/mol, (Aₘᵢₙ, Aₘₐₓ)=(0.0, 1.0), (bₘᵢₙ, bₘₐₓ)=(0.0, 1.0), (σₘᵢₙ, σₘₐₓ)=(0.001, 100.0) in the calculations of this example. Finally, information gained from the data is given by:

$$H ( \{ \tilde{I} \} ) = \int d ( Δ G ) dAdbd σ P ( Δ G , A , b , σ \vert \{ \tilde{I} \} ) log \frac{P ( Δ G , A , b , σ \vert \{ \tilde{I} \} )}{P ( Δ G ) P ( A ) P ( b ) P ( σ )} . \qquad ( 11 )$$

The posterior probability in Eq. (8) is estimated by nested sampling (See Sivia D, Skilling J (2006) Data analysis: A Bayesian tutorial (Oxford University Press, Oxford, which is incorporated herein by reference as if fully set forth). Nested sampling results in an ensemble of models from which the average value of each parameter and its standard deviation are obtained. Nested sampling allows to keep track of the evidence, yielding the absolute value of the posterior probability (Eq. (8)) and information gain from each experiment (Eq. (11)).

### Example 6

Multiple receptor-multiple ligand model. The log-likelihood of the observed fluorescence from multiple receptors interrogated by a mixture of ligands is given by:

$$\begin{matrix}ℒ = log P ( \{ \tilde{I} \} \vert \{ α \} , μ , \{ σ \} ) \\ = - {\sum }_{k = 1}^{{N}_{rec}} \{ \frac{1}{2 {σ}_{k}^{2}} {\sum }_{l = 1}^{{N}_{k}} {[ {I}_{k}^{l} ( \{ α \} , μ ) - {\tilde{I}}_{k}^{l} ]}^{2} - \frac{{N}_{k}}{2} log ( 2 {πσ}_{k}^{2} ) \} .\end{matrix} \qquad ( 12 )$$

Here, Ĩₖ^{l} denotes fluorescence measured for receptor k at the total chemical potential μ^{l} (Nₖ is the total number of measurements for receptor k). The log-likelihood is used to estimate the posterior probability P({α}, μ, {σ}|{Ĩ}) as in Eq. (8). A uniform prior for p was employed, with (μₘᵢₙ, μₘₐₓ)=(−10.0, −2.0) and a Jeffrey's prior for α's, with (αₘᵢₙ, αₘₐₓ)=(0.01, 100.0).

### Example 7

Hessian matrix as a measure of receptor array sensitivity. Differentiating Eq. (12) twice with respect to the model parameters leads to:

$$\frac{{\partial }^{2} ℒ}{\partial {γ}_{i} \partial {γ}_{j}} = - {\sum }_{k = 1}^{{N}_{rec}} \frac{1}{{σ}_{k}^{2}} {\sum }_{l = 1}^{{N}_{k}} \{ \frac{\partial {I}_{k}^{l}}{\partial {γ}_{i}} \frac{\partial {I}_{k}^{l}}{\partial {γ}_{j}} + [ {I}_{k}^{l} ( \{ γ \} ) - {\tilde{I}}_{k}^{l} ] \frac{{\partial }^{2} {I}_{k}^{l}}{\partial {γ}_{i} \partial {γ}_{j}} \} , \qquad ( 13 )$$

Where {γ}=({α}, μ). The second term can be omitted in the low-noise limit (Iₖ^{l}({α}, μ)−Ĩₖ^{l}˜σₖ→0), yielding Eq. (4). Explicitly:

$$\frac{{\partial }^{2} ℒ}{\partial {α}_{i} \partial {α}_{j}} = - {\sum }_{k = 1}^{{N}_{rec}} \frac{1}{{σ}_{k}^{2}} {\sum }_{l = 1}^{{N}_{k}} ( \frac{{p}_{i + 1}^{k , l}}{{α}_{i}} ( {A}_{i + 1}^{k} - {I}_{k}^{l} ) - \frac{{I}_{k}^{l}}{{Z}^{k , l} S} ) ( \frac{{p}_{j + 1}^{k , l}}{{α}_{j}} ( {A}_{j + 1}^{k} - {I}_{k}^{l} ) - \frac{{I}_{k}^{l}}{{Z}^{k , l} S} ) , \\ \frac{{\partial }^{2} ℒ}{\partial {μ}^{2}} = - {β}^{2} {\sum }_{k = 1}^{{N}_{rec}} \frac{1}{{σ}_{k}^{2}} {\sum }_{l = 1}^{{N}_{k}} {( \frac{{I}_{k}^{l}}{{Z}^{k , l}} )}^{2} , \\ \frac{{\partial }^{2} ℒ}{\partial μ \partial {α}_{i}} = - β {\sum }_{k = 1}^{{N}_{rec}} \frac{1}{{σ}_{k}^{2}} {\sum }_{l = 1}^{{N}_{k}} {( \frac{{I}_{k}^{l}}{{Z}^{k , l}} )}^{2} ( \frac{{p}_{i + 1}^{k , l}}{{α}_{i}} ( {A}_{i + 1}^{k} - {I}_{k}^{l} ) - \frac{{I}_{k}^{l}}{{Z}^{k , l} S} ) . \qquad ( 14 )$$

### Example 8

Sensitivity analysis for two ligands interacting with a single receptor. For a single receptor and two ligands the following is obtain from Eq. (14) (omitting the receptor index and setting α₁=α, σ²=1 for convenience): (15)

$$\frac{{\partial }^{2} ℒ}{\partial {α}^{2}} = - {\sum }_{l = 1}^{N} {( \frac{{p}_{2}^{l}}{α} ( {A}_{2} - {I}^{l} ) - \frac{{I}^{l}}{{Z}^{l} ( 1 + α )} )}^{2} , \\ \frac{{\partial }^{2} ℒ}{\partial {μ}^{2}} = - {β}^{2} {\sum }_{l = 1}^{N} {( \frac{{I}^{l}}{{Z}^{l}} )}^{2} , \\ \frac{{\partial }^{2} ℒ}{\partial μ \partial α} = - β {\sum }_{l = 1}^{N} ( \frac{{I}^{l}}{{Z}^{l}} ) ( \frac{{p}_{2}^{l}}{α} ( {A}_{2} - {I}^{l} ) - \frac{{I}^{l}}{{Z}^{l} ( 1 + α )} ) . \qquad ( 15 )$$

Hessian analysis and the definition of the mixing ratios: As noted above, the mixing ratios are defined as αₘ=nₘ₊₁/n₁ (m=1 . . . N_{lig}−1), where n₁ is the concentration of one of the ligands. Different choices of the ligand in the denominator may lead to very different numerical values of α if, for example, n_{1<<}n₂ in a two-ligand, one-receptor system. Nonetheless, the uncertainty of both predictions is related. Indeed, if α=n₂/n₁→0 one can show that

$$\frac{{\partial }^{2} ℒ}{\partial {α}^{2}} \to - {\sum }_{l = 1}^{N} {( \frac{{e}_{1} {e}_{2} ( {A}_{2} - {A}_{1} ) - {A}_{1} {e}_{1} + {A}_{2} {e}_{2}}{{( 1 + {e}_{1} )}^{2}} )}^{2} , \qquad ( 16 )$$

where eᵢ^{l}=exp {−β(ΔG₁−μ^{l})}, i=1,2. Thus the absence of ligand 2 can be predicted with finite uncertainty, at least if it is assumed that μ is known. In the α→+∞ limit,

$$\frac{{\partial }^{2} ℒ}{\partial {α}^{2}} \to - \frac{1}{{α}^{4}} {\sum }_{l = 1}^{N} {( \frac{{e}_{1} {e}_{2} ( {A}_{2} - {A}_{1} ) - {A}_{1} {e}_{1} + {A}_{2} {e}_{2}}{{( 1 + {e}_{1} )}^{2}} )}^{2} . \qquad ( 17 )$$

Note that the divergence of error with α² is expected because α→+∞ is equivalent to α′=n₁/n₂=1/α→0, yielding σ_{α}²=−( [symbol] ^{Γ}L/ [symbol] α²)⁻¹=α⁴σ_{α′}². Thus σ_{α′}² remains finite as ligand 2 disappears from the mixture. Moreover, the expression for [symbol] ²L/ [symbol] α′² in the α′→0 limit should be the same as the expression for [symbol] ²L/ [symbol] α² in the α→0 limit, but with ligand labels 1 and 2 interchanged. Indeed, if 1 [symbol] 2 Eq. (17) becomes the same as Eq. (16), apart from the 1/α⁴ factor accounted for above.

Agonist-agonist case: If both ligands have unit efficacies (A₁=A₂=1), Eq. (15) gives:

$$\frac{{\partial }^{2} ℒ}{\partial {α}^{2}} = - {\sum }_{l = 1}^{N} {( \frac{{p}_{2}^{l} - α {p}_{1}^{l}}{{Z}^{l} α ( 1 + α )} )}^{2} \qquad ( 18 )$$

Assume for simplicity that μ is known, so that σ_{α}²=−( [symbol] ²L/ [symbol] α²)⁻¹. Furthermore, suppose that ΔG₁ is fixed at a finite value, whereas ΔG₂ is varied from −∞ to +∞. It is then easy to see that ΔG₂=ΔG₁ is a special case, giving p₂¹=αp₁^{l}(∀l) and thus σ_{α}²=∞. So, as expected, discrimination between the two ligands is difficult if they have equal efficacies and binding affinities. If ΔG₂→−∞Z^{l}→+∞(and p₂^{l}→1, ∀l), making [symbol] ²L/ [symbol] α²=0 again. Thus discrimination is difficult if one of the ligands completely saturates the receptor. However, if ΔG₂→+∞Z^{l} remains finite (while p₂^{l}→0, ∀l), yielding

$$\frac{{\partial }^{2} ℒ}{\partial {α}^{2}} ≃ - \frac{1}{{( 1 + α )}^{2}} {\sum }_{l = 1}^{N} {( \frac{{p}_{1}^{l}}{{Z}^{l}} )}^{2} . \qquad ( 19 )$$

Surprisingly, discrimination is still possible in this limit, even if ligand 2 does not bind the receptor. This is because the total concentration is known in this example and so information provided by ligand 1 is enough to infer α. Of course, if ligand 1 is also unbound (p₁^{l}→0, ∀l), predicting becomes difficult again.

If α is known, the error in the predicted total chemical potential μ is determined by:

$$\frac{{\partial }^{2} ℒ}{\partial {μ}^{2}} = - {β}^{2} {\sum }_{l = 1}^{N} {( \frac{{Z}^{l} - 1}{{Z}^{l 2}} )}^{2} . \qquad ( 20 )$$

Learning the value of the total concentration becomes impossible if both ligands are unbound (Z¹→1), or if one ligand is bound so strongly that assessing the concentration of the other ligand becomes problematic (Z¹→∞). Note that in both of these limits [symbol] ²L/ [symbol] α²=0 as well.

Surprisingly, simultaneous discrimination of μ and α is not possible if both ligands have equal efficacies. Indeed, the determinant of the 2×2 matrix of second derivatives is always close to 0:

$$det ( \frac{{\partial }^{2} ℒ}{\partial {γ}_{i} \partial {γ}_{j}} ) = {( \frac{β}{α ( 1 + α )} )}^{2} {\sum }_{l , {l}^{′} = 1}^{N} \frac{{Z}^{{l}^{′}} - 1}{{Z}^{l 2} {Z}^{{l}^{′} 3}} ( {p}_{2}^{l} - α {p}_{1}^{l} ) \times [ ( {p}_{2}^{l} - α {p}_{1}^{l} ) ( {p}_{1}^{{l}^{′}} + {p}_{2}^{{l}^{′}} ) - ( {p}_{2}^{{l}^{′}} - α {p}_{1}^{{l}^{′}} ) ( {p}_{1}^{l} + {p}_{2}^{l} ) ] . \qquad ( 21 )$$

This is because appreciable values of p₁^{l} or p₂^{l} lead to Z¹>1, which in turn suppresses the determinant. The small value of the determinant means that at least one of the errors is large. For example, if ΔG₂=ΔG₁,

$${σ}_{α}^{2} = - \frac{1}{det ( \frac{{\partial }^{2} ℒ}{\partial {γ}_{i} \partial {γ}_{j}} )} \frac{{\partial }^{2} ℒ}{\partial {μ}^{2}} \qquad ( 22 )$$

is infinite because p₂^{l}=αp₁^{l}(∀l), whereas Z^{l} is finite. In general, the multidimensional analysis of this type is difficult because zeros in the numerator and denominator of Eq. (22) and a similar equation for σ_{μ}² have to be handled correctly.

Agonist-antagonist case: If one of the ligands (e.g. ligand 2) acts as an antagonist (A₁=1, A₂=0):

$$\frac{{\partial }^{2} ℒ}{\partial {α}^{2}} = - {\sum }_{l = 1}^{N} {( {p}_{1}^{l} )}^{2} {( \frac{{p}_{2}^{l}}{α} + \frac{1}{{Z}^{l} ( 1 + α )} )}^{2} , \\ \frac{{\partial }^{2} ℒ}{\partial {μ}^{2}} = - {β}^{2} {\sum }_{l = 1}^{N} {( \frac{{p}_{1}^{l}}{{Z}^{l}} )}^{2} , \\ \frac{{\partial }^{2} ℒ}{\partial μ \partial α} = - β {\sum }_{l = 1}^{N} ( \frac{{p}_{1}^{{l}^{2}}}{{Z}^{l}} ) ( \frac{{p}_{2}^{l}}{α} + \frac{1}{{Z}^{l} ( 1 + α )} ) . \qquad ( 23 )$$

Note that both α and μ discrimination are poor if ΔG₂<</G₁, yielding small p₁^{l}. With ligand 1 acting as an antagonist (A₁=0, A₂=1):

$$\frac{{\partial }^{2} ℒ}{\partial {α}^{2}} = - {\sum }_{l = 1}^{N} {( {p}_{2}^{l} )}^{2} {( \frac{{p}_{1}^{l}}{α} + \frac{1}{{Z}^{l} α ( 1 + α )} )}^{2} , \\ \frac{{\partial }^{2} ℒ}{\partial {μ}^{2}} = - {β}^{2} {\sum }_{l = 1}^{N} {( \frac{{p}_{2}^{l}}{{Z}^{l}} )}^{2} , \\ \frac{{\partial }^{2} ℒ}{\partial μ \partial α} = - β {\sum }_{l = 1}^{N} ( \frac{{p}_{2}^{{l}^{2}}}{{Z}^{l}} ) ( \frac{{p}_{1}^{l}}{α} + \frac{1}{{Z}^{l} α ( 1 + α )} ) . \qquad ( 24 )$$

If α=1 Eq. (24) is the same as Eq. (23) with ΔG₁ and ΔG₂ interchanged. However, for arbitrary α there is no symmetry, so that maximizing the determinant of the Hessian with A₁=0, A2=1 and A₁=1, A₂=0 yields two distinct solutions in the {ΔG₁, AG₂} space.

### Example 9

A reporter system. A mutant UDP-glucose receptor (P2Y14) functionally expressed in the yeast Saccharomyces and/or other mutant receptors that have ligand-binding properties that are useful as practical biosensors and are disclosed in U.S. Patent Publication No. 20080070794, filed on May 21, 2007, to Broach et al.; U.S. Patent Publication No. 20070154947, filed Aug. 31, 2006, to Broach et al.; and Creation of GPCR-based chemical sensors by directed evolution in yeast, published in Protein Engineering, Design & Selection vol. 19 no. 1 pp. 1-8, 2006, authors Addison D. Ault and James R. Broach, all of which are incorporated herein by reference as if fully set forth describe chemosensors and their accompanying reporter systems. Briefly, the yeast P2Y14 receptor was replaced by the GPCRs K-3, H-20 and 2111. As discussed above, the GPCR L-3 has also replaced P2Y14 in subsequent engineering. The yeast Gα was replaced with a chimeric Gα, and FUS1-LacZ and FUS1h-His3 reporter genes were included in the yeast strain. Through this system, the yeast pheromone receptor is replaced with an engineered GPCR and the G-protein is tailored to activate the pheromone response pathway in reaction to ligand binding. Pathway activation is monitored using a β-galactosidase assay with fluorescent readout.

### REFERENCES

[1] Su CY, Menuz K, Carlson J (2009) Olfactory perception: Receptors, cells, and circuits. Cell 139:45-59.
[2] Breer H (2003) Olfactory receptors: molecular basis for recognition and discrimination of odors. Anal. Bioanal. Chem. 377:427-433.
[3] Firestein S (2001) How the olfactory system makes sense of scents. Nature 413:211-218.
[4] Buck L (1996) Information coding in the vertebrate olfactory system. Annu. Rev. Neurosci. 19:517-544.
[5] Malnic B, Hirono J, Sato T, Buck L (1999) Combinatorial receptor codes for odors. Cell 96:713-723.
[6] Hallem E, Carlson J (2006) Coding of odors by a receptor repertoire. Cell 125:143-160.
[7] Saito H, Chi Q, Zhuang H, Matsunami H, Mainland J (2009) Odor coding by a mammalian receptor repertoire. Sci. Signal. 2:ra9.
[8] Albert K, et al. (2000) Cross-reactive chemical sensor arrays. Chem. Rev. 100:2595-2626.
[9] Rakow N, Suslick K (2000) A colorimetric sensor array for odour visualization. Nature 406:710-713.
[10] Hertzog-Ronen C, Borzin E, Gerchikov Y, Tessler N, Eichen Y (2009) Detection and identification of alkylating agents by using a bioinspired “chemical nose”. Chem. Eur. J. 15:10380-10386.
[11] Jurs P, Bakken G, McClelland H (2000) Computational methods for the analysis of chemical sensor array data from volatile analytes. Chem. Rev. 100:2649-2678.
[12] Kitamura M, Shabbir S, Anslyn E (2009) Guidelines for pattern recognition using differential receptors and indicator displacement arrays. J. Org. Chem. 74:4479-4489.
[13] Shabbir S, et al. (2009) Pattern-based recognition for the rapid determination of identity, concentration, and enantiomeric excess of subtly different threo diols. J. Am. Chem. Soc. 131:13125-13131.
[14] Feuerstein T, Limberger N (1999) Mathematical analysis of the control of neurotransmitter release by presynaptic receptors as a supplement to experimental data. Arch. Pharmacol. 359: 345359. 31
[15] Ault A, Broach J (2006) Creation of GPCR-based chemical sensors by directed evolution in yeast. Prot. Eng. Des. Sel. 19:1-8.
[16] Chambers J, et al. (2000) A G protein-coupled receptor for UDP-glucose. J. Biol. Chem. 275:10767-10771.
[17] Sivia D, Skilling J (2006) Data analysis: A Bayesian tutorial (Oxford University Press, Oxford).
[18] Metropolis N, Rosenbluth A, Rosenbluth M, Teller A, E. T (1953) Equation of state by fast computing machines. J. Chem. Phys. 21:1087-1092.

The references cited throughout this application are incorporated for all purposes apparent herein and in the references themselves as if each reference was fully set forth. For the sake of presentation, specific ones of these references are cited at particular locations herein. A citation of a reference at a particular location indicates a manner(s) in which the teachings of the reference are incorporated. However, a citation of a reference at a particular location does not limit the manner in which all of the teachings of the cited reference are incorporated for all purposes.

It is understood, therefore, that the invention is not limited to the particular embodiments disclosed, but is intended to cover all modifications which are within the spirit and scope of the invention as defined by the appended claims; the above description; and/or shown in the attached drawings.

What is claimed is:

1. A method of analyzing a chemical mixture that may contain a plurality of ligands comprising:
providing a chemosensor array including at least one sensor, and a respective reporter operably connected to each of the at least one sensor, wherein binding of at least one of the plurality of ligands to one of the at least one sensor causes activation of the respective reporter to produce a respective report intensity,
each of the plurality of ligands having a respective free energy of binding with each respective one of the at least one sensor, each of the at least one sensor having a respective efficacy of activation by each respective one of the plurality of ligands, and each of the at least one sensor having a respective background intensity;
exposing the chemosensor array to the chemical mixture;
measuring each of the respective report intensities; and
inferring a respective concentration for each of the plurality of ligands from the respective report intensities based on the respective free energies, the respective efficacies and the respective backgrounds.

2. The method of claim 1, wherein the step of inferring is done by Bayesian inference.

3. The method of claim 1 further comprising obtaining the respective free energy and respective efficacy for each of the at least one sensor in comparison to each of the plurality of ligands.

4. The method of claim 1, wherein one or more of the at least one sensor is independently selected from the group consisting of biological receptors.

5. The method of claim 1, wherein one or more of the at least one sensor is independently selected from the group consisting of G-protein-coupled-receptors.

6. The method of claim 5, wherein the respective reporter is a respective gene responsive to a respective one of the G-protein coupled receptors, the activation of the respective reporter includes causing expression of the respective gene to provide a respective gene product, and the step of measuring the respective report intensity includes measuring at least one of the presence or activity of the respective gene product.

7. The method of claim 6, wherein the G-protein coupled receptors include moieties selected from the group consisting of UDP-glucose receptor, 2211, H-20, K-3, L-3, HTR1A, HTR1B, HTR1D, HTR1E, HTR1F, HTR2A, HTR2B, HTR2c, HTR4, HTR5A, HTR6, HTR7, CHRM1, CHRM2, CHRM3, CHRM4, CHRM5, ADORA1, ADORA2A, ADORA2B, ADORA3, ADRA1A, ADRA1B, ADRA1D, ADRA2A, ADRA2B, ADRA2C, ADRB1, ADRB2, ADRB3, C3AR1, C5AR1, GPR77, ΔGTR1, AGTR2, APLNR, GPBAR1, NMBR, GRPR, BRS3, BDKRB1, BDKRB2, CNR1, CNR2, CCR1, CCR2, CCR3, CCR4, CCR5, CCR6, CCR7, CCR8, CCR9, CCR10, CXCR1, CXCR2, CXCR3, CXCR4, CXCR5, CXCR6, CX3CR1, XCR1, CCKAR, CCKBR, DRD1, DRD2, DRD3, DRD4, DRD5, EDNRA, EDNRB, GPER, FPR1, FPR2, FPR3, FFAR1, FFAR2, FFAR3, GPR42, GALR1, GALR2, GALR3, GHSR, FSHR, LHCGR, TSHR, GNRHR, GNRHR2, HRH1, HRH2, HRH3, HRH4, KISS1R, LTB4R, LTB4R2, CYSLTR1, CYSLTR2, OXER1, FPR2, LPAR1, LPAR2, LPAR3, S1PR1, S1PR2, S1PR3, S1PR4, S1PR5, MCHR1, MCHR2, MC1R, MC2R, MC3R, MC4R, MC5R, MTNR1A, MTNR1B, MLNR, NMUR1, NMUR2, NPFFR1, NPFFR2, NPSR1, NPBWR1, NPBWR2, NPY1R, NPY2R, PPYR1, NPY5R, NTSR1, NTSR2, GPR81, GPR109A, GPR109B, OPRD1, OPRK1, OPRM1, OPRL1, HCRTR1, HCRTR2, P2RY1, P2RY2, P2RY4, P2RY6, P2RY11, P2RY12, P2RY13, P2RY14, QRFPR, PTAFR, PROKR1, PROKR2, PRLHR, PTGDR, GPR44, PTGER1, PTGER2, PTGER3, PTGER4, PTGFR, PTGIR, TBXA2R, F2R, F2RL1, F2RL2, F2RL3, RXFP1, RXFP2, RXFP3, RXFP4, SSTR1, SSTR2, SSTR3, SSTR4, SSTR5, TACR1, TACR2, TACR3, TRHR, TAAR1, UTS2R, AVPR1A, AVPR1B, AVPR2, OXTR, CCRL2, CMKLR1, CXCR7, GPR183, GPR42, GPR1, GPR3, GPR4, GPR6, GPR12, GPR15, GPR17, GPR18, GPR19, GPR20, GPR21, GPR22, LPAR4, GPR25, GPR26, GPR27, GPR31, GPR32, GPR33, GPR34, GPR35, GPR37, GPR37L1, GPR39, GPR45, GPR50, GPR52, GPR55, GPR61, GPR62, GPR63, GPR65, GPR68, GPR75, GPR78, GPR79, GPR82, GPR83, GPR84, GPR85, GPR87, GPR88, LPAR5, GPR101, GPR119, GPR120, GPR132, GPR135, GPR139, GPR141, GPR142, GPR146, GPR148, GPR149, GPR150, GPR151, GPR152, GPR153, GPR160, GPR161, GPR162, GPR171, GPR173, GPR174, GPR182, LGR4, LGR5, LGR6, MAS1, MAS1L, MRGPRD, MRGPRE, MRGPRF, MRGPRG, MRGPRX1, MRGPRX2, MRGPRX3, MRGPRX4, OPN3, OPN5, OXGR1, LPAR6, P2RY8, P2RY10, SUCNR1, TAAR2, TAAR3, TAAR5, TAAR6, TAAR8, TAAR9, CCBP2, CCRL1, DARC, OR2W1, MOR272-1, MOR271-1, MOR41-1, OR1A1, MOR203-1, MOR256-17, MOR1-1, MOR2-1, MOR273-1, MOR139-1, MOR189-1, MOR136-1, OR51E1, MOR37-1, MOR30-1, OR51E2, OR2J2, MOR261-1, OR5P3, MOR258-1, MOR185-1, OR51L1, MOR9-1, MOR15-1, MOR106-1, MOR105-1, MOR40-1, MOR33-1, MORS-1, MOR25-1, MOR31-1, MOR23-1, OR10J5, OR2C1, MOR260-1, MOR277-1, MOR128-2, MOR107-1, OR2M7, MOR268-1, MOR236-1, MOR223-1, MOR269-1, MOR259-1, MOR4-1, MOR184-1, MOR182-1, MOR253-1, MOR251-1, MOR222-1, MOR18-1, MOR180-1, MOR205-1, MOR140-1, MOR250-1, MOR204-6, MOR162-1, MOR129-1, MOR161-1, MOR207-1 and MOR170-1.

8. The method of claim 6, wherein the chemical mixture is one selected from the group consisting of a medical sample, an environmental toxicology sample, a remediation sample, a materials quality control sample, a food sample, an agricultural product sample, an industrial manufacturing sample, an ambient air sample, a workplace sample, an emissions sample, a product sample, a leak sample, a drug testing sample, a drug compliance sample, a hazardous spill sample, and a potential explosives sample.

9. The method of claim 1, wherein one of the plurality of ligands is an agonist to one of the at least one sensor and a different one of the plurality of ligands is an antagonist to the one of the at least one sensor.

10. The method of claim 1, wherein the chemical mixture is one selected from the group consisting of a medical sample, an environmental toxicology sample, a remediation sample, a materials quality control sample, a food sample, an agricultural product sample, an industrial manufacturing sample, an ambient air sample, a workplace sample, an emissions sample, a product sample, a leak sample, a drug testing sample, a drug compliance sample, a hazardous spill sample, and a potential explosives sample.

11. The method of claim 1, wherein the respective free energies and the respective efficacies are obtained by determining an extent to which binding of one of the plurality of ligands to one of the at least one sensor causes activation of the respective reporter to produce the respective report intensity, and inferring a respective concentration for each of the plurality of ligands includes calculating a fractional amount of each one of the at least one sensor that is bound to each of the plurality of ligands, recovering a total concentration of all of the ligands in the plurality of ligands and ratios of pairs of ligands in the plurality of ligands, and deducing the concentration of each one of the plurality of ligands in the chemical mixture.

12. A chemosensor system comprising:
a chemosensor array including at least one sensor, and a respective reporter operably connected to each of the at least one sensor, wherein binding of at least one of a plurality of ligands to one of the at least one sensor causes activation of the respective reporter to produce a respective report intensity, each of the plurality of ligands having a respective free energy of binding with each respective one of the at least one sensor, each of the at least one sensor having a respective efficacy of activation by each respective one of the plurality of ligands, and each of the at least one sensor having a respective background intensity;
a processor operably connected to the chemosensor array, and
a computer-readable medium operably connected to the processor, operably connected to the chemosensor array, and including processor executable instructions for analyzing a chemical mixture that may include the plurality of ligands;
the processor executable instructions including directions for receiving data including at least one of the respective report intensities, the respective free energies, the respective efficacies, or respective backgrounds, and inferring a respective concentration for each of the plurality of ligands from the respective report intensities received after exposing the chemosensor array to the chemical mixture, wherein the inferring is based on the respective free energies, the respective efficacies and the respective backgrounds.

13. The chemosensor system of claim 12, wherein inferring is done by Bayesian inference.

14. The system of claim 12 further comprising a memory having the respective free energy and respective efficacy for each of the at least one sensor in comparison to each of the plurality of ligands.

15. The system of claim 12, wherein one or more of the at least one sensor is independently selected from the group consisting of biological receptors.

16. The system of claim 12, wherein one or more of the at least one sensor is independently selected from the group consisting of G-protein coupled receptors.

17. The system of claim 16, wherein the respective reporter is a respective gene responsive to a respective one of the G-protein coupled receptors, the activation of the respective reporter includes causing expression of the respective gene to provide a respective gene product, and the step of measuring the respective report intensity includes measuring at least one of the presence or activity of the respective gene product.

18. The system of claim 17, wherein the G-protein coupled receptors include moieties selected from the group consisting of UDP-glucose receptor, 2211, H-20, K-3, L-3, HTR1A, HTR1B, HTR1D, HTR1E, HTR1F, HTR2A, HTR2B, HTR2c, HTR4, HTR5A, HTR6, HTR7, CHRM1, CHRM2, CHRM3, CHRM4, CHRM5, ADORA1, ADORA2A, ADORA2B, ADORA3, ADRA1A, ADRA1B, ADRA1D, ADRA2A, ADRA2B, ADRA2C, ADRB1, ADRB2, ADRB3, C3AR1, C5AR1, GPR77, ΔGTR1, AGTR2, APLNR, GPBAR1, NMBR, GRPR, BRS3, BDKRB1, BDKRB2, CNR1, CNR2, CCR1, CCR2, CCR3, CCR4, CCR5, CCR6, CCR7, CCR8, CCR9, CCR10, CXCR1, CXCR2, CXCR3, CXCR4, CXCR5, CXCR6, CX3CR1, XCR1, CCKAR, CCKBR, DRD1, DRD2, DRD3, DRD4, DRD5, EDNRA, EDNRB, GPER, FPR1, FPR2, FPR3, FFAR1, FFAR2, FFAR3, GPR42, GALR1, GALR2, GALR3, GHSR, FSHR, LHCGR, TSHR, GNRHR, GNRHR2, HRH1, HR112, HRH3, HRH4, KISS1R, LTB4R, LTB4R2, CYSLTR1, CYSLTR2, OXER1, FPR2, LPAR1, LPAR2, LPAR3, S1PR1, S1PR2, S1PR3, S1PR4, S1PR5, MCHR1, MCHR2, MC1R, MC2R, MC3R, MC4R, MC5R, MTNR1A, MTNR1B, MLNR, NMUR1, NMUR2, NPFFR1, NPFFR2, NPSR1, NPBWR1, NPBWR2, NPY1R, NPY2R, PPYR1, NPY5R, NTSR1, NTSR2, GPR81, GPR109A, GPR109B, OPRD1, OPRK1, OPRM1, OPRL1, HCRTR1, HCRTR2, P2RY1, P2RY2, P2RY4, P2RY6, P2RY11, P2RY12, P2RY13, P2RY14, QRFPR, PTAFR, PROKR1, PROKR2, PRLHR, PTGDR, GPR44, PTGER1, PTGER2, PTGER3, PTGER4, PTGFR, PTGIR, TBXA2R, F2R, F2RL1, F2RL2, F2RL3, RXFP1, RXFP2, RXFP3, RXFP4, SSTR1, SSTR2, SSTR3, SSTR4, SSTR5, TACR1, TACR2, TACR3, TRHR, TAAR1, UTS2R, AVPR1A, AVPR1B, AVPR2, OXTR, CCRL2, CMKLR1, CXCR7, GPR183, GPR42, GPR1, GPR3, GPR4, GPR6, GPR12, GPR15, GPR17, GPR18, GPR19, GPR20, GPR21, GPR22, LPAR4, GPR25, GPR26, GPR27, GPR31, GPR32, GPR33, GPR34, GPR35, GPR37, GPR37L1, GPR39, GPR45, GPR50, GPR52, GPR55, GPR61, GPR62, GPR63, GPR65, GPR68, GPR75, GPR78, GPR79, GPR82, GPR83, GPR84, GPR85, GPR87, GPR88, LPAR5, GPR101, GPR119, GPR120, GPR132, GPR135, GPR139, GPR141, GPR142, GPR146, GPR148, GPR149, GPR150, GPR151, GPR152, GPR153, GPR160, GPR161, GPR162, GPR171, GPR173, GPR174, GPR182, LGR4, LGR5, LGR6, MAS1, MAS1L, MRGPRD, MRGPRE, MRGPRF, MRGPRG, MRGPRX1, MRGPRX2, MRGPRX3, MRGPRX4, OPN3, OPN5, OXGR1, LPAR6, P2RY8, P2RY10, SUCNR1, TAAR2, TAAR3, TAAR5, TAAR6, TAAR8, TAAR9, CCBP2, CCRL1, DARC, OR2W1, MOR272-1, MOR271-1, MOR41-1, OR1A1, MOR203-1, MOR256-17, MOR1-1, MOR2-1, MOR273-1, MOR139-1, MOR189-1, MOR136-1, OR51E1, MOR37-1, MOR30-1, OR51E2, OR2J2, MOR261-1, OR5P3, MOR258-1, MOR185-1, OR51L1, MOR9-1, MOR15-1, MOR106-1, MOR105-1, MOR40-1, MOR33-1, MORS-1, MOR25-1, MOR31-1, MOR23-1, OR10J5, OR2C1, MOR260-1, MOR277-1, MOR128-2, MOR107-1, OR2M7, MOR268-1, MOR236-1, MOR223-1, MOR269-1, MOR259-1, MOR4-1, MOR184-1, MOR182-1, MOR253-1, MOR251-1, MOR222-1, MOR18-1, MOR180-1, MOR205-1, MOR140-1, MOR250-1, MOR204-6, MOR162-1, MOR129-1, MOR161-1, MOR207-1 and MOR170-1.

19. The system of claim 12, wherein one of the plurality of ligands is an agonist to one of the at least one sensor and a different one of the plurality of ligands is an antagonist to the one of the at least one sensor.

20. A computer-readable medium storing a set of processor-executable instructions for execution by a general purpose computer to perform a method of analyzing a chemical mixture that may contain a plurality of ligands, the method comprising:
obtaining data from a chemosensor array including at least one sensor, and a respective reporter operably connected to each of the at least one sensor, wherein binding of each of the plurality of ligands to each respective one of the at least one sensor causes activation of the respective reporter to produce a respective report intensity,
each of the plurality of ligands having a respective free energy of binding with each respective one of the at least one sensor, each of the at least one sensor having a respective efficacy of activation by each respective one of the plurality of ligands, and each of the at least one sensor having a respective background intensity;
inferring a respective concentration for each of the plurality of ligands from the respective report intensities based on the respective free energies, the respective efficacies and the respective backgrounds.

21. The computer-readable medium of claim 20, wherein instructions include direction for inferring by Bayesian inference.

22. The computer readable-medium of claim 20 further comprising instructions for at least one of providing the chemosensor array, exposing the chemosensor array to the chemical mixture or measuring each of the respective report intensities.

23. A method of making a chemosensor array comprising:
selecting a plurality of ligands to be analyzed by the chemosensor array, each ligand in the plurality of ligands having a range of relative concentrations with respect to the remaining ligands in the plurality of ligands;
selecting a plurality of sensors having i) a respective free energy of binding between with each of the plurality of ligands, and ii) a respective efficacy of activation by each of the plurality of ligands;
defining errors in predicting component concentrations by inferring a concentration of each of the ligands in the plurality of ligands and determining the difference between the inferred concentration and the actual concentration;
minimizing errors by sampling for binding free energies and efficacies between each of the at least one sensor and each of the plurality of ligands and determining a best estimate and associated error for each of the at least one sensor;
selecting sensors from the plurality of sensors for the chemosensor array based the best estimate and associated error for each of the plurality of sensors that are capable of detecting whether one of the ligands in the plurality of ligands is present in a chemical mixture that may contain one or more of the plurality of ligands and the concentration of the one of the ligands.

24. The method of claim 23, wherein selecting sensors includes choosing a set of sensors having less associated error than remaining sensors in the plurality of sensors.

25. The method of claim 23 further comprising repeating the steps of selecting a plurality of sensors, determining, analytically calculating, and minimizing errors for the at least one sensor, wherein the plurality of sensors includes a different number of individual sensors.

26. The method of claim 23, wherein one of the plurality of ligands is an agonist to one of the at least one sensor and a different one of the plurality of ligands is an antagonist to the one of the at least one sensor.

27. The method of claim 23, wherein one or more of the at least one sensor is independently selected from the group consisting of biological receptors.

28. The method of claim 23, wherein one or more of the at least one sensor is independently selected from the group consisting of G-protein-coupled-receptors.

29. A chemosensor array comprising at least one sensor, and a respective reporter operably connected to each of the at least one sensor, wherein binding of at least one of a plurality of ligands to one of the at least one sensor causes activation of the respective reporter to produce a respective report intensity, one of the plurality of ligands is an agonist to one of the at least one sensor and a different one of the plurality ligands an antagonist to the one of the at least one sensor, each of the plurality of ligands having a respective free energy of binding with each respective one of the at least one sensor, each of the at least one sensor having a respective efficacy of activation by each respective one of the plurality of ligands, and each of the at least one sensor having a respective background intensity.

30. The chemosensor array of claim 29, wherein one or more of the at least one sensor is independently selected from the group consisting of biological receptors.

31. The chemosensor array of claim 29, wherein one or more of the at least one sensor is independently selected from the group consisting of G-protein-coupled-receptors.
